(19) United States
(12) Patent Application Publication
(10) Pub. No.: US 2022/0263089 A1
(43) Pub. Date: Aug. 18, 2022

(54) POSITIVE ELECTRODE ACTIVE MATERIAL AND MANUFACTURING METHOD OF POSITIVE ELECTRODE ACTIVE MATERIAL

(71) Applicant: SEMICONDUCTOR ENERGY LABORATORY CO., LTD., ATSUGI-SHI (JP)

(72) Inventors: Yohei MOMMA, Isehara (JP); Teruaki OCHIAI, Atsugi (JP); Mayumi MIKAMI, Atsugi (JP); Jyo SAITOU, Atsugi (JP)

(73) Assignee: SEMICONDUCTOR ENERGY LABORATORY CO., LTD., ATSUGI-SHI (JP)

(21) Appl. No.: 17/729,236

(22) Filed: Apr. 26, 2022

Related U.S. Application Data
(63) Continuation of application No. 17/264,701, filed on Jan. 29, 2021.

(30) Foreign Application Priority Data
Aug. 3, 2018 (JP) 2018-146603
Aug. 22, 2018 (JP) 2018-155213
Oct. 17, 2018 (JP) 2018-195850

(51) Int. Cl. H01M 4/525; C01G 51/00; C01G 53/00; H01M 4/505; H01M 10/0525; H01M 10/0568; H01M 10/0569

(52) U.S. Cl. CPC H01M 4/525; C01G 51/44; C01G 53/42; H01M 4/505; H01M 2004/028; H01M 10/0568; H01M 10/0569; C01P 2002/72; C01P 2006/40; H01M 10/0525

(57) ABSTRACT

A positive electrode active material, which has higher capacity and excellent charge and discharge cycle performance, for a lithium-ion secondary battery is provided. The positive electrode active material includes lithium, cobalt, magnesium, oxygen, and fluorine; when a pattern obtained by powder X ray diffraction using a CuKα1 ray is subjected to Rietveld analysis, the positive electrode active material has a crystal structure having a space group R-3m, a lattice constant of an a-axis is greater than 2.814×10(−10th power) m and less than 2.817×10(−10th power) m, and a lattice constant of a c-axis is greater than 14.05×10(−10th power) m and less than 14.07×10(−10th power) m; and in analysis by X-ray photoelectron spectroscopy, a relative value of a magnesium concentration is higher than or equal to 1.6 and lower than or equal to 6.0 with the cobalt concentration regarded as 1.

### CROSS REFERENCE TO RELATED APPLICATIONS

This application is a continuation of U.S. application Ser. No. 17/264,701, filed Jan. 29, 2021, now pending, which is a U.S. National Phase Application under 35 U.S.C. § 371 of International Application PCT/IB2019/056304, filed on Jul. 24, 2019, which is incorporated by reference and claims the benefit of foreign priority applications filed in Japan on Aug. 3, 2018, as Application No. 2018-146603, on Aug. 22, 2018, as Application No. 2018-155213, and on Oct. 17, 2018, as Application No. 2018-195850.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a secondary battery, and an electronic device including a secondary battery.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density have rapidly grown with the development of the semiconductor industry, for portable information terminals such as mobile phones, smartphones, tablets, and laptop computers; portable music players; digital cameras; medical equipment; next-generation clean energy vehicles (hybrid electric vehicles (HEV), electric vehicles (EV), plug-in hybrid electric vehicles (PHEV), and the like); and the like. The lithium-ion secondary batteries are essential as rechargeable energy supply sources for today's information society.

The performance required for lithium-ion secondary batteries includes much higher energy density, improved cycle performance, safety under a variety of environments, improved long-term reliability, and the like.

Thus, improvement of a positive electrode active material has been studied to improve the cycle performance and increase the capacity of lithium-ion secondary batteries (Patent Document 1 and Patent Document 2). In addition, a crystal structure of a positive electrode active material also has been studied (Non-Patent Document 1 to Non-Patent Document 3).

X-ray diffraction (XRD) is one of methods used for analysis of a crystal structure of a positive electrode active material. With the use of the ICSD (Inorganic Crystal Structure Database) described in Non-Patent Document 5, XRD data can be analyzed.

Patent Document 3 describes the Jahn-Teller effect in nickel-based layered oxide.

### REFERENCE

### Patent Document

[Patent Document 1] Japanese Patent Application Laid-Open No. 2002-216760
[Patent Document 2] Japanese Patent Application Laid-Open No. 2006-261132
[Patent Document 3] Japanese Published Patent Application No. 2017-188466

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂, Journal of The Electrochemical Society, 2002, 149 (12) A1604-A1609.
[Non-Patent Document 4] W. E. Counts et al., Journal of the American Ceramic Society, (1953), 36 [1] 12-17. Fig. 01471.
[Non-Patent Document 5] Belsky, A. et al., “New developments in the Inorganic Crystal Structure Database (ICSD): accessibility in support of materials research and design”, Acta Cryst. (2002), B58, 364-369.

### SUMMARY OF THE INVENTION

### Problems to be Solved by the Invention

An object of one embodiment of the present invention is to provide a positive electrode active material that has high capacity and excellent charge and discharge cycle performance for a lithium-ion secondary battery, and a manufacturing method thereof. Alternatively, an object is to provide a manufacturing method of a positive electrode active material with high productivity. Alternatively, an object of one embodiment of the present invention is to provide a positive electrode active material that suppresses a decrease in capacity in charge and discharge cycles when used for a lithium-ion secondary battery. Alternatively, an object of one embodiment of the present invention is to provide a high-capacity secondary battery. Alternatively, an object of one embodiment of the present invention is to provide a secondary battery with excellent charge and discharge characteristics. Alternatively, an object is to provide a positive electrode active material in which elution of a transition metal such as cobalt is inhibited even when a state being charged with high voltage is held for a long time. Alternatively, an object of one embodiment of the present invention is to provide a highly safe or reliable secondary battery.

Alternatively, an object of one embodiment of the present invention is to provide a novel material, novel active material particles, a novel power storage device, or a manufacturing method thereof.

Note that the description of these objects does not preclude the existence of other objects. One embodiment of the present invention does not have to achieve all these objects. Note that other objects can be taken from the description of the specification, the drawings, and the claims.

### Means for Solving the Problems

One embodiment of the present invention is a positive electrode active material containing lithium, cobalt, magnesium, oxygen, and fluorine; when a pattern obtained by powder X ray diffraction using a CuKα1 ray is subjected to Rietveld analysis, the positive electrode active material has a crystal structure having a space group R-3m, greater than 2.814×10⁻¹⁰ m and less than 2.817×10⁻¹⁰ m is used, and a lattice constant of a c-axis is greater than 14.05×10⁻¹⁰ m and less than 14.07×10⁻¹⁰ m; and in analysis by X-ray photoelectron spectroscopy, a relative value of a magnesium concentration is higher than or equal to 1.6 and lower than or equal to 6.0 with the cobalt concentration regarded as 1.

Another embodiment of the present invention is a positive electrode active material containing lithium, cobalt, magnesium, oxygen, and fluorine. The positive electrode active material has a first diffraction peak at 2θ of greater than or equal to 19.10° and less than or equal to 19.50° and a second diffraction peak at 2θ of greater than or equal to 45.50° and less than or equal to 45.60° when a lithium-ion secondary battery using the positive electrode active material for a positive electrode and a lithium metal for a negative electrode is subjected to constant current charge at 25° C. until battery voltage becomes 4.7 V and then subjected to constant voltage charge until a current value becomes 0.01 C, and then the positive electrode is analyzed by powder X-ray diffraction using a CuKα1 ray.

In any of the above embodiments, the positive electrode active material preferably has a first diffraction peak at 2θ of greater than or equal to 19.10° and less than or equal to 19.50° and a second diffraction peak at 2θ of greater than or equal to 45.50° and less than or equal to 45.60° when a lithium-ion secondary battery using the positive electrode active material for a positive electrode and a lithium metal for a negative electrode is subjected to constant current charge at 25° C. until battery voltage becomes 4.7 V and then subjected to constant voltage charge until a current value becomes 0.01 C, and then the positive electrode is analyzed by powder X-ray diffraction using a CuKα1 ray.

In any of the above embodiments, a magnesium concentration measured by X-ray photoelectron spectroscopy is preferably higher than or equal to 1.6 and lower than or equal to 6.0 with the cobalt concentration regarded as 1.

In any of the above embodiments, the positive electrode active material preferably contains nickel, aluminum, and phosphorus.

One embodiment of the present invention is a manufacturing method of a positive electrode active material including a first step of mixing a lithium source, a fluorine source, and a magnesium source to form a first mixture; a second step of mixing a composite oxide containing lithium, cobalt, and oxygen and the first mixture to form a second mixture; a third step of heating the second mixture to form a third mixture; a fourth step of mixing the third mixture and an aluminum source to form a fourth mixture; and a fifth step of heating the fourth mixture to form a fifth mixture, and in the fourth step, the number of atoms of aluminum contained in the aluminum source is greater than or equal to 0.001 times and less than or equal to 0.02 times the number of atoms of cobalt contained in the third mixture.

In the above embodiment, the number of atoms of magnesium contained in the magnesium source in the first step is preferably greater than or equal to 0.005 times and less than or equal to 0.05 times the number of atoms of cobalt contained in the composite oxide in the second step.

### Effect of the Invention

According to one embodiment of the present invention, a positive electrode active material that has high capacity and excellent charge and discharge cycle performance for a lithium-ion secondary battery, and a manufacturing method thereof can be provided. In addition, a manufacturing method of a positive electrode active material with high productivity can be provided. In addition, a positive electrode active material that suppresses a decrease in capacity in charge and discharge cycles when used in a lithium-ion secondary battery can be provided. In addition, a high-capacity secondary battery can be provided. In addition, a secondary battery with excellent charge and discharge characteristics can be provided. In addition, a positive electrode active material in which elution of a transition metal such as cobalt is inhibited even when a state being charged with high voltage is held for a long time can be provided. In addition, a highly safe or reliable secondary battery can be provided. In addition, a novel material, novel active material particles, a novel power storage device, or a manufacturing method thereof can be provided.

### BRIEF DESCRIPTION OF THE DRAWINGS

FIG. 1 is a diagram illustrating the charge depth and crystal structures of a positive electrode active material.

FIG. 2 is a diagram illustrating the charge depth and crystal structures of a positive electrode active material.

FIG. 3 is an XRD pattern calculated from crystal structures.

FIG. 4(A) shows a lattice constant calculated from XRD. FIG. 4(B) shows a lattice constant calculated from XRD. FIG. 4(C) shows a lattice constant calculated from XRD.

FIG. 5(A) shows a lattice constant calculated from XRD. FIG. 5(B) shows a lattice constant calculated from XRD. FIG. 5(C) shows a lattice constant calculated from XRD.

FIG. 6 is a diagram showing an example of a manufacturing method of a positive electrode active material of one embodiment of the present invention.

FIG. 7 is a diagram showing an example of a manufacturing method of a positive electrode active material of one embodiment of the present invention.

FIG. 8 is a diagram showing an example of a manufacturing method of a positive electrode active material of one embodiment of the present invention.

FIG. 9 is a diagram showing an example of a manufacturing method of a positive electrode active material of one embodiment of the present invention.

FIG. 10(A) is a cross-sectional view of an active material layer when a graphene compound is used as a conductive additive. FIG. 10(B) is a cross-sectional view of an active material layer when a graphene compound is used as a conductive additive.

FIG. 11(A) is a diagram showing a charge method of a secondary battery. FIG. 11(B) is a diagram showing a charge method of a secondary battery. FIG. 11(C) is a diagram showing a charge method of a secondary battery.

FIG. 12(A) is a diagram showing a charge method of a secondary battery. FIG. 12(B) is a diagram showing a charge method of a secondary battery. FIG. 12(C) is a diagram showing a charge method of a secondary battery.

FIG. 13(A) is a diagram showing a charge method of a secondary battery. FIG. 13(B) is a diagram showing a charge method of a secondary battery.

FIG. 14(A) is a diagram illustrating a coin-type secondary battery. FIG. 14(B) is a diagram illustrating a coin-type secondary battery. FIG. 14(C) is a diagram illustrating current and electrons in charge.

FIG. 15(A) is a diagram illustrating a cylindrical secondary battery. FIG. 15(B) is a diagram illustrating a cylindrical secondary battery. FIG. 15(C) is a diagram illustrating a plurality of cylindrical secondary batteries. FIG. 15(D) is a diagram illustrating a plurality of cylindrical secondary batteries.

FIG. 16(A) is a diagram illustrating an example of a battery pack. FIG. 16(B) is a diagram illustrating an example of a battery pack.

FIG. 17(A1) is a diagram illustrating an example of a secondary battery. FIG. 17(A2) is a diagram illustrating an example of a secondary battery. FIG. 17(B1) is a diagram illustrating an example of a secondary battery. FIG. 17(B2) is a diagram illustrating an example of a secondary battery.

FIG. 18(A) is a diagram illustrating an example of a secondary battery. FIG. 18(B) is a diagram illustrating an example of a secondary battery.

FIG. 19 is a diagram illustrating an example of a secondary battery.

FIG. 20(A) is a diagram illustrating a laminated secondary battery. FIG. 20(B) is a diagram illustrating a laminated secondary battery. FIG. 20(C) is a diagram illustrating a laminated secondary battery.

FIG. 21(A) is a diagram illustrating a laminated secondary battery. FIG. 21(B) is a diagram illustrating a laminated secondary battery.

FIG. 22 is an external view of a secondary battery.

FIG. 23 is an external view of a secondary battery.

FIG. 24(A) is a diagram illustrating a method for forming a secondary battery. FIG. 24(B) is a diagram illustrating a method for forming a secondary battery. FIG. 24(C) is a diagram illustrating a method for forming a secondary battery.

FIG. 25(A) is a diagram illustrating a bendable secondary battery. FIG. 25(B1) is a diagram illustrating a bendable secondary battery. FIG. 25(B2) is a diagram illustrating a bendable secondary battery. FIG. 25(C) is a diagram illustrating a bendable secondary battery.

FIG. 25(D) is a diagram illustrating a bendable secondary battery.

FIG. 26(A) is a diagram illustrating a bendable secondary battery. FIG. 26(B) is a diagram illustrating a bendable secondary battery.

FIG. 27(A) is a diagram illustrating an example of an electronic device. FIG. 27(B) is a diagram illustrating an example of an electronic device. FIG. 27(C) is a diagram illustrating an example of an electronic device. FIG. 27(D) is a diagram illustrating an example of an electronic device. FIG. 27(E) is a diagram illustrating an example of an electronic device. FIG. 27(F) is a diagram illustrating an example of an electronic device. FIG. 27(G) is a diagram illustrating an example of an electronic device. FIG. 27(H) is a diagram illustrating an example of an electronic device.

FIG. 28(A) is a diagram illustrating an example of an electronic device. FIG. 28(B) is a diagram illustrating an example of an electronic device. FIG. 28(C) is a diagram illustrating an example of an electronic device.

FIG. 29 is a diagram illustrating examples of electronic devices.

FIG. 30(A) is a diagram illustrating an example of a vehicle. FIG. 30(B) is a diagram illustrating an example of a vehicle. FIG. 30(C) is a diagram illustrating an example of a vehicle.

FIG. 31(A) shows continuous charge tolerance of secondary batteries. FIG. 31(B) shows continuous charge tolerance of secondary batteries.

FIG. 32(A) shows continuous charge tolerance of secondary batteries. FIG. 32(B) shows continuous charge tolerance of secondary batteries.

FIG. 33(A) shows cycle performance of secondary batteries. FIG. 33(B) shows cycle performance of secondary batteries.

FIG. 34(A) shows an XRD evaluation result of a positive electrode. FIG. 34(B) shows an XRD evaluation result of a positive electrode.

FIG. 35(A) shows an XRD evaluation result of a positive electrode. FIG. 35(B) shows an XRD evaluation result of a positive electrode.

FIG. 36(A) shows continuous charge tolerance of secondary batteries. FIG. 36(B) shows continuous charge tolerance of secondary batteries.

FIG. 37 shows cycle performance of secondary batteries.

FIG. 38(A) shows charge and discharge curves of a secondary battery. FIG. 38(B) shows charge and discharge curves of a secondary battery. FIG. 38(C) shows charge and discharge curves of a secondary battery.

FIG. 39(A) shows a TEM observation result of a positive electrode active material. FIG. 39(B) shows an EDX analysis result of a positive electrode active material.

FIG. 40(A) shows XRD evaluation results of positive electrodes. FIG. 40(B) shows XRD evaluation results of positive electrodes.

### MODE FOR CARRYING OUT THE INVENTION

Embodiments of the present invention are described in detail with reference to the drawings. Note that the present invention is not limited to the following description, and it is readily understood by those skilled in the art that modes and details of the present invention can be modified in various ways. In addition, the present invention should not be construed as being limited to the description of embodiments below.

In addition, in this specification and the like, crystal planes and orientations are indicated by the Miller index. In the crystallography, a bar is placed over a number in the expression of crystal planes and orientations; however, in this specification and the like, crystal planes and orientations are in some cases expressed by placing a minus sign (−) at the front of a number instead of placing the bar over the number because of patent expression limitations. Furthermore, an individual direction which shows an orientation in a crystal is denoted by “[ ]”, a set direction which shows all of the equivalent orientations is denoted by “< >”, an individual plane which shows a crystal plane is denoted by “( )”, and a set plane having equivalent symmetry is denoted by “{ }”.

In this specification and the like, segregation refers to a phenomenon in which in a solid made of a plurality of elements (e.g., A, B, and C), a certain element (e.g., B) is spatially non-uniformly distributed.

In this specification and the like, a surface portion of a particle of an active material or the like refers to a region from a surface to a depth of approximately 10 nm. A plane generated by a crack may also be referred to as a surface. In addition, a region whose position is deeper than that of the surface portion is referred to as an inner portion.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In addition, in this specification and the like, a rock-salt crystal structure refers to a structure in which cations and anions are alternately arranged. Note that a cation or anion vacancy may exist.

In addition, in this specification and the like, a pseudo-spinel crystal structure of a composite oxide containing lithium and a transition metal refers to a space group R-3m, which is not a spinel crystal structure but a crystal structure in which oxygen is hexacoordinated to ions such as cobalt and magnesium, and the cation arrangement has symmetry similar to that of the spinel crystal structure. Note that in the pseudo-spinel crystal structure, oxygen is tetracoordinated to a light element such as lithium in some cases. Also in that case, the ion arrangement has symmetry similar to that of the spinel crystal structure.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure generally.

Anions of a layered rock-salt crystal and anions of a rock-salt crystal have cubic closest packed structures (face-centered cubic lattice structures). Anions of a pseudo-spinel crystal are also presumed to have cubic closest packed structures. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic closest packed structures composed of anions in the layered rock-salt crystal, the pseudo-spinel crystal, and the rock-salt crystal are aligned is referred to as a state where crystal orientations are substantially aligned in some cases.

Whether the crystal orientations in two regions are substantially aligned can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, and the like. X-ray diffraction (XRD), electron diffraction, neutron diffraction, and the like can also be used for judging. In the TEM image and the like, alignment of cations and anions can be observed as repetition of bright lines and dark lines. When the orientations of cubic closest packed structures in the layered rock-salt crystal and the rock-salt crystal are aligned, a state where an angle made by the repetition of bright lines and dark lines in the layered rock-salt crystal and the rock-salt crystal is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

In addition, in this specification and the like, theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In addition, in this specification and the like, charge depth obtained when all lithium that can be inserted and extracted is inserted is 0, and charge depth obtained when all lithium that can be inserted and extracted and is contained in a positive electrode active material is extracted is 1.

In addition, in this specification and the like, charge refers to transfer of lithium ions from a positive electrode to a negative electrode in a battery and transfer of electrons from a negative electrode to a positive electrode in an external circuit. For a positive electrode active material, extraction of lithium ions is called charge. A positive electrode active material with a charge depth of greater than or equal to 0.7 and less than or equal to 0.9 may be referred to as a positive electrode active material charged with a high voltage.

Similarly, discharge refers to transfer of lithium ions from a negative electrode to a positive electrode in a battery and transfer of electrons from a positive electrode to a negative electrode in an external circuit. Discharge of a positive electrode active material refers to insertion of lithium ions. Furthermore, a positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material.

In addition, in this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

### Embodiment 1

In this embodiment, a positive electrode active material of one embodiment of the present invention is described.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. As an example of the element M, one or more elements selected from Co and Ni can be given. As another example of the element M, in addition to one or more elements selected from Co and Ni, one or more elements selected from Al and Mn can be given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charge and discharge are performed on LiNiO₂, the crystal structure might be disordered because of the distortion. The influence of the Jahn-Teller effect is suggested to be small in LiCoO₂; hence, LiCoO₂ is preferable because the resistance to high-voltage charge and discharge is higher in some cases.

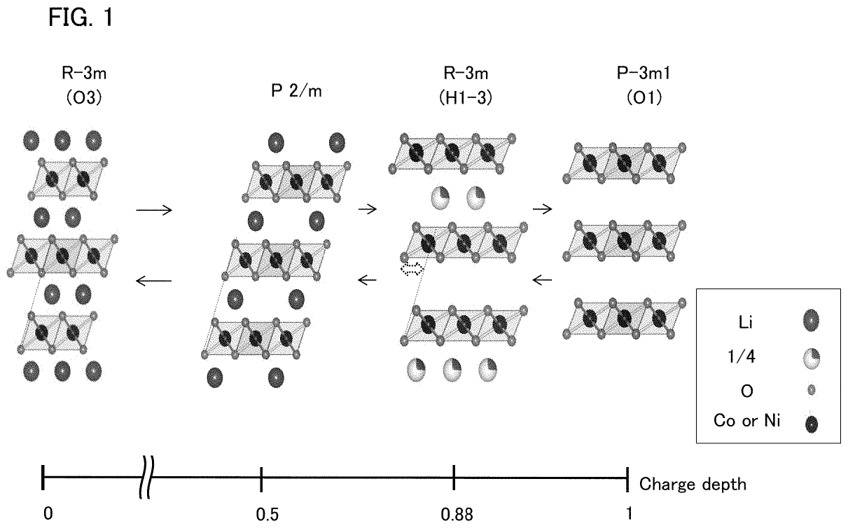

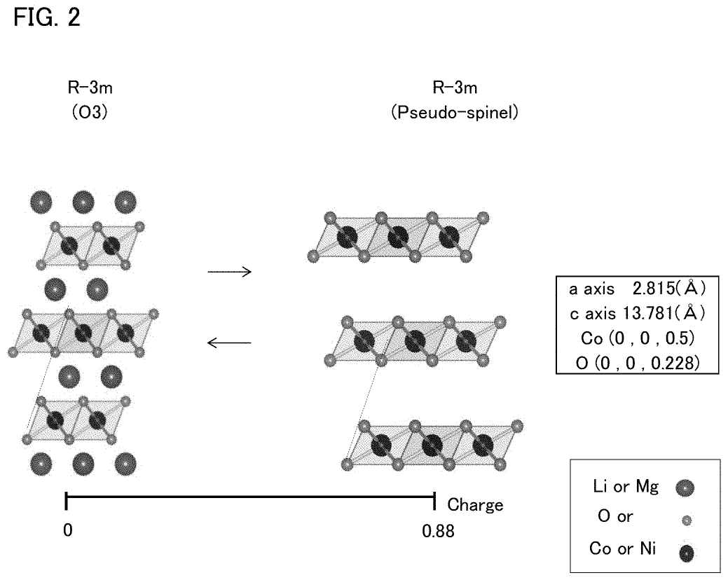

Positive electrode active materials are described with reference to FIG. 1 and FIG. 2. In FIG. 1 and FIG. 2, the case where cobalt is used as a transition metal contained in the positive electrode active material is described.

### <Positive Electrode Active Material 1>

A positive electrode active material 100C shown in FIG. 2 is lithium cobalt oxide (LiCoO₂) to which halogen and magnesium are not added in a formation method described later. As described in Non-Patent Document 1, Non-Patent Document 2, and the like, the crystal structure of lithium cobalt oxide shown in FIG. 2 changes depending on the charge depth.

As illustrated in FIG. 1, lithium cobalt oxide with a charge depth of 0 (the discharged state) includes a region having the crystal structure of the space group R-3m, and includes three CoO₂ layers in a unit cell. Thus, this crystal structure is referred to as an O₃-type crystal structure in some cases. Note that the CoO₂ layer has a structure in which octahedral geometry with oxygen atoms hexacoordinated to cobalt continues on a plane in the edge-sharing state.

Furthermore, when the charge depth is 1, LiCoO₂ has the crystal structure of the space group P-3m1, and one CoO₂ layer exists in a unit cell. Thus, this crystal structure is referred to as an O1-type crystal structure in some cases.

Moreover, lithium cobalt oxide when the charge depth is approximately 0.88 has the crystal structure of the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 1, the c-axis of the H1-3 type crystal structure is described half that of the unit cell for easy comparison with the other structures.

For the H1-3 type structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type structure is represented by a unit cell including one cobalt and two oxygen. Meanwhile, the pseudo-spinel crystal structure of one embodiment of the present invention is preferably represented by a unit cell including one cobalt and one oxygen, as described later. This means that the symmetry of cobalt and oxygen differs between the pseudo-spinel structure and the H1-3 type structure, and the amount of change from the O₃ structure is smaller in the pseudo-spinel structure than in the H1-3 type structure. A preferred unit cell for representing a crystal structure in a positive electrode active material is selected such that the value of GOF (good of fitness) is smaller in Rietveld analysis of XRD patterns, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type structure and the R-3m (O₃) structure in a discharged state.

However, there is a large deviation in the position of the CoO₂ layer between these two crystal structures. As indicated by the dotted line and the arrow in FIG. 1, the CoO₂ layer in the H1-3 type crystal structure largely deviates from that in R-3m (O3). Such a dynamic structural change might adversely affect the stability of the crystal structure.

A difference in volume is also large. A difference in volume in comparison with the same number of cobalt atoms between the H1-3 type crystal structure and the O3-type crystal structure in the discharged state is 3.0% or more.

In addition, a structure in which CoO₂ layers are continuous, such as P-3m1 (O1), included in the H1-3 type crystal structure is highly likely to be unstable.

Thus, the repeated high-voltage charge and discharge break the crystal structure of lithium cobalt oxide. The break of the crystal structure degrades the cycle performance. This is probably because the break of the crystal structure reduces sites where lithium can stably exist and makes it difficult to insert and extract lithium.

### <Positive Electrode Active Material 2>

### <<Inner Portion>>

In the positive electrode active material of one embodiment of the present invention, the difference in the positions of CoO₂ layers can be small in repeated charge and discharge at high voltage. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high-voltage charged state. Thus, in the positive electrode active material of one embodiment of the present invention, a short circuit is less likely to occur while the high-voltage charged state is maintained. This is preferable because the safety is further improved.

In the positive electrode active material of one embodiment of the present invention, there is a small difference in change in the crystal structure and volume in comparison with the same number of transition metal atoms between the sufficiently discharged state and the high-voltage charged state.

FIG. 2 illustrates the crystal structures of the positive electrode active material 100A before and after being charged and discharged. The positive electrode active material 100A is a composite oxide containing lithium, cobalt, and oxygen. In addition to the above, the positive electrode active material 100A preferably contains magnesium. Furthermore, the positive electrode active material 100A preferably contains halogen such as fluorine or chlorine.

The crystal structure with a charge depth of 0 (the discharged state) in FIG. 2 is R-3m (O3), which is the same as that in FIG. 1. Meanwhile, the positive electrode active material 100A with a charge depth in a sufficiently charged state includes a crystal whose structure is different from the H1-3 type structure. This structure belongs to the space group R-3m, and is not a spinel crystal structure but a structure in which an ion of cobalt, magnesium, or the like is coordinated to six oxygen atoms and the cation arrangement has symmetry similar to that of the spinel crystal structure. This structure is thus referred to as the pseudo-spinel crystal structure in this specification and the like. Note that although the indication of lithium is omitted in the diagram of the pseudo-spinel crystal structure shown in FIG. 2 to explain the symmetry of cobalt atoms and the symmetry of oxygen atoms, a lithium of 20 atomic % or less, for example, with respect to cobalt practically exists between the CoO₂ layers. In addition, in both the O₃-type crystal structure and the pseudo-spinel crystal structure, a slight amount of magnesium preferably exists between the CoO₂ layers, i.e., in lithium sites. In addition, a slight amount of halogen such as fluorine preferably exists in oxygen sites at random.

Note that in the pseudo-spinel crystal structure, oxygen is tetracoordinated to a light element such as lithium in some cases. Also in that case, the ion arrangement has symmetry similar to that of the spinel crystal structure.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure generally.

Anions of a layered rock-salt crystal and anions of a rock-salt crystal have cubic closest packed structures (face-centered cubic lattice structures). Anions of a pseudo-spinel crystal are also presumed to have cubic closest packed structures. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic closest packed structures composed of anions in the layered rock-salt crystal, the pseudo-spinel crystal, and the rock-salt crystal are aligned is referred to as a state where crystal orientations are substantially aligned in some cases.

In the positive electrode active material 100A, a change in the crystal structure when the positive electrode active material 100A is charged with high voltage and a large amount of lithium is extracted is inhibited as compared with the positive electrode active material 100C. As indicated by the dotted lines in FIG. 2, for example, there is a very little deviation in the CoO₂ layers between the crystal structures.

More specifically, the structure of the positive electrode active material 100A is highly stable even when a charge voltage is high. For example, at a charge voltage that makes the positive electrode active material 100C have the H1-3 crystal structure, for example, at a voltage of approximately 4.6 V with reference to the potential of lithium metal, the positive electrode active material 100A can have the R-3m (O3) crystal structure. Moreover, in a higher charge voltage region, for example, at voltages of approximately 4.65 V to 4.7 V with reference to the potential of lithium metal, the pseudo-spinel crystal structure can be obtained. At a much higher charge voltage, the H1-3 type structure is eventually observed in some cases. In the case where graphite, for instance, is used as a negative electrode active material in a secondary battery, when the voltage of the secondary battery ranges from 4.3 V to 4.5 V, for example, the R-3m (O3) crystal structure can be maintained. In a higher charge voltage region, for example, at voltages of 4.35 V to 4.55 V with reference to the potential of lithium metal, the pseudo-spinel crystal structure can be obtained.

Thus, in the positive electrode active material 100A, the crystal structure is less likely to be disordered even when charge and discharge are repeated at high voltage.

Note that in the unit cell of the pseudo-spinel crystal structure, coordinates of cobalt and oxygen can be represented by Co (0, 0, 0.5) and 0 (0, 0, x) within the range of 0.20≤x≤0.25.

A slight amount of magnesium existing between the CoO₂ layers, i.e., in lithium sites at random, has an effect of inhibiting a deviation in the CoO₂ layers. Thus, the existence of magnesium between the CoO₂ layers makes it easier to obtain the pseudo-spinel crystal structure. Therefore, magnesium is preferably distributed over whole particles of the positive electrode active material 100A. In addition, to distribute magnesium over whole particles, heat treatment is preferably performed in the formation process of the positive electrode active material 100A.

However, cation mixing occurs when the heat treatment temperature is excessively high, so that magnesium is highly likely to enter the cobalt sites. Magnesium in the cobalt sites eliminates the effect of maintaining the R-3m structure. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over whole particles. The addition of the halogen compound decreases the melting point of lithium cobalt oxide. The decrease in the melting point makes it easier to distribute magnesium over whole particles at a temperature at which the cation mixing is unlikely to occur. Furthermore, the existence of the fluorine compound expects to improve corrosion resistance to hydrofluoric acid generated by decomposition of an electrolyte solution.

When the magnesium concentration is higher than a predetermined value, the effect of stabilizing a crystal structure becomes small in some cases. This is probably because magnesium enters the cobalt sites in addition to the lithium sites. The number of magnesium atoms in the positive electrode active material of one embodiment of the present invention is preferably 0.001 to 0.1 times, preferably larger than 0.01 times and less than 0.04 times, still further preferably approximately 0.02 times the number of cobalt atoms. The magnesium concentration described here may be a value obtained by element analysis on the entire particles of the positive electrode active material using ICP-MS or the like, or may be a value based on the ratio of the raw materials mixed in the formation process of the positive electrode active material, for example.

To lithium cobalt oxide, as a metal other than cobalt (hereinafter, a metal Z), one or more metals selected from nickel, aluminum, manganese, titanium, vanadium, and chromium may be added, for example, and in particular, at least one of nickel and aluminum is preferably added. In some cases, manganese, titanium, vanadium, and chromium are likely to have a valence of four stably and thus contribute highly to a stable structure. The addition of the metal Z may enable the positive electrode active material of one embodiment of the present invention to have a more stable crystal structure in high-voltage charge, for example. Here, in the positive electrode active material of one embodiment of the present invention, the metal Z is preferably added at a concentration at which the crystallinity of the lithium cobalt oxide is not greatly changed. For example, the metal Z is preferably added at an amount with which the aforementioned Jahn-Teller effect is not exhibited.

As the magnesium concentration in the positive electrode active material of one embodiment of the present invention increases, the capacity of the positive electrode active material decreases in some cases. As an example, one possible reason is that the amount of lithium that contributes to charge and discharge decreases when magnesium enters the lithium sites. Another possible reason is that excess magnesium generates a magnesium compound that does not contribute to charge and discharge. When the positive electrode active material of one embodiment of the present invention contains nickel as the metal Z in addition to magnesium, the capacity per weight and per volume can be increased in some cases. When the positive electrode active material of one embodiment of the present invention contains aluminum as the metal Z in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements, such as magnesium and the metal Z, contained in the positive electrode active material of one embodiment of the present invention are described below using the number of atoms.

The number of nickel atoms in the positive electrode active material of one embodiment of the present invention is preferably 7.5% or less, further preferably 0.05% to 4%, still further preferably 0.1% to 2% of the number of cobalt atoms. The nickel concentration described here may be a value obtained by element analysis on the entire particle of the positive electrode active material using ICP-MS or the like, or may be a value based on the ratio of the raw materials mixed in the process of forming the positive electrode active material, for example.

The number of aluminum atoms in the positive electrode active material of one embodiment of the present invention is preferably 0.05% to 4%, further preferably 0.1% to 2% of the number of cobalt atoms. The aluminum concentration described here may be a value obtained by element analysis on the entire particle of the positive electrode active material using ICP-MS or the like, or may be a value based on the ratio of the raw materials mixed in the process of forming the positive electrode active material, for example.

It is preferable that the positive electrode active material of one embodiment of the present invention contain an element X, and phosphorus be used as the element X. The positive electrode active material of one embodiment of the present invention further preferably includes a compound containing phosphorus and oxygen.

When the positive electrode active material of one embodiment of the present invention includes a compound containing the element X, a short circuit is less likely to occur while the high-voltage charged state is maintained in some cases.

When the positive electrode active material of one embodiment of the present invention contains phosphorus as the element X, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion and coating film separation of a current collector in some cases. Furthermore, the decrease in hydrogen fluoride concentration in the electrolyte solution can inhibit a reduction in adhesion properties due to gelling or insolubilization of PVDF in some cases.

When containing magnesium in addition to the element X, the positive electrode active material of one embodiment of the present invention is extremely stable in the high-voltage charged state. When the element X is phosphorus, the number of phosphorus atoms is preferably 1% or more and 20% or less, further preferably 2% or more and 10% or less, still further preferably 3% or more and 8% or less of the number of cobalt atoms. In addition, the number of magnesium atoms is preferably 0.1% or more and 10% or less, further preferably 0.5% or more and 5% or less, still further preferably 0.7% or more and 4% or less of the number of cobalt atoms. The phosphorus concentration and the magnesium concentration described here may each be a value obtained by element analysis on the entire particle of the positive electrode active material using inductively coupled plasma mass spectrometry (ICP-MS) or the like, or may be a value based on the ratio of the raw materials mixed in the process of forming the positive electrode active material, for example.

In the case where the positive electrode active material has a crack, phosphorus, more specifically, a compound containing phosphorus and oxygen, in the inner portion of the crack may inhibit crack development, for example

### <<Surface Portion>>

Magnesium is preferably distributed over whole particles of the positive electrode active material 100A, and further preferably, the magnesium concentration in the surface portion of the particle is higher than the average in whole particles. For example, the magnesium concentration in the surface portion of the particle that is measured by XPS or the like is preferably higher than the average magnesium concentration in whole particles measured by ICP-MS or the like.

In the case where the positive electrode active material 100A contains an element other than cobalt, for example, one or more metals selected from nickel, aluminum, manganese, iron, and chromium, the concentration of the metal(s) in the surface portion of the particle is preferably higher than the average concentration of the metal(s) in the whole particle. For example, the concentration of the element other than cobalt in the surface portion of the particle measured by XPS or the like is preferably higher than the average concentration of the element in the whole particle measured by ICP-MS or the like.

The entire surface of the particle is a kind of crystal defects and lithium is extracted from the surface during charge; thus, the lithium concentration in the surface of the particle tends to be lower than that inside the particle. Therefore, the surface of the particle tends to be unstable and its crystal structure is likely to be broken. The higher the magnesium concentration in the surface portion is, the more effectively the change in the crystal structure can be inhibited. In addition, a high magnesium concentration in the surface portion expects to improve the corrosion resistance to hydrofluoric acid generated by the decomposition of the electrolyte solution.

In addition, the concentration of halogen such as fluorine in the surface portion of the positive electrode active material 100A is preferably higher than the average concentration of halogen such as fluorine in whole particles. When halogen exists in the surface portion that is a region in contact with the electrolyte solution, the corrosion resistance to hydrofluoric acid can be effectively improved.

In this manner, the surface portion of the positive electrode active material 100A preferably has higher concentrations of magnesium and fluorine than those in the inner portion and a composition different from that in the inner portion. In addition, the composition preferably has a crystal structure stable at normal temperature. Thus, the surface portion may have a crystal structure different from that of the inner portion. For example, at least part of the surface portion of the positive electrode active material 100A may have a rock-salt crystal structure. Furthermore, in the case where the surface portion and the inner portion have different crystal structures, the orientations of crystals in the surface portion and the inner portion are preferably substantially aligned.

Note that in the surface portion where only MgO is contained or MgO and CoO(II) form a solid solution, it is difficult to insert and extract lithium. Thus, the surface portion should contain at least cobalt, and further contain lithium in the discharged state to have a path through which lithium is inserted and extracted. In addition, the cobalt concentration is preferably higher than the magnesium concentration.

The element X is preferably positioned in the vicinity of the surface of the particle in the positive electrode active material 100A. For example, the positive electrode active material 100A may be covered with a coating film containing the element X.

### <<Grain Boundary>>

A slight amount of magnesium or halogen contained in the positive electrode active material 100A may randomly exist in the inner portion, but part of the element is further preferably segregated at a grain boundary.

In other words, the magnesium concentration in the crystal grain boundary and its vicinity of the positive electrode active material 100A is preferably higher than that in the other regions in the inner portion. In addition, the halogen concentration in the crystal grain boundary and its vicinity is also preferably higher than that in the other regions in the inner portion.

Like the particle surface, the crystal grain boundary is also a plane defect. Thus, the crystal grain boundary tends to be unstable and its crystal structure easily starts to change. Therefore, the higher the magnesium concentration in the crystal grain boundary and its vicinity is, the more effectively the change in the crystal structure can be inhibited.

Furthermore, even when cracks are generated along the crystal grain boundary of the particle of the positive electrode active material 100A, high concentrations of magnesium and halogen in the crystal grain boundary and its vicinity increase the concentrations of magnesium and halogen in the vicinity of a surface generated by the cracks. Thus, the positive electrode active material after the cracks are generated can also have increased corrosion resistance to hydrofluoric acid.

Note that in this specification and the like, the vicinity of the crystal grain boundary refers to a region of approximately 10 nm from the grain boundary.

### <<Particle Size>>

A too large particle size of the positive electrode active material 100A causes problems such as difficulty in lithium diffusion and too much surface roughness of an active material layer in coating to a current collector. By contrast, a too small particle size causes problems such as difficulty in carrying the active material layer in coating to the current collector and overreaction with an electrolyte solution. Therefore, an average particle diameter (D50, also referred to as median diameter) is preferably more than or equal to 1 μm and less than or equal to 100 μm, further preferably more than or equal to 2 μm and less than or equal to 40 μm, still further preferably more than or equal to 5 μm and less than or equal to 30 μm.

### <Analysis Method>

Whether or not a positive electrode active material is the positive electrode active material 100A of one embodiment of the present invention that has the pseudo-spinel crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described so far, the positive electrode active material 100A of one embodiment of the present invention has a feature of a small change in the crystal structure between the high-voltage charged state and the discharged state. A material where 50 wt % or more of the crystal structure largely changes between the high-voltage charged state and the discharged state is not preferable because the material cannot withstand the high-voltage charge and discharge. In addition, it should be noted that an objective crystal structure is not obtained in some cases only by addition of impurity elements. For example, although the positive electrode active material that is lithium cobalt oxide containing magnesium and fluorine is a commonality, the positive electrode active material has 60 wt % or more of the pseudo-spinel crystal structure in some cases, and has 50 wt % or more of the H1-3 type crystal structure in other cases, when charged with high voltage. Furthermore, at a predetermined voltage, the positive electrode active material has almost 100 wt % of the pseudo-spinel crystal structure, and with an increase in the predetermined voltage, the H1-3 type crystal structure is generated in some cases. Thus, analysis of the crystal structure, including XRD, is needed to determine whether or not the positive electrode active material is the positive electrode active material 100A of one embodiment of the present invention.

Note that a positive electrode active material in the high-voltage charged state or the discharged state sometimes causes a change in the crystal structure when exposed to air. For example, the pseudo-spinel crystal structure changes into the H1-3 type crystal structure in some cases. Thus, all samples are preferably handled in an inert atmosphere such as an argon atmosphere.

### <<Charge Method>>

High-voltage charge for determining whether or not a composite oxide is the positive electrode active material 100A of one embodiment of the present invention can be performed on a coin cell (CR2032 type with a diameter of 20 mm and a height of 3.2 mm) with a lithium counter electrode, for example.

More specifically, a positive electrode current collector made of aluminum foil that is coated with slurry in which a positive electrode active material, a conductive additive, and a binder are mixed can be used as a positive electrode.

A lithium metal can be used for the counter electrode. Note that when a material other than the lithium metal is used for the counter electrode, the potential of a secondary battery differs from the potential of the positive electrode. Unless otherwise specified, voltages and potentials in this specification and the like refer to the potentials of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

A positive electrode can and a negative electrode can that are formed using stainless steel (SUS) can be used as a positive electrode can and a negative electrode can.

The coin cell formed under the above conditions is charged with constant current at 4.6 V and 0.5 C and then charged with constant voltage until the current value reaches 0.01 C. Note that here, 1 C is set to 137 mA/g, and the temperature is set to 25° C. The temperature is set to 25° C. After the charge is performed in this manner, the coin cell is disassembled in a glove box with an argon atmosphere and the positive electrode is taken out, whereby the high-voltage charged positive electrode active material can be obtained. In order to inhibit reaction with components in the external world, the positive electrode active material is preferably hermetically sealed in an argon atmosphere when performing various analyses later. For example, XRD can be performed on the positive electrode active material enclosed in an airtight container with an argon atmosphere.

### <<XRD>>

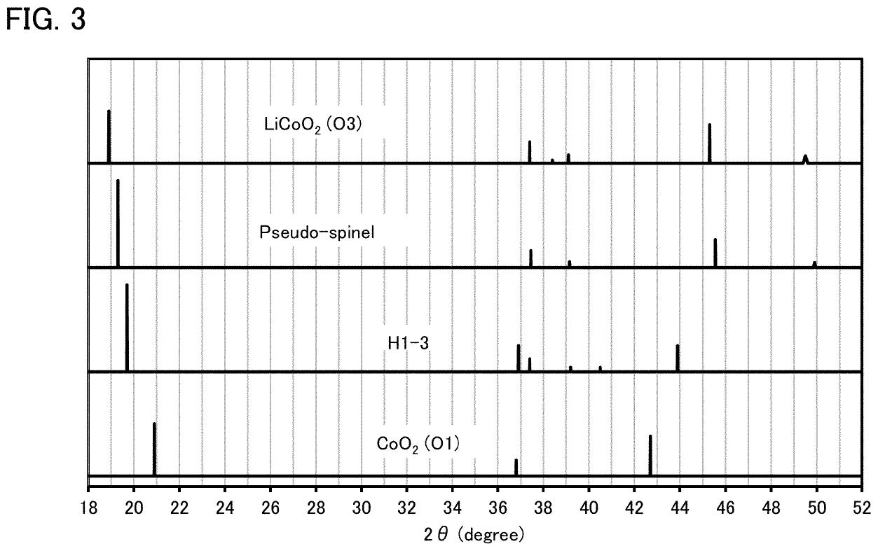

FIG. 3 shows ideal powder XRD patterns with the CuKα1 ray that were calculated from models of the pseudo-spinel crystal structure and the H1-3 crystal structure. In addition, for comparison, FIG. 3 also shows ideal XRD patterns calculated from the crystal structures of LiCoO₂ (O3) with a charge depth of 0 and CoO₂ (O1) with a charge depth of 1. Note that the patterns of LiCoO₂ (O3) and CoO₂ (O1) are made from crystal structure data obtained from ICSD (Inorganic Crystal Structure Database) (Non-Patent Document 5) using Reflex Powder Diffraction, which is a module of Materials Studio (BIOVIA). The range of 20 is from 15° to 75°, Step size is 0.01, the wavelength λ1 is 1.540562×10⁻¹⁰ m, λ2 is not set, and Monochromator is a single monochromator. The pattern of the H1-3 type crystal structure is made from the crystal structure data disclosed in Non-Patent Document 3 in a similar manner. The pattern of the pseudo-spinel crystal structure is estimated from the XRD pattern of the positive electrode active material of one embodiment of the present invention, the crystal structure is fitted with TOPAS ver. 3 (crystal structure analysis software manufactured by Bruker Corporation), and XRD patterns are made in a manner similar to those of other structures.

As shown in FIG. 3, the pseudo-spinel crystal structure has diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.50° and less than or equal to 45.60°). However, in the H1-3 type crystal structure and CoO₂ (P-3m1, O1), peaks at these positions do not appear. Thus, the peaks at 2θ of 19.30±0.20° and 2θ of 45.55±0.10° in the high-voltage charged state can be the features of the positive electrode active material 100A of one embodiment of the present invention.

It can also be said that the positions where the XRD diffraction peaks appear are close in the crystal structure with a charge depth of 0 and the crystal structure in the high-voltage charged state. More specifically, a difference in the positions of two or more, further preferably three or more of the main diffraction peaks between both of the crystal structures is 29 of less than or equal to 0.7, further preferably 2θ of less than or equal to 0.5.

Note that although the positive electrode active material 100A of one embodiment of the present invention has the pseudo-spinel crystal structure when being charged with high voltage, not all the particles necessarily have the pseudo-spinel crystal structure. The particles may have another crystal structure, or some of the particles may be amorphous. Note that when the XRD patterns are analyzed by the Rietveld analysis, the pseudo-spinel crystal structure preferably accounts for more than or equal to 50 wt %, further preferably more than or equal to 60 wt %, still further preferably more than or equal to 66 wt % of the positive electrode active material. The positive electrode active material in which the pseudo-spinel crystal structure accounts for more than or equal to 50 wt %, further preferably more than or equal to 60 wt %, still further preferably more than or equal to 66 wt % can have sufficiently good cycle performance.

Furthermore, even after 100 or more cycles of charge and discharge, the pseudo-spinel crystal structure preferably accounts for more than or equal to 35 wt %, further preferably more than or equal to 40 wt %, still further preferably more than or equal to 43 wt % when the Rietveld analysis is performed.

In addition, the crystallite size of the pseudo-spinel crystal structure included in the positive electrode active material particle is decreased to approximately one-tenth that of LiCoO₂ (O3) in the discharged state. Thus, a clear peak of the pseudo-spinel crystal structure can be observed after the high-voltage charge even under the same XRD measurement conditions as those of a positive electrode before the charge and discharge. By contrast, simple LiCoO₂ has a small crystallite size and a broad small peak even when it can have a structure part of which is similar to the pseudo-spinel crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described the metal Z in addition to cobalt as long as the influence of the Jahn-Teller effect is small.

The range of the lattice constant where the influence of the Jahn-Teller effect is presumed to be small in the positive electrode active material is examined by XRD analysis.

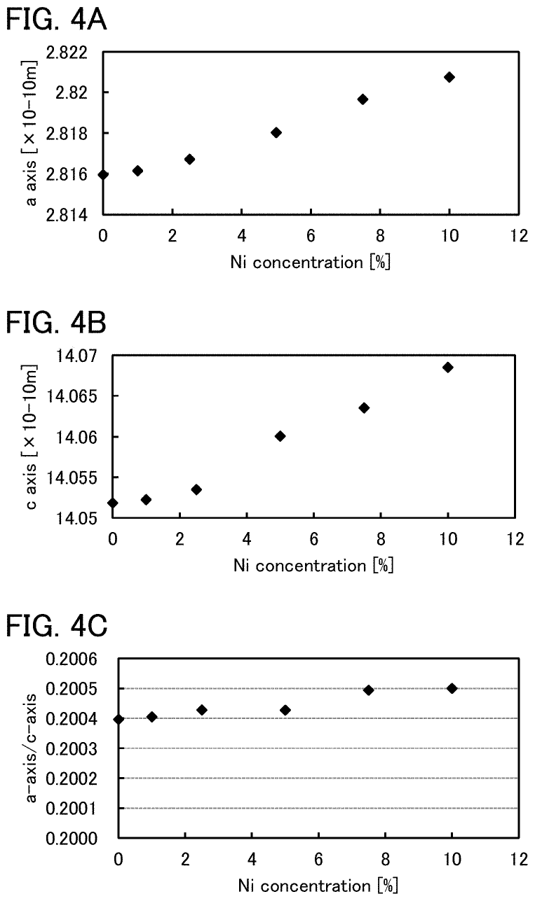

FIGS. 4(A) and 4(B) show the estimation results of the lattice constants of the a-axis and the c-axis by XRD in the case where the positive electrode active material of one embodiment of the present invention has a layered rock-salt crystal structure and contains cobalt and nickel. FIG. 4(A) shows the results of the a-axis, and FIG. 4(B) shows the results of the c-axis. Note that the XRD patterns of a powder after the synthesis of the positive electrode active material and before incorporation into a positive electrode are used for the calculation of the lattice constants shown in FIGS. 4(A) and 4(B). The nickel concentration on the horizontal axis represents a nickel concentration with the sum of cobalt atoms and nickel atoms regarded as 100%. The positive electrode active material is formed through Step S21 to Step S25, which are described later, and a cobalt source and a nickel source are used in Step S21. The nickel concentration represents a nickel concentration with the sum of cobalt atoms and nickel atoms regarded as 100% in Step S21.

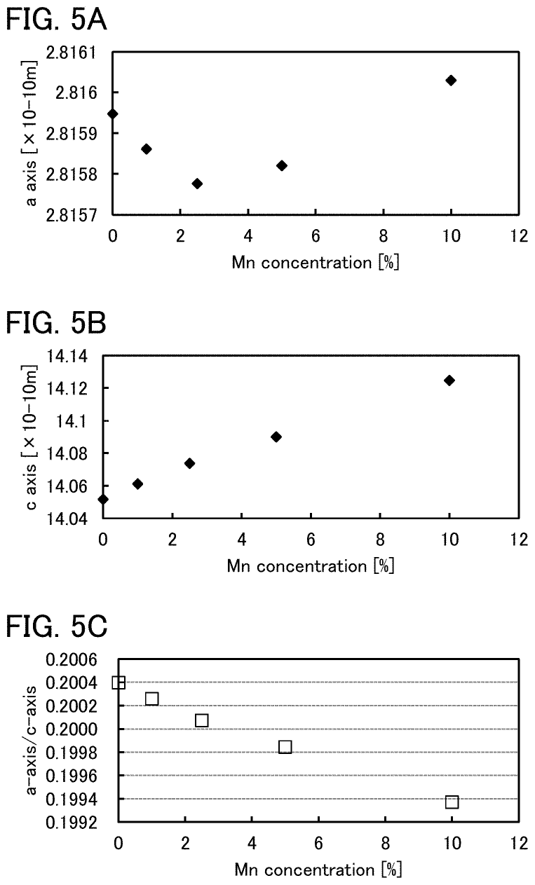

FIGS. 5(A) and 5(B) show the estimation results of the lattice constants of the a-axis and the c-axis by XRD in the case where the positive electrode active material of one embodiment of the present invention has a layered rock-salt crystal structure and contains cobalt and manganese. FIG. 5(A) shows the results of the a-axis, and FIG. 5(B) shows the results of the c-axis. Note that the XRD patterns of a powder after the synthesis of the positive electrode active material before incorporation into a positive electrode are used for the calculation of the lattice constants shown in FIGS. 5(A) and 5(B). The manganese concentration on the horizontal axis represents a manganese concentration with the sum of cobalt atoms and manganese atoms regarded as 100%. The positive electrode active material is formed through Step S21 to Step S25, which are described later, and a cobalt source and a nickel source are used in Step S21. The manganese concentration on the horizontal axis represents a manganese concentration with the sum of cobalt atoms and manganese atoms regarded as 100%.

FIG. 4(C) shows values obtained by dividing the lattice constants of the a-axis by the lattice constants of the c-axis (a-axis/c-axis) in the positive electrode active material, whose results of the lattice constants are shown in FIGS. 4(A) and 4(B). FIG. 5(C) shows values obtained by dividing the lattice constants of the a-axis by the lattice constants of the c-axis (a-axis/c-axis) in the positive electrode active material, whose results of the lattice constants are shown in FIGS. 5(A) and 5(B).

As shown in FIG. 4(C), the value of a-axis/c-axis tends to significantly change between nickel concentrations of 5% and 7.5%, indicating that the distortion of the a-axis becomes large. This distortion may be the Jahn-Teller distortion. It is suggested that an excellent positive electrode active material with small Jahn-Teller distortion can be obtained at a nickel concentration lower than 7.5%.

FIG. 5(A) indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion of the particle are not limited to the above ranges. In other words, the nickel concentration and the manganese concentration in the surface portion of the particle may be higher than the above concentrations.

Preferable ranges of the lattice constants of the positive electrode active material of one embodiment of the present invention are examined above. In the layered rock-salt crystal structure of the particle of the positive electrode active material in the discharged state or the state where charge and discharge are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charge and discharge are not performed may be the state of a powder before the formation of a positive electrode of a secondary battery.

Alternatively, in the layered rock-salt crystal structure of the particle of the positive electrode active material in the discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the particle of the positive electrode active material in the discharged state or the state where charge and discharge are not performed is subjected to XRD analysis, a first peak is observed at 2θ of 18.50° or greater and 19.30° or less, and a second peak is observed at 2θ of 38.00° or greater and 38.80° or less, in some cases.

### <<XPS>>

A region from the surface to a depth of approximately 2 to 8 nm (normally, approximately 5 nm) can be analyzed by X-ray photoelectron spectroscopy (XPS); thus, the concentration of each element in approximately half of the surface portion can be quantitatively analyzed. In addition, the bonding states of the elements can be analyzed by narrow scanning analysis. Note that the quantitative accuracy of XPS is approximately ±1 atomic % in many cases. The lower detection limit depends on the element but is approximately 1 atomic %.

When the positive electrode active material 100A is analyzed by XPS and the cobalt concentration is regarded as 1, the relative value of the magnesium concentration is preferably greater than or equal to 1.6 and less than or equal to 6.0, further preferably greater than or equal to 1.8 and less than 4.0. Furthermore, the relative value of the concentration of halogen such as fluorine is preferably greater than or equal to 0.2 and less than or equal to 6.0, further preferably greater than or equal to 1.2 and less than or equal to 4.0.

In the XPS analysis, monochromatic aluminum can be used as an X-ray source, for example. An extraction angle is, for example, 45°.

In addition, when the positive electrode active material 100A is analyzed by XPS, a peak indicating the bonding energy of fluorine with another element is preferably higher than or equal to 682 eV and lower than 685 eV, further preferably approximately 684.3 eV. This value is different from both of the bonding energy of lithium fluoride, which is 685 eV, and the bonding energy of magnesium fluoride, which is 686 eV. That is, when the positive electrode active material 100A contains fluorine, bonding other than bonding of lithium fluoride and magnesium fluoride is preferable.

Furthermore, when the positive electrode active material 100A is analyzed by XPS, a peak indicating the bonding energy of magnesium with another element is preferably higher than or equal to 1302 eV and lower than 1304 eV, further preferably approximately 1303 eV. This value is different from the bonding energy of magnesium fluoride, which is 1305 eV, and is close to the bonding energy of magnesium oxide. That is, when the positive electrode active material 100A contains magnesium, bonding other than bonding of magnesium fluoride is preferable.

### <<EDX>>

In the EDX measurement, to measure a region while scanning the region and evaluate two-dimensionally is referred to as EDX area analysis in some cases. In addition, to extract data of a linear region from EDX area analysis and evaluate the atomic concentration distribution in a positive electrode active material particle is referred to as linear analysis in some cases.

The concentrations of magnesium and fluorine in the inner portion, the surface portion, and the vicinity of the crystal grain boundary can be quantitatively analyzed by the EDX area analysis (e.g., element mapping). In addition, peaks of the concentrations of magnesium and fluorine can be analyzed by the EDX linear analysis.

When the positive electrode active material 100A is analyzed by the EDX linear analysis, a peak of the magnesium concentration in the surface portion preferably exists in a region from the surface of the positive electrode active material 100A to a depth of 3 nm toward the center, further preferably to a depth of 1 nm, still further preferably to a depth of 0.5 nm.

In addition, the distribution of fluorine contained in the positive electrode active material 100A preferably overlaps with the distribution of magnesium. Thus, when the EDX linear analysis is performed, a peak of the fluorine concentration in the surface portion preferably exists in a region from the surface of the positive electrode active material 100A to a depth of 3 nm toward the center, further preferably to a depth of 1 nm, still further preferably to a depth of 0.5 nm.

<<dQ/dVvsV Curve>>

Moreover, when the positive electrode active material of one embodiment of the present invention is discharged at a low rate of, for example, 0.2 C or less after high-voltage charge, a characteristic change in voltage appears just before the end of discharge, in some cases. This change can be clearly observed by the fact that at least one peak appears within the range of 3.5 V to 3.9 V in a dQ/dVvsV curve calculated from a discharge curve.

### [Forming Method 1 of Positive Electrode Active Material]

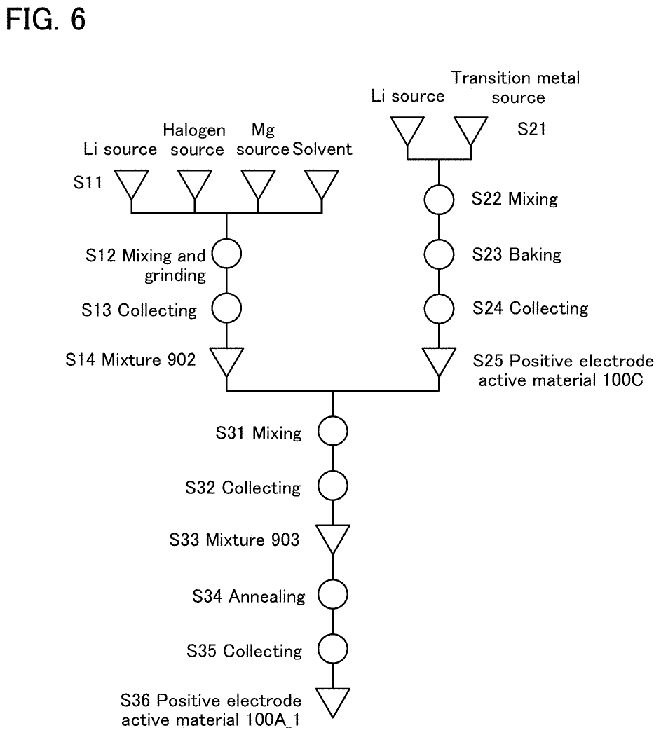

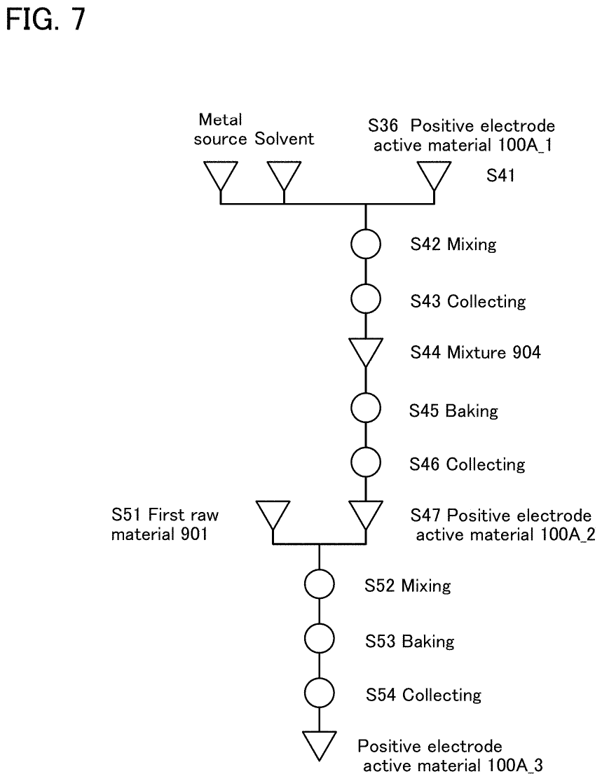

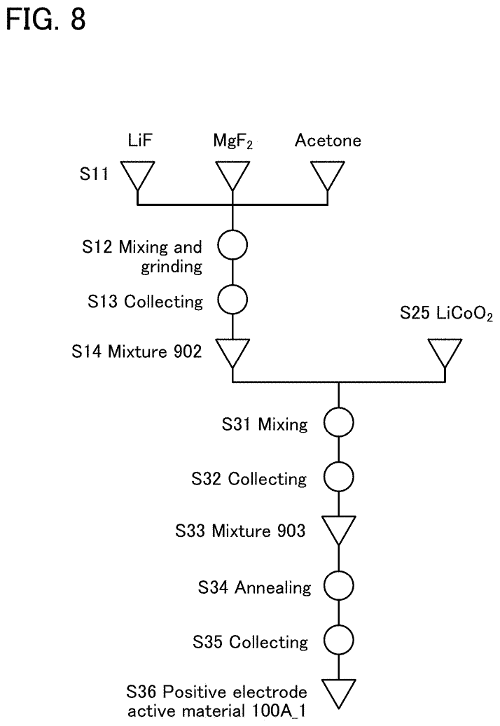

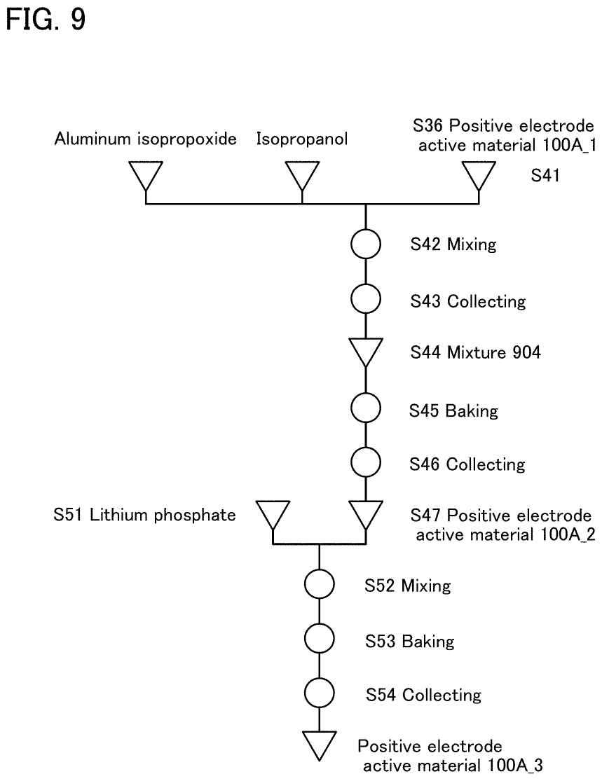

Next, an example of a manufacturing method of the positive electrode active material of one embodiment of the present invention is described with reference to FIG. 6 and FIG. 7. In addition, FIG. 8 and FIG. 9 show another more specific example of the manufacturing method.

### <Step S11>

First, a halogen source such as a fluorine source or a chlorine source and a magnesium source are prepared as materials of a mixture 902 as shown in Step S11 in FIG. 6. In addition, a lithium source is preferably prepared as well.

As the fluorine source, for example, lithium fluoride, magnesium fluoride, or the like can be used. Among them, lithium fluoride, which has a relatively low melting point of 848° C., is preferable because it is easily melted in an annealing process described later. As the chlorine source, for example, lithium chloride, magnesium chloride, or the like can be used. As the magnesium source, for example, magnesium fluoride, magnesium oxide, magnesium hydroxide, magnesium carbonate, or the like can be used. As the lithium source, for example, lithium fluoride, lithium carbonate, or the like can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source and the lithium source, and magnesium fluoride MgF₂ is prepared as the fluorine source and the magnesium source (Step S11 in FIG. 8 as a specific example of FIG. 6). When lithium fluoride LiF and magnesium fluoride MgF₂ are mixed at a molar ratio of approximately LiF:MgF₂=65:35, the effect of reducing the melting point becomes the highest (Non-Patent Document 4). On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and smaller than 1.1 times a certain value.

In addition, in the case where the following mixing and grinding steps are performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used (see Step S11 in FIG. 8).

### <Step S12>

Next, the materials of the mixture 902 are mixed and ground (Step S12 in FIG. 6 and FIG. 8). Although the mixing can be performed by a dry process or a wet process, the wet process is preferable because the materials can be ground to the smaller size. For example, a ball mill, a bead mill, or the like can be used for the mixing. When the ball mill is used, a zirconia ball is preferably used as media, for example. The mixing step and the grinding step are preferably performed sufficiently to pulverize the mixture 902.

### <Step S13 and Step S14>

The materials mixed and ground in the above manner are collected (Step S13 in FIG. 6 and FIG. 8), whereby the mixture 902 is obtained (Step S14 in FIG. 6 and FIG. 8).

For example, the mixture 902 preferably has an average particle diameter (D50) of greater than or equal to 600 nm and less than or equal to 20 μm, further preferably greater than or equal to 1 μm and less than or equal to 10 μm. When mixed with a composite oxide containing lithium, a transition metal, and oxygen in the later step, the mixture 902 pulverized to such a small size is easily attached to surfaces of composite oxide particles uniformly. The mixture 902 is preferably attached to the surfaces of the composite oxide particles uniformly because both halogen and magnesium are easily distributed to the surface portion of the composite oxide particles after heating. When there is a region containing neither halogen nor magnesium in the surface portion, the positive electrode active material might be less likely to have the above-described pseudo-spinel crystal structure in the charged state.

Next, the composite oxide containing lithium, the transition metal, and oxygen is obtained through Step S21 to Step S25.

### <Step S21>

Next, as shown in Step S21 in FIG. 6, a lithium source and a transition metal source are prepared as materials of the composite oxide containing lithium, the transition metal, and oxygen.

As the lithium source, for example, lithium carbonate, lithium fluoride, or the like can be used.

As the transition metal, at least one of cobalt, manganese, and nickel can be used, for example.

In the case where the positive electrode active material has a layered rock-salt crystal structure, as the ratio of the materials, the mixture ratio of cobalt, manganese, and nickel with which the positive electrode active material can have a layered rock-salt crystal structure is used. In addition, aluminum may be added to the transition metal as long as the positive electrode active material can have the layered rock-salt crystal structure.

As the transition metal source, oxide or hydroxide of the transition metal, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S22>

Next, the lithium source and the transition metal source are mixed (Step S22 in FIG. 6). The mixing can be performed by a dry process or a wet process. For example, a ball mill, a bead mill, or the like can be used for the mixing. When the ball mill is used, a zirconia ball is preferably used as media, for example.

### <Step S23>

Next, the materials mixed in the above manner are heated. This step is sometimes referred to as baking or first heating to distinguish this step from a heating step performed later. The heating is preferably performed at higher than or equal to 800° C. and lower than 1100° C., further preferably at higher than or equal to 900° C. and lower than or equal to 1000° C., still further preferably at approximately 950° C. Excessively low temperature might result in insufficient decomposition and melting of starting materials. By contrast, excessively high temperature might cause a defect due to excessive reduction of the transition metal, evaporation of lithium, or the like. For example, a defect in which cobalt has a valence of two might be caused.

The heating time is preferably longer than or equal to 2 hours and shorter than or equal to 20 hours. Baking is preferably performed in an atmosphere with few moisture, such as dry air (e.g., a dew point is lower than or equal to −50° C., further preferably lower than or equal to 100° C.). For example, it is preferable that the heating be performed at 1000° C. for 10 hours, the temperature rise be 200° C./h, and the flow rate of a dry atmosphere be 10 L/min After that, the heated materials can be cooled to room temperature. The temperature decreasing time from the specified temperature to room temperature is preferably longer than or equal to 10 hours and shorter than or equal to 50 hours, for example.

Note that the cooling to room temperature in Step S23 is not essential. As long as later steps of Step S24, Step S25, and Step S31 to Step S34 are performed without problems, the cooling may be performed at a temperature higher than room temperature.

Note that the metals contained in the positive electrode active material may be introduced in Step S22 and Step S23 described above, and some of the metals can be introduced in Step S41 to Step S46 described later. More specifically, a metal M1 (M1 is one or more elements selected from cobalt, manganese, nickel, and aluminum) is introduced in Step S22 and Step S23, and a metal M2 (M2 is one or more elements selected from manganese, nickel, and aluminum, for example) is introduced in Step S41 to Step S46. When the step of introducing the metal M1 and the step of introducing the metal M2 are separately performed in such a manner, the profiles in the depth direction of the metals can be made different from each other in some cases. For example, the concentration of the metal M2 in the surface portion of a particle can be higher than that in the inner portion of the particle. Furthermore, with the number of atoms of the metal M1 as a reference, the ratio of the number of atoms of the metal M2 with respect to the reference can be higher in the surface portion than in the inner portion.

For the positive electrode active material of one embodiment of the present invention, cobalt is preferably selected as the metal M1 and nickel and aluminum are preferably selected as the metal M2.

### <Step S24 and Step S25>

The materials baked in the above manner are collected (Step S24 in FIG. 6), whereby the composite oxide containing lithium, the transition metal, and oxygen is obtained as the positive electrode active material 100C (Step S25 in FIG. 6). Specifically, lithium cobalt oxide, lithium manganese oxide, lithium nickel oxide, lithium cobalt oxide in which manganese is substituted for part of cobalt, or lithium nickel-manganese-cobalt oxide is obtained.

Alternatively, a composite oxide containing lithium, a transition metal, and oxygen that is synthesized in advance may be used as Step S25 (see FIG. 8). In this case, Step S21 to Step S24 can be skipped.

In the case where the composite oxide containing lithium, the transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, the transition metal, and oxygen and the positive electrode active material, and elements other than the main components are regarded as impurities. For example, when analyzed by a glow discharge mass spectroscopy method, the total impurity element concentration is preferably less than or equal to 10,000 ppm wt, further preferably less than or equal to 5,000 ppm wt. In particular, the total impurity concentration of transition metals such as titanium and arsenic is preferably less than or equal to 3,000 ppm wt, further preferably less than or equal to 1,500 ppm wt.

For example, as lithium cobalt oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1,100 ppm wt, and the concentrations of elements other than lithium, cobalt, and oxygen are less than or equal to 150 ppm wt.

Alternatively, a lithium cobalt oxide particle (product name: CELLSEED C-5H) manufactured by NIPPON CHEMICAL INDUSTRIAL CO., LTD. can be used. This is lithium cobalt oxide in which the average particle diameter (D50) is approximately 6.5 μm, and the concentrations of elements other than lithium, cobalt, and oxygen are approximately equal to or less than those of C-10N in the impurity analysis by GD-MS.

In this embodiment, cobalt is used as the transition metal, and the lithium cobalt oxide particle (CELLSEED C-10N manufactured by NIPPON CHEMICAL INDUSTRIAL CO., LTD.) is used (see FIG. 8).

The composite oxide containing lithium, the transition metal, and oxygen in Step S25 preferably has a layered rock-salt crystal structure with few defects and distortions. Therefore, the composite oxide is preferably a composite oxide that includes few impurities. In the case where the composite oxide containing lithium, the transition metal, and oxygen includes a lot of impurities, the crystal structure is highly likely to have a lot of defects or distortions.

Here, the positive electrode active material 100C includes a crack in some cases. The crack is generated in any of Step S21 to Step S25 or in a plurality of steps. For example, the crack is generated in the baking step of Step S23. The number of generated cracks might vary depending on conditions such as the baking temperature, the rate of increasing or decreasing temperature in baking, and the like. Furthermore, the crack might be generated in the steps of mixing, grinding, and the like, for example.

### <Step S31>

Next, the mixture 902 and the composite oxide containing lithium, the transition metal, and oxygen are mixed (Step S31 in FIG. 6 and FIG. 8). The atomic ratio of the transition metal TM in the composite oxide containing lithium, the transition metal, and oxygen to magnesium Mg_{Mix1} contained in the mixture 902 is preferably TM:Mg_{Mix1}=1:y (0.005≤y≤0.05), further preferably TM:Mg_{Mix1}=1:y (0.007≤y≤0.04), still further preferably approximately TM:Mg_{Mix1}=1:0.002.

The condition of the mixing in Step S31 is preferably milder than that of the mixing in Step S12 not to damage the particles of the composite oxide. For example, a condition with a lower rotation frequency or shorter time than the mixing in Step S12 is preferable. In addition, it can be said that the dry process has a milder condition than the wet process. For example, a ball mill, a bead mill, or the like can be used for the mixing. When the ball mill is used, a zirconia ball is preferably used as media, for example.

### <Step S32 and Step S33>

The materials mixed in the above manner are collected (Step S32 in FIG. 6 and FIG. 8), whereby the mixture 903 is obtained (Step S33 in FIG. 6 and FIG. 8).

Note that this embodiment describes a method for adding the mixture of lithium fluoride and magnesium fluoride to lithium cobalt oxide with few impurities; however, one embodiment of the present invention is not limited thereto. Mixture obtained through baking after addition of a magnesium source and a fluorine source to the starting material of lithium cobalt oxide may be used instead of the mixture 903 in Step S33. In that case, there is no need to separate steps Step S11 to Step S14 and steps Step S21 to Step S25, which is simple and productive.

Alternatively, lithium cobalt oxide to which magnesium and fluorine are added in advance may be used. When lithium cobalt oxide to which magnesium and fluorine are added is used, the process can be simpler because the steps up to Step S32 can be omitted.

In addition, a magnesium source and a fluorine source may be further added to the lithium cobalt oxide to which magnesium and fluorine are added in advance.

### <Step S34>

Next, the mixture 903 is heated. This step can be referred to as annealing or second heating to distinguish this step from the heating step performed before.

The annealing is preferably performed at an appropriate temperature for an appropriate time. The appropriate temperature and time depend on the conditions such as the particle size and the composition of the composite oxide containing lithium, the transition metal, and oxygen in Step S25. In the case where the particle size is small, the annealing is preferably performed at a lower temperature or for a shorter time than the case where the particle size is large, in some cases.

When the average particle diameter (D50) of the particles in Step S25 is approximately 12 μm, for example, the annealing temperature is preferably higher than or equal to 600° C. and lower than or equal to 950° C., for example. The annealing time is preferably longer than or equal to 3 hours, further preferably longer than or equal to 10 hours, still further preferably longer than or equal to 60 hours, for example.

On the other hand, when the average particle diameter (D50) of the particles in Step S25 is approximately 5 μm, the annealing temperature is preferably higher than or equal to 600° C. and lower than or equal to 950° C., for example. The annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

It is considered that when the mixture 903 is annealed, a material having a low melting point (e.g., lithium fluoride, which has a melting point of 848° C.) in the mixture 902 is melted first and distributed to the surface portion of the composite oxide particle. Next, the existence of the melted material decreases the melting points of other materials, presumably resulting in melting of the other materials. For example, magnesium fluoride (melting point: 1263° C.) is presumably melted and distributed to the surface portion of the composite oxide particle.

Then, the elements that are included in the mixture 902 and are distributed to the surface portion probably form a solid solution in the composite oxide containing lithium, the transition metal, and oxygen.

The elements included in the mixture 902 diffuse faster in the surface portion and the vicinity of the grain boundary than inside the composite oxide particles. Therefore, the concentrations of magnesium and halogen in the surface portion and the vicinity of the grain boundary are higher than those of magnesium and halogen inside the composite oxide particles. As described later, the higher the magnesium concentration in the surface portion and the vicinity of the grain boundary is, the more effectively the change in the crystal structure can be suppressed.

### <Step S35 and Step S36>

The material annealed in the above manner is collected (Step S35 in FIG. 6 and FIG. 8), whereby a positive electrode active material 100A_1 is obtained (Step S36 in FIG. 6 and FIG. 8).

### [Forming Method 2 of Positive Electrode Active Material]

Further treatment may be performed on the positive electrode active material 100A_1 obtained in Step S36. Here, treatment for adding the metal Z is performed. The treatment is preferably performed after Step S25 because the concentration of the metal Z can be higher in the particle surface portion than in the inner portion of the positive electrode active material concentration in some cases.

The addition of the metal Z may be performed by mixing a material containing the metal Z with the mixture 902 and the like in Step S31, for example. This case is preferable because the number of steps can be reduced and the steps can be simplified.

Alternatively, as described later, the step of adding the metal Z may be performed after Step S31 to Step S35. In that case, for example, a compound of magnesium and the metal Z can be inhibited from being formed in some cases.

The metal Z is added in the positive electrode active material of one embodiment of the present invention through Step S41 to Step S53 described later. For the addition of the metal Z, a liquid phase method such as a sol-gel method, a solid phase method, a sputtering method, an evaporation method, a CVD (chemical vapor deposition) method, a PLD (pulsed laser deposition) method, and the like can be used. The addition of the metal M2 described above can be performed through the step of adding the metal Z described below.

### <Step S41>

As shown in FIG. 7, a metal source is first prepared in Step S41. In the case of employing a sol-gel method, a solvent used for the sol-gel method is also prepared. As the metal source, metal alkoxide, metal hydroxide, metal oxide, or the like can be used. When the metal Z is aluminum, for example, the aluminum concentration in the metal source ranges from 0.001 to 0.02 times that of cobalt with the number of cobalt atoms in the lithium cobalt oxide regarded as 1. When the metal Z is nickel, for example, the nickel concentration in the metal source ranges from 0.001 to 0.02 times that of cobalt with the number of cobalt atoms in the lithium cobalt oxide regarded as 1. When the metal Z is aluminum and nickel, for example, the aluminum concentration in the metal source ranges from 0.001 to 0.02 times that of cobalt and the nickel concentration in the metal source ranges from 0.001 to 0.02 times that of cobalt with the number of cobalt atoms in the lithium cobalt oxide regarded as 1.

Here, an example of employing a sol-gel method using aluminum isopropoxide as the metal source and isopropanol as the solvent is shown (Step S41 in FIG. 9).

### <Step S42>

Next, the aluminum alkoxide is dissolved in alcohol, and then the lithium cobalt oxide particles are mixed (Step S42 in FIG. 7 and FIG. 9).

The necessary amount of metal alkoxide depends on the particle size of lithium cobalt oxide. For example, when aluminum isopropoxide is used and the particle diameter (D50) of the lithium cobalt oxide is approximately 20 μm, the aluminum isopropoxide is preferably added so that the aluminum concentration in the aluminum isopropoxide ranges from 0.001 to 0.02 times that of cobalt with the number of cobalt atoms in the lithium cobalt oxide regarded as 1.

Next, a mixed solution of the alcohol solution of metal alkoxide and the lithium cobalt oxide particles is stirred under an atmosphere containing water vapor. The stirring can be performed with a magnetic stirrer, for example. The stirring time is not limited as long as water and metal alkoxide in the atmosphere cause hydrolysis and polycondensation reaction. For example, the stirring can be performed at 25° C. and a humidity of 90% RH (Relative Humidity) for 4 hours. Alternatively, the stirring may be performed under an atmosphere where the humidity and temperature are not adjusted, for example, an air atmosphere in a fume hood. In such a case, the stirring time is preferably set longer and can be 12 hours or longer at room temperature, for example.

Reaction between water vapor and metal alkoxide in the atmosphere enables a sol-gel reaction to proceed more slowly as compared with the case where liquid water is added. Alternatively, reaction between metal alkoxide and water at room temperature enables a sol-gel reaction to proceed more slowly as compared with the case where heating is performed at a temperature higher than the boiling point of alcohol serving as a solvent, for example. A sol-gel reaction that proceeds slowly enables formation of a high-quality coating layer with a uniform thickness.

### <Step S43 and Step S44>

After the above process, the precipitate is collected from the mixed solution (Step S43 in FIG. 7 and FIG. 9). As the collection method, filtration, centrifugation, evaporation to dryness, and the like can be used. The precipitate can be washed with alcohol that is the solvent in which metal alkoxide is dissolved. Note that in the case of employing evaporation to dryness, the solvent and the precipitate are not necessarily separated in this step; for example, the precipitate is collected in the subsequent drying step (Step S44).

Next, the collected residue is dried, so that a mixture 904 is obtained (Step S44 in FIG. 7 and FIG. 9). For example, the drying step can be performed at 80° C. for 1 hour to 4 hours.

### <Step S45>

Next, the obtained mixture 904 is baked (Step S45 in FIG. 7 and FIG. 9).

For the baking time, the retention time at a temperature within a specified range is preferably greater than or equal to 1 hour and less than or equal to 50 hours, further preferably greater than or equal to 2 hours and less than or equal to 20 hours. When the baking time is too short, the crystallinity of a compound containing the metal Z formed in the surface portion is low in some cases. Alternatively, the metal Z is not sufficiently diffused in some cases. Alternatively, an organic substance may remain on the surface in some cases. However, when the baking time is too long, the metal Z is diffused too much so that the concentration of the metal Z at the surface portion and near the crystal grain boundary might be low. Furthermore, the productivity is lowered.

The specified temperature is preferably higher than or equal to 500° C. and lower than or equal to 1200° C., further preferably higher than or equal to 700° C. and lower than or equal to 920° C., and still further preferably higher than or equal to 800° C. and lower than or equal to 900° C. When the specified temperature is too low, the crystallinity of the compound containing the metal Z formed in the surface portion is low in some cases. Alternatively, the metal Z is not sufficiently diffused in some cases. Alternatively, an organic substance may remain on the surface in some cases.

The baking is preferably performed in an oxygen-containing atmosphere. When the oxygen partial pressure is low, Co might be reduced unless the baking temperature is lowered.

In this embodiment, the specified temperature is 850° C. and kept for 2 hours, the temperature rising rate is 200° C./h, and the flow rate of oxygen is 10 L/min.

The cooling time after the baking is preferably long, in which case a crystal structure is easily stabilized. For example, the time of decreasing temperature from the specified temperature to room temperature is preferably greater than or equal to 10 hours and less than or equal to 50 hours. Here, the baking temperature in Step S45 is preferably lower than the baking temperature in Step S34.

### <Step S46 and Step S47>

Next, cooled particles are collected (Step S46 in FIG. 7 and FIG. 9). Moreover, the particles are preferably made to pass through a sieve. Through the above process, a positive electrode active material 100A_2 of one embodiment of the present invention can be formed (Step S47 in FIG. 7 and FIG. 9).

After Step S47, treatment may be performed by repeating Step S41 to Step S46. The number of repetitions may be one, or two or more.

In the case where the treatment is performed twice or more, the treatment may be performed with the same or different kinds of metal sources. In the case where different metal sources are used, for example, an aluminum source can be used for the first treatment and a nickel source can be used for the second treatment.

### <Step S51>

Next, a compound containing the element X is prepared as a first raw material 901 (Step S51 in FIG. 7 and FIG. 9).

The first raw material 901 may be ground in Step S51. For example, a ball mill, a bead mill, or the like can be used for the grinding. The powder obtained after the grinding may be classified using a sieve.

The first raw material 901 is a compound containing the element X, and phosphorus can be used as the element X. The first raw material 901 is preferably a compound having a bond between the element X and oxygen.

As the first raw material 901, for example, a phosphate compound can be used. As the phosphate compound, a phosphate compound containing an element D can be used. The element D is one or more elements selected from lithium, sodium, potassium, magnesium, zinc, cobalt, iron, manganese, and aluminum A phosphate compound containing hydrogen in addition to the element D can be used. An ammonium phosphate, or an ammonium salt containing the element D can also be used as the phosphate compound.

Examples of the phosphate compound include lithium phosphate, sodium phosphate, potassium phosphate, magnesium phosphate, zinc phosphate, aluminum phosphate, ammonium phosphate, lithium dihydrogen phosphate, ammonium dihydrogen phosphate, magnesium hydrogen phosphate, and lithium cobalt phosphate. As the positive electrode active material, lithium phosphate or magnesium phosphate is particularly preferably used.

In this embodiment, lithium phosphate is used as the first raw material 901 (Step S51 in FIG. 7 and FIG. 9).

### <Step S52>

Next, the first raw material 901 obtained in Step S51 and the positive electrode active material 100A_2 obtained in Step S47 are mixed (Step S52 in FIG. 7 and FIG. 9). It is preferable to mix the first raw material 901 at 0.01 mol to 0.1. mol inclusive, further preferably at 0.02 mol to 0.08 mol inclusive with respect to 1 mol of the positive electrode active material 100A_2 obtained in Step S25. For example, a ball mill, a bead mill, or the like can be used for the mixing. The powder obtained after the mixing may be classified using a sieve.

### <Step S53>

Next, the materials mixed in the above are heated (Step S53 in FIG. 7 and FIG. 9). In the formation of the positive electrode active material, this step is not necessarily performed in some cases. In the case of performing heating, the heating is preferably performed at higher than or equal to 300° C. and lower than 1200° C., further preferably at higher than or equal to 550° C. and lower than or equal to 950° C., still further preferably at approximately 750° C. Excessively low temperature might result in insufficient decomposition and melting of starting materials. By contrast, excessively high temperature might cause a defect due to excessive reduction of the transition metal, evaporation of lithium, or the like.

By the heating, a reaction product of the positive electrode active material 100A_2 and the first raw material 901 is generated in some cases.

The heating time is preferably longer than or equal to 2 hours and shorter than or equal to 60 hours. Baking is preferably performed in an atmosphere with little moisture, such as dry air (e.g., a dew point is lower than or equal to −50° C., further preferably lower than or equal to 100° C.). For example, it is preferable that the heating be performed at 1000° C. for 10 hours, the temperature rise be 200° C./h, and the flow rate of a dry atmosphere be 10 L/min After that, the heated materials can be cooled to room temperature. The temperature decreasing time from the specified temperature to room temperature is preferably longer than or equal to 10 hours and shorter than or equal to 50 hours, for example.

Note that the cooling to room temperature in Step S53 is not essential. As long as later Step S54 is performed without problems, it is possible to perform cooling to a temperature higher than room temperature.

### <Step S54>

The materials baked in the above are collected (Step S54 in FIG. 7 and FIG. 9), whereby a positive electrode active material 100A_3 containing the element D is obtained.

The description of the positive electrode active material 100A described with reference to FIG. 2 and the like can be referred to for the positive electrode active material 100A_1, the positive electrode active material 100 A_2, and the positive electrode active material 100A_3.

### Embodiment 2

In this embodiment, examples of materials that can be used for a secondary battery containing the positive electrode active material 100 described in the above embodiment are described. In this embodiment, a secondary battery in which a positive electrode, a negative electrode, and an electrolyte solution are wrapped in an exterior body is described as an example.

### [Positive Electrode]

The positive electrode includes a positive electrode active material layer and a positive electrode current collector.

### <Positive Electrode Active Material Layer>

The positive electrode active material layer contains at least a positive electrode active material. The positive electrode active material layer may contain, in addition to the positive electrode active material, other materials such as a coating film of the active material surface, a conductive additive, and a binder.

As the positive electrode active material, the positive electrode active material 100 described in the above embodiment can be used. A secondary battery including the positive electrode active material 100 described in the above embodiment can have high capacity and excellent cycle performance.

Examples of the conductive additive include a carbon material, a metal material, and a conductive ceramic material. Alternatively, a fiber material may be used as the conductive additive. The content of the conductive additive in the active material layer is preferably greater than or equal to 1 wt % and less than or equal to 10 wt %, further preferably greater than or equal to 1 wt % and less than or equal to 5 wt %.

A network for electric conduction can be formed in the active material layer by the conductive additive. The conductive additive also allows the maintenance of a path for electric conduction between the positive electrode active material particles. The addition of the conductive additive to the active material layer increases the electric conductivity of the active material layer.

Examples of the conductive additive include natural graphite, artificial graphite such as mesocarbon microbeads, and carbon fiber. As carbon fiber, mesophase pitch-based carbon fiber and isotropic pitch-based carbon fiber can be used. Furthermore, as carbon fiber, carbon nanofiber and carbon nanotube can be used. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, metal powder or metal fibers of copper, nickel, aluminum, silver, gold, or the like, a conductive ceramic material, or the like can be used.

Alternatively, a graphene compound may be used as the conductive additive.

A graphene compound has excellent electrical characteristics of high conductivity and excellent physical properties of high flexibility and high mechanical strength in some cases. Furthermore, a graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Thus, a graphene compound is preferably used as the conductive additive, in which case the area where the active material and the conductive additive are in contact with each other can be increased. The graphene compound serving as the conductive additive is preferably formed with a spray dry apparatus as a coating film to cover the entire surface of the active material, in which case the electrical resistance can be reduced in some cases. Here, it is particularly preferable to use, for example, graphene, multilayer graphene, or RGO as a graphene compound. Note that RGO refers to a compound obtained by reducing graphene oxide (GO), for example.

In the case where an active material with a small particle size (e.g., 1 μm or less) is used, the specific surface area of the active material is large and thus more conductive paths for the active material particles are needed. Thus, the amount of conductive additive tends to increase and the carried amount of active material tends to decrease relatively. When the carried amount of active material decreases, the capacity of the secondary battery also decreases. In such a case, a graphene compound that can efficiently form a conductive path even with a small amount is particularly preferably used as the conductive additive because the carried amount of active material does not decrease.

A cross-sectional structure example of an active material layer 200 containing a graphene compound as a conductive additive is described below.

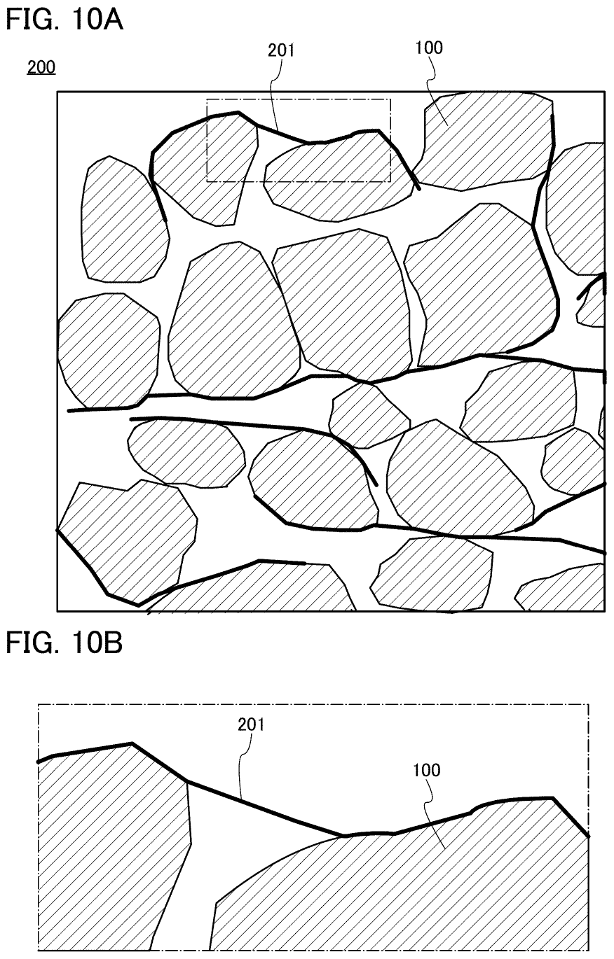

FIG. 10(A) is a longitudinal cross-sectional view of the active material layer 200. The active material layer 200 includes particles of the positive electrode active material 100, a graphene compound 201 serving as a conductive additive, and a binder (not illustrated). Here, graphene or multilayer graphene may be used as the graphene compound 201, for example. The graphene compound 201 preferably has a sheet-like shape. The graphene compound 201 may have a sheet-like shape formed of a plurality of sheets of multilayer graphene and/or a plurality of sheets of graphene that partly overlap with each other.

The longitudinal cross section of the active material layer 200 in FIG. 10(B) shows substantially uniform dispersion of the sheet-like graphene compounds 201 in the active material layer 200. The graphene compounds 201 are schematically shown by thick lines in FIG. 10(B) but are actually thin films each having a thickness corresponding to the thickness of a single layer or a multi-layer of carbon molecules. The plurality of graphene compounds 201 are formed to partly coat or adhere to the surfaces of the plurality of particles of the positive electrode active material 100, so that the graphene compounds 201 make surface contact with the particles of the positive electrode active material 100.

Here, the plurality of graphene compounds are bonded to each other to form a net-like graphene compound sheet (hereinafter, referred to as a graphene compound net or a graphene net). The graphene net covering the active material can function as a binder for bonding active materials. The amount of binder can thus be reduced, or the binder does not have to be used. This can increase the proportion of the active material in the electrode volume or weight. That is to say, the capacity of the secondary battery can be increased.

Here, it is preferable to perform reduction after a layer to be the active material layer 200 is formed in such a manner that graphene oxide is used as the graphene compound 201 and mixed with an active material. When graphene oxide with extremely high dispersibility in a polar solvent is used for the formation of the graphene compounds 201, the graphene compounds 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conduction path. Note that graphene oxide can be reduced either by heat treatment or with the use of a reducing agent, for example.

Unlike conductive additive particles that make point contact with an active material, such as acetylene black, the graphene compound 201 is capable of making low-resistance surface contact; accordingly, the electrical conduction between the particles of the positive electrode active material 100 and the graphene compounds 201 can be improved with a smaller amount of the graphene compound 201 than that of a normal conductive additive. This increases the proportion of the particles of the positive electrode active material 100 in the active material layer 200, resulting in increased discharge capacity of the secondary battery.

It is possible to form a graphene compound serving as a conductive additive as a coating film to cover the entire surface of the active material and to form a conductive path between the active materials using the graphene compound in advance with a spray dry apparatus.

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluororubber can be used as the binder.

For the binder, for example, water-soluble polymers are preferably used. As the water-soluble polymers, for example, a polysaccharide can be used. As the polysaccharide, for example, a cellulose derivative such as carboxymethyl cellulose (CMC), methyl cellulose, ethyl cellulose, hydroxypropyl cellulose, diacetyl cellulose, and regenerated cellulose or starch can be used. It is further preferred that such water-soluble polymers be used in combination with any of the above rubber materials.

Alternatively, as the binder, a material such as polystyrene, poly(methyl acrylate), poly(methyl methacrylate) (polymethyl methacrylate, PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. An example of a water-soluble polymer having an especially significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

The water-soluble polymers stabilize viscosity by being dissolved in water and allow stable dispersion of the active material and another material combined as a binder, such as styrene-butadiene rubber, in an aqueous solution. Furthermore, a water-soluble polymer is expected to be easily and stably adsorbed to an active material surface because it has a functional group. Many cellulose derivatives such as carboxymethyl cellulose have functional groups such as a hydroxyl group and a carboxyl group. Because of functional groups, polymers are expected to interact with each other and cover an active material surface in a large area.

In the case where the binder covering or being in contact with the active material surface forms a film, the film is expected to serve as a passivation film to suppress the decomposition of the electrolyte solution. Here, the passivation film refers to a film without electronic conductivity or a film with extremely low electric conductivity, and can suppress the decomposition of an electrolyte solution at a potential at which a battery reaction occurs in the case where the passivation film is formed on the active material surface, for example. It is preferred that the passivation film can conduct lithium ions while suppressing electric conduction.

### <Positive Electrode Current Collector>

The positive electrode current collector can be formed using a material that has high conductivity, such as a metal like stainless steel, gold, platinum, aluminum, and titanium, or an alloy thereof. It is preferred that a material used for the positive electrode current collector not dissolve at the potential of the positive electrode. Alternatively, the positive electrode current collector can be formed using an aluminum alloy to which an element that improves heat resistance, such as silicon, titanium, neodymium, scandium, or molybdenum, is added. Still alternatively, a metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 μm and less than or equal to 30 μm.

### [Negative Electrode]

The negative electrode includes a negative electrode active material layer and a negative electrode current collector. The negative electrode active material layer may contain a conductive additive and a binder.

### <Negative Electrode Active Material>

As a negative electrode active material, for example, an alloy-based material or a carbon-based material can be used.

For the negative electrode active material, an element that enables charge-discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by an alloying reaction and a dealloying reaction with lithium and a compound containing the element, for example, may be referred to as an alloy-based material.

In this specification and the like, SiO refers, for example, to silicon monoxide. Note that SiO can alternatively be expressed as SiOₓ. Here, x preferably has an approximate value of 1. For example, x is preferably 0.2 or more and 1.5 or less, further preferably 0.3 or more and 1.2 or less.

As the carbon-based material, graphite, graphitizing carbon (soft carbon), non-graphitizing carbon (hard carbon), carbon nanotube, graphene, carbon black, and the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

Alternatively, for the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used for the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that of the positive electrode current collector can be used. Note that a material which is not alloyed with carrier ions such as lithium is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for a secondary battery is preferably highly purified and contains small numbers of dust particles and elements other than the constituent elements of the electrolyte solution (hereinafter, also simply referred to as impurities). Specifically, the weight ratio of impurities to the electrolyte solution is less than or equal to 1%, preferably less than or equal to 0.1%, and further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of a material to be added in the whole solvent is, for example, higher than or equal to 0.1 wt % and lower than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in charge and discharge at high voltage can be suppressed and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

### [Charge and Discharge Methods]

The secondary battery can be charged and discharged in the following manner, for example.

### <<CC Charge>>

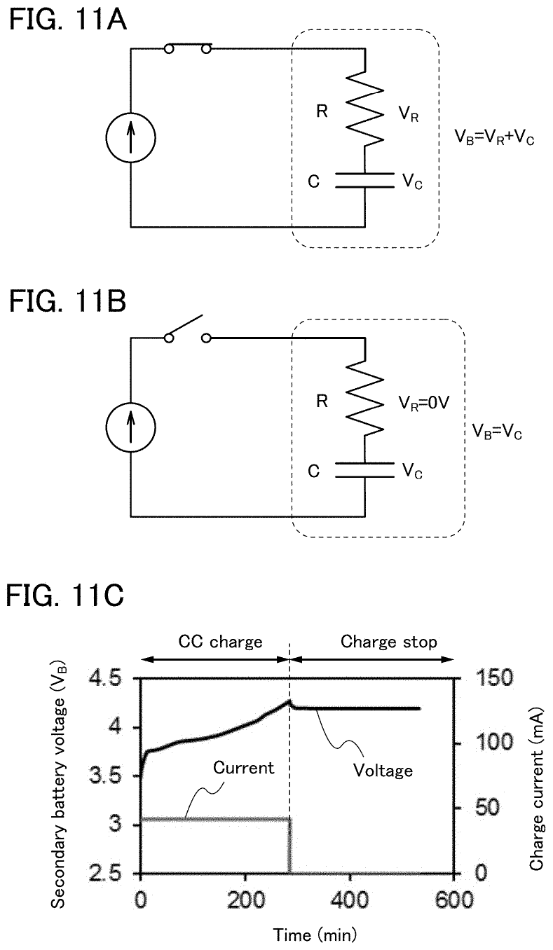

First, CC (constant current) charge, which is one of charge methods, is described. CC charge is a charge method in which a constant current is made to flow to a secondary battery in the whole charge period and charge is terminated when the voltage reaches a predetermined voltage. The secondary battery is assumed to be an equivalent circuit with internal resistance R and secondary battery capacitance C as illustrated in FIG. 11(A). In that case, a secondary battery voltage V_{B} is the sum of a voltage V_{R} applied to the internal resistance R and a voltage V_{C} applied to the secondary battery capacitance C.

While the CC charge is performed, a switch is on as illustrated in FIG. 11(A), so that a constant current I flows to the secondary battery. During the period, the current I is constant; thus, in accordance with the Ohm's law (V_{R}=R×I), the voltage V_{R} applied to the internal resistance R is also constant. In contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, the charge is terminated. On termination of the CC charge, the switch is turned off as illustrated in FIG. 11(B), and the current I becomes 0. Thus, the voltage V_{R} applied to the internal resistance R becomes 0 V. Consequently, the secondary battery voltage V_{B} is decreased.

FIG. 11(C) shows an example of the secondary battery voltage V_{B} and charge current during a period in which the CC charge is performed and after the CC charge is terminated. The secondary battery voltage V_{B} increases while the CC charge is performed, and slightly decreases after the CC charge is terminated.

### <<CCCV Charge>>

Next, CCCV charge, which is a charge method different from the above-described method, is described. CCCV charge is a charge method in which CC charge is performed until the voltage reaches a predetermined voltage and then CV (constant voltage) charge is performed until the amount of current flow becomes small, specifically, a termination current value.

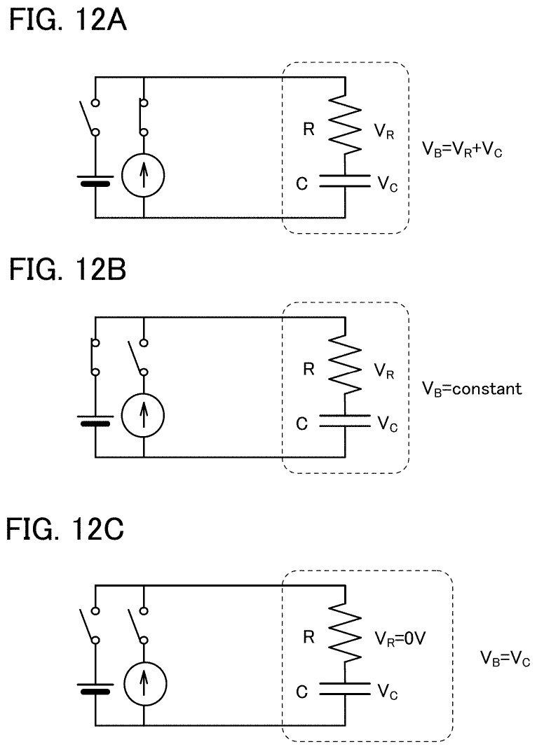

While the CC charge is performed, a switch of a constant current power source is on and a switch of a constant voltage power source is off as illustrated in FIG. 12(A), so that the constant current I flows to the secondary battery. During the period, the current I is constant; thus, in accordance with the Ohm's law (V_{R}=R×I), the voltage V_{R} applied to the internal resistance R is also constant. In contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, switching is performed from the CC charge to the CV charge. While the CV charge is performed, the switch of the constant voltage power source is on and the switch of the constant current power source is off as illustrated in FIG. 12(B); thus, the secondary battery voltage V_{B} is constant. In contrast, the voltage V_{C} applied to the secondary battery capacitance C increases over time. Since V_{B}=V_{R}+V_{C} is satisfied, the voltage V_{R} applied to the internal resistance R decreases over time. As the voltage V_{R} applied to the internal resistance R decreases, the current I flowing to the secondary battery also decreases in accordance with the Ohm's law (V_{R}=R×I).

When the current I flowing to the secondary battery becomes a predetermined current, e.g., approximately 0.01 C, charge is terminated. On termination of the CCCV charge, all the switches are turned off as illustrated in FIG. 12(C), so that the current I becomes 0. Thus, the voltage V_{R} applied to the internal resistance R becomes 0 V. However, the voltage V_{R} applied to the internal resistance R becomes sufficiently small by the CV charge; thus, even when a voltage drop no longer occurs in the internal resistance R, the secondary battery voltage V_{B} hardly decreases.

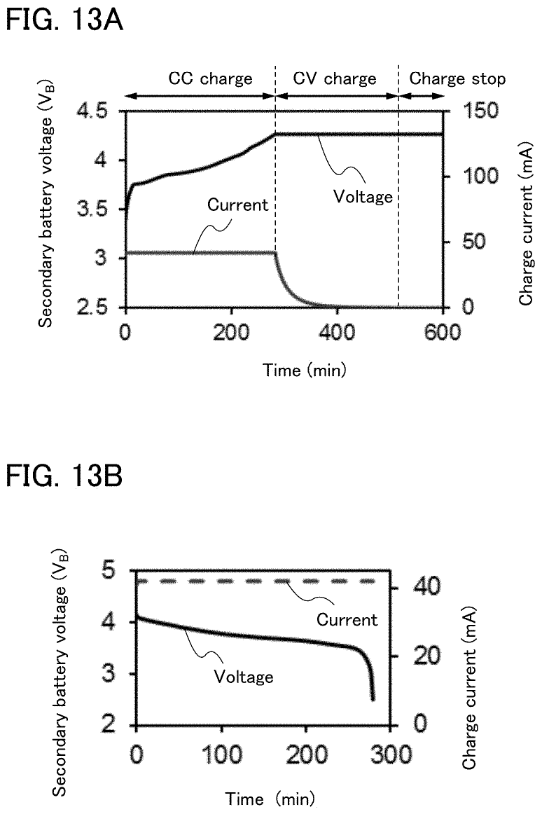

FIG. 13(A) shows an example of the secondary battery voltage V_{B} and charge current while the CCCV charge is performed and after the CCCV charge is terminated. Even after the CCCV charge is terminated, the secondary battery voltage V_{B} hardly decreases.

### <<CC Discharge>>

Next, CC discharge, which is one of discharge methods, is described. CC discharge is a discharge method in which a constant current is made to flow from the secondary battery in the whole discharge period, and discharge is terminated when the secondary battery voltage V_{B} reaches a predetermined voltage, e.g., 2.5 V.

FIG. 13(B) shows an example of the secondary battery voltage V_{B} and discharge current while the CC discharge is performed. As discharge proceeds, the secondary battery voltage V_{B} decreases.

Next, a discharge rate and a charge rate are described. The discharge rate refers to the relative ratio of discharge current to battery capacity and is expressed in a unit C. A current of approximately 1 C in a battery with a rated capacity X (Ah) is X(A). The case where discharge is performed at a current of 2X(A) is rephrased as follows: discharge is performed at 2 C. The case where discharge is performed at a current of X/5(A) is rephrased as follows: discharge is performed at 0.2 C. Similarly, the case where charge is performed at a current of 2X(A) is rephrased as follows: charge is performed at 2 C, and the case where charge is performed at a current of X/5(A) is rephrased as follows: charge is performed at 0.2 C.

### Embodiment 3

In this embodiment, examples of a shape of a secondary battery containing the positive electrode active material 100 described in the above embodiment are described. For the materials used for the secondary battery described in this embodiment, refer to the description of the above embodiment.

### [Coin-Type Secondary Battery]

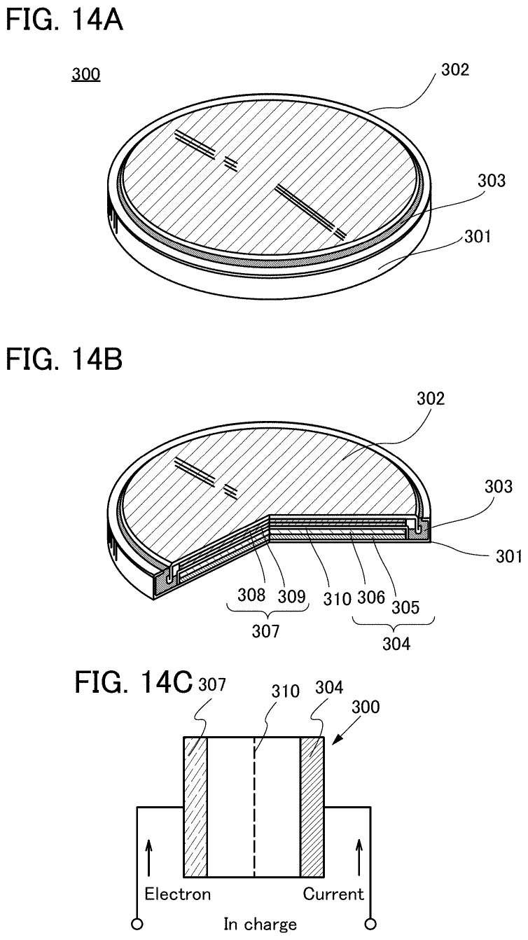

First, an example of a coin-type secondary battery is described. FIG. 14(A) is an external view of a coin-type (single-layer flat type) secondary battery, and FIG. 14(B) is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as illustrated in FIG. 14(B), the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 can be manufactured.

When the positive electrode active material described in the above embodiment is used in the positive electrode 304, the coin-type secondary battery 300 with high capacity and excellent cycle performance can be obtained.

Here, a current flow in charge a secondary battery is described with reference to FIG. 14(C). When a secondary battery using lithium is regarded as a closed circuit, lithium ions transfer and a current flows in the same direction. Note that in the secondary battery using lithium, an anode and a cathode change places in charge and discharge, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of the terms “anode” and “cathode” related to an oxidation reaction and a reduction reaction might cause confusion because the anode and the cathode change places at the time of charge and discharge. Thus, the terms “anode” and “cathode” are not used in this specification. If the term “anode” or “cathode” is used, it should be mentioned that the anode or the cathode is which of the one at the time of charge or the one at the time of discharge and corresponds to which of a positive (plus) electrode or a negative (minus) electrode.

Two terminals in FIG. 14(C) are connected to a charger, and the secondary battery 300 is charged. As the charge of the secondary battery 300 proceeds, a potential difference between electrodes increases.

### [Cylindrical Secondary Battery]

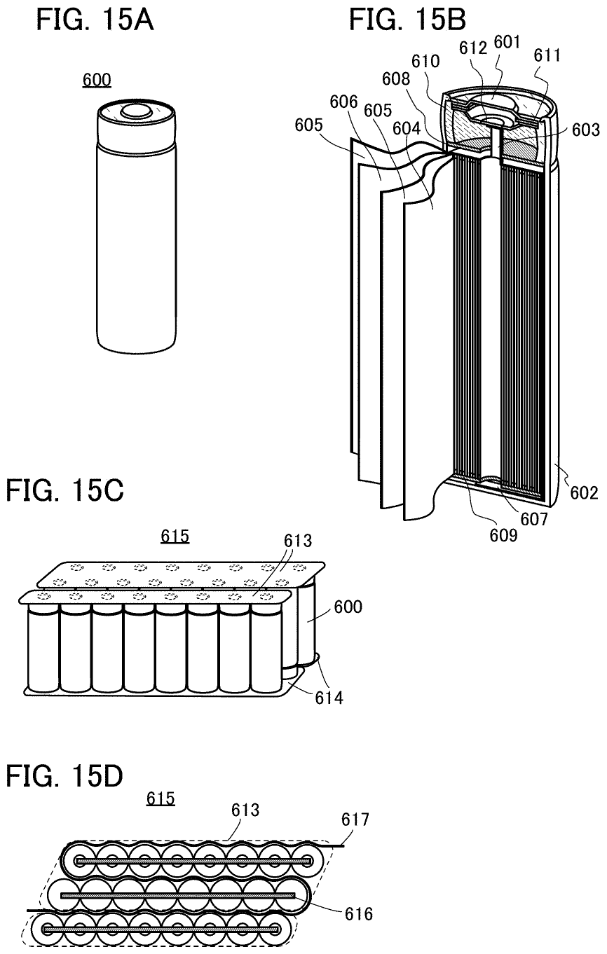

Next, an example of a cylindrical secondary battery is described with reference to FIGS. 15(A), 15(B), 15(C), and 15(D). FIG. 15(A) illustrates an external view of a secondary battery 600. FIG. 15(B) is a schematic cross-sectional view of the cylindrical secondary battery 600. The cylindrical secondary battery 600 includes, as illustrated in FIG. 15(B), a positive electrode cap (battery lid) 601 on the top surface and a battery can (outer can) 602 on the side and bottom surfaces. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

Alternatively, as illustrated in FIG. 15(C), a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 15(D) is a top view of the module 615. The conductive plate 613 is shown by a dotted line for clarity of the drawing. As illustrated in FIG. 15(D), the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### [Structure Examples of Secondary Battery]

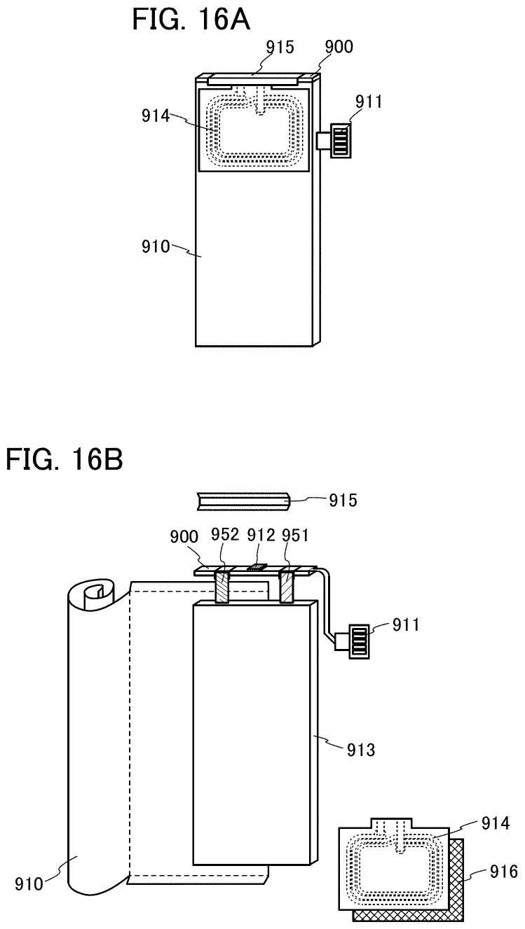

Other structure examples of secondary batteries are described with reference to FIG. 16(A) to FIG. 20(C).

FIG. 16(A) and FIG. 16(B) are external views of a battery pack. The battery pack includes a circuit board 900 and a secondary battery 913. A label 910 is attached to the secondary battery 913. In addition, as illustrated in FIG. 16(B), the secondary battery includes a terminal 951 and a terminal 952.

The circuit board 900 includes a circuit 912. The terminals 911 are connected to the terminal 951, the terminal 952, the antenna 914, and the circuit 912 via the circuit board 900. Note that a plurality of terminals 911 serving as a control signal input terminal, a power supply terminal, and the like may be provided.

The circuit 912 may be provided on the rear surface of the circuit board 900. Note that the shape of the antenna 914 is not limited to a coil shape and may be a linear shape or a plate shape. Furthermore, a planar antenna, an aperture antenna, a traveling-wave antenna, an EH antenna, a magnetic-field antenna, a dielectric antenna, or the like may be used.

Alternatively, the antenna 914 may be a flat-plate conductor. The flat-plate conductor can serve as one of conductors for electric field coupling. That is, the antenna 914 can serve as one of two conductors of a capacitor. Thus, electric power can be transmitted and received not only by an electromagnetic field or a magnetic field but also by an electric field.

The battery pack includes a layer 916 between the secondary battery 913 and the antenna 914. The layer 916 has a function of preventing an influence on an electromagnetic field by the secondary battery 913, for example. As the layer 916, for example, a magnetic body can be used.

Note that the structure of the secondary battery is not limited to that illustrated in FIGS. 16(A) and 16(B).

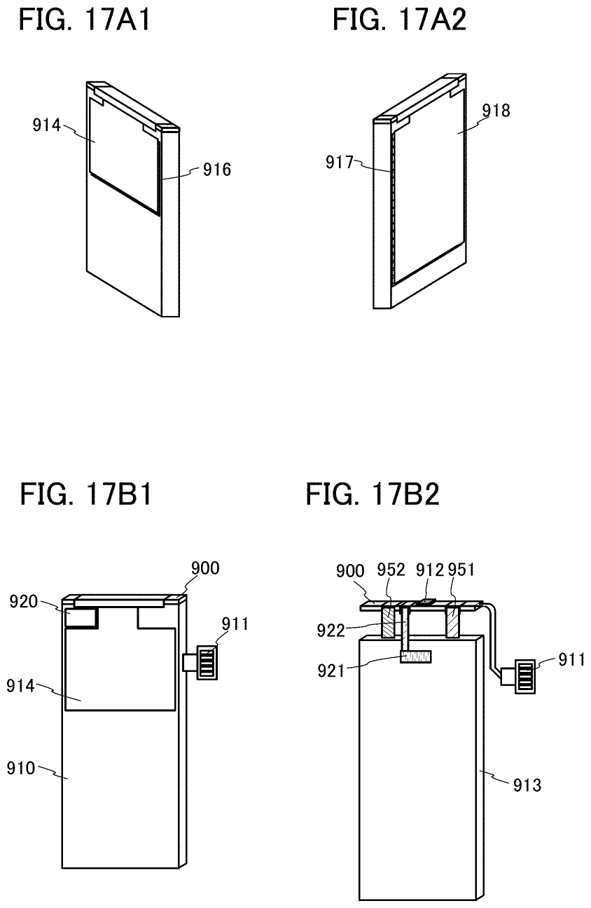

For example, as illustrated in FIG. 17(A1) and FIG. 17(A2), two opposite surfaces of the secondary battery 913 in FIG. 16(A) and FIG. 16(B) may be provided with respective antennas. FIG. 17(A1) is an external view seen from one side of the opposite surfaces, and FIG. 17(A2) is an external view seen from the other side of the opposite surfaces. For portions similar to those in FIG. 16(A) and FIG. 16(B), refer to the description of the secondary battery illustrated in FIG. 16(A) and FIG. 16(B) as appropriate.

As illustrated in FIG. 17(A1), the antenna 914 is provided on one of the opposite surfaces of the secondary battery 913 with the layer 916 located therebetween, and as illustrated in FIG. 17(A2), an antenna 918 is provided on the other of the opposite surfaces of the secondary battery 913 with a layer 917 located therebetween. The layer 917 has a function of preventing an influence on an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as near field communication (NFC), can be employed.

Alternatively, as illustrated in FIG. 17(B1), the secondary battery 913 in FIG. 16(A) and FIG. 16(B) may be provided with a display device 920. The display device 920 is electrically connected to the terminal 911. Note that the label 910 is not necessarily provided in a portion where the display device 920 is provided. For portions similar to those in FIG. 16(A) and FIG. 16(B), refer to the description of the secondary battery illustrated in FIG. 16(A) and FIG. 16(B) as appropriate.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 17(B2), the secondary battery 913 illustrated in FIG. 16(A) and FIG. 16(B) may be provided with a sensor 921. The sensor 921 is electrically connected to the terminal 911 via a terminal 922. For portions similar to those in FIG. 16(A) and FIG. 16(B), refer to the description of the secondary battery illustrated in FIG. 16(A) and FIG. 16(B) as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be acquired and stored in a memory inside the circuit 912.

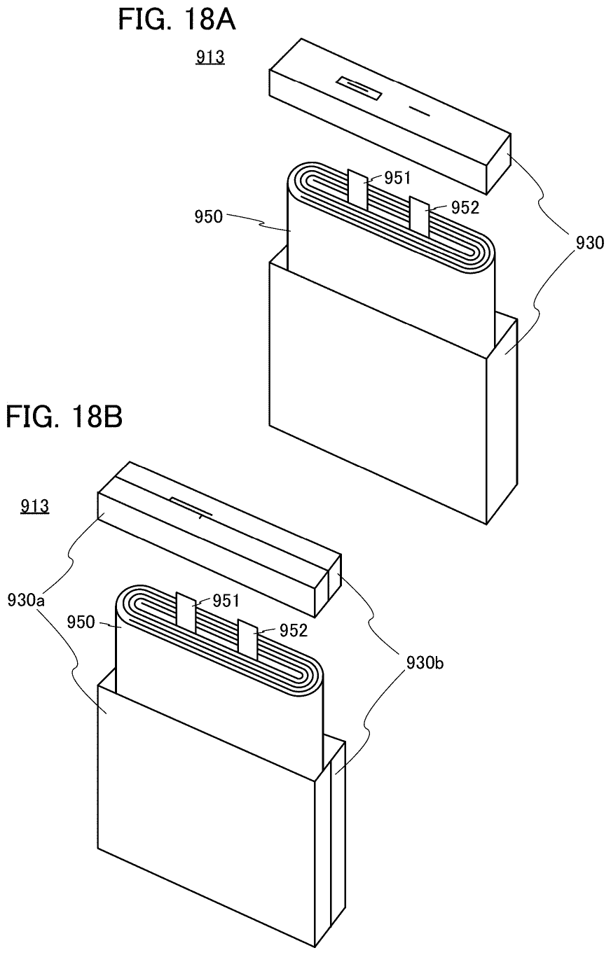

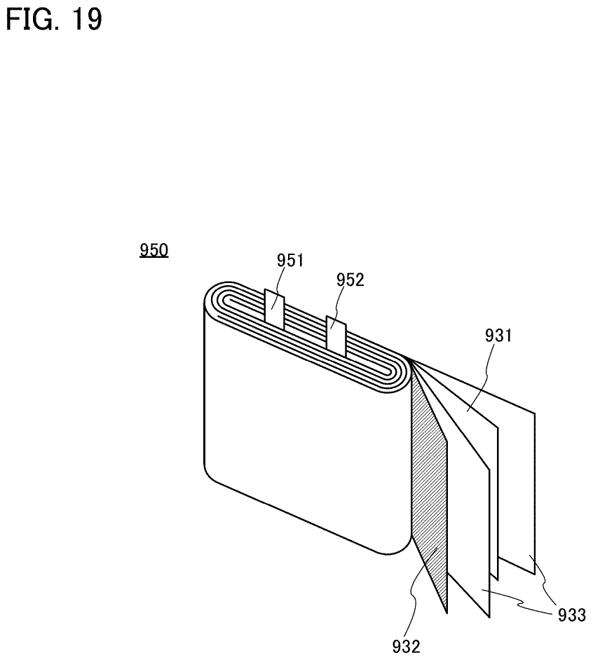

Furthermore, structure examples of the secondary battery 913 are described with reference to FIGS. 18(A) and 18(B) and FIG. 19.

The secondary battery 913 illustrated in FIG. 18(A) includes a wound body 950 provided with the terminal 951 and the terminal 952 inside a housing 930. The wound body 950 is soaked in an electrolyte solution inside the housing 930. The terminal 952 is in contact with the housing 930. An insulator or the like inhibits contact between the terminal 951 and the housing 930. Note that in FIG. 18(A), the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 18(B), the housing 930 in FIG. 18(A) may be formed using a plurality of materials. For example, in the secondary battery 913 in FIG. 18(B), a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 and the antenna 918 may be provided inside the housing 930a. For the housing 930b, a metal material can be used, for example.

FIG. 19 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be stacked.

The negative electrode 931 is connected to the terminal 911 in FIGS. 16(A) and 16(B) via one of the terminal 951 and the terminal 952. The positive electrode 932 is connected to the terminal 911 in FIGS. 16(A) and 16(B) via the other of the terminal 951 and the terminal 952.

When the positive electrode active material described in the above embodiment is used in the positive electrode 932, the secondary battery 913 with high capacity and excellent cycle performance can be obtained.

### [Laminated Secondary Battery]

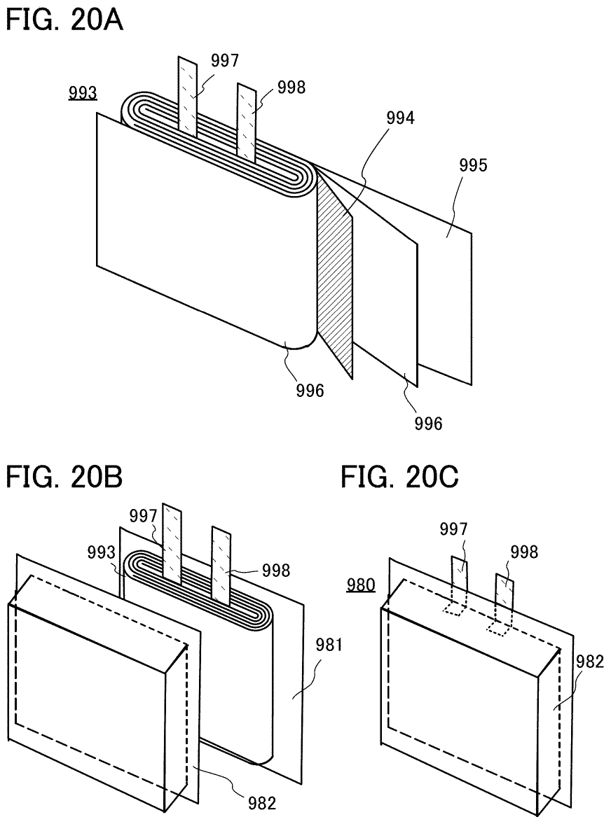

Next, an example of a laminated secondary battery is described with reference to FIG. 20(A) to FIG. 26(B). When the laminated secondary battery has flexibility and is used in an electronic device at least part of which is flexible, the secondary battery can be bent as the electronic device is bent.

A laminated secondary battery 980 is described with reference to FIGS. 20(A), 20(B), and 20(C). The laminated secondary battery 980 includes a wound body 993 illustrated in FIG. 20(A). The wound body 993 includes a negative electrode 994, a positive electrode 995, and separators 996. The wound body 993 is, like the wound body 950 illustrated in FIG. 19, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be determined as appropriate depending on required capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 20(B), the wound body 993 is packed in a space formed by bonding a film 981 and a film 982 having a depressed portion that serve as exterior bodies by thermocompression bonding or the like, whereby the secondary battery 980 illustrated in FIG. 20(C) can be formed. The wound body 993 includes the lead electrode 997 and the lead electrode 998, and is soaked in an electrolyte solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIGS. 20(B) and 20(C) illustrate an example where a space is formed by two films, the wound body 993 may be placed in a space formed by bending one film

When the positive electrode active material described in the above embodiment is used in the positive electrode 995, the secondary battery 980 with high capacity and excellent cycle performance can be obtained.

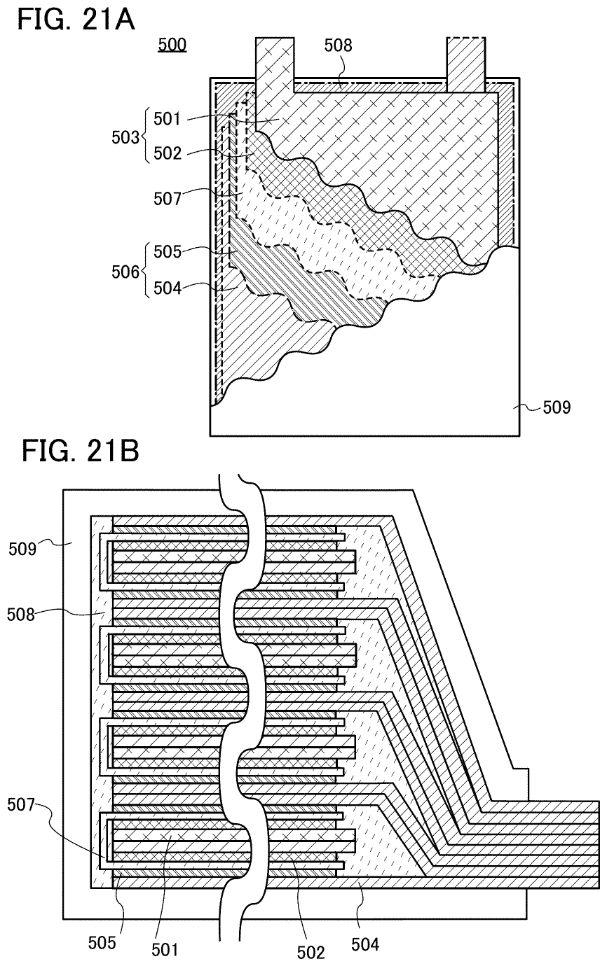

In FIGS. 20(B) and 20(C), an example in which the secondary battery 980 includes a wound body in a space formed by films serving as exterior bodies is described; however, as illustrated in FIGS. 21(A) and 21(B), a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 21(A) includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 2 can be used as the electrolyte solution 508.

In the laminated secondary battery 500 illustrated in FIG. 21(A), the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 21(B) illustrates an example of a cross-sectional structure of the laminated secondary battery 500. Although FIG. 21(A) illustrates an example in which only two current collectors are included for simplicity, an actual battery includes a plurality of electrode layers.

In FIG. 21(B), the number of electrode layers is 16, for example. The laminated secondary battery 500 has flexibility even though including 16 electrode layers. FIG. 21(B) illustrates a structure including 8 layers of negative electrode current collectors 504 and 8 layers of positive electrode current collectors 501, i.e., 16 layers in total. Note that FIG. 21(B) illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high capacity. In contrast, with a small number of electrode layers, the secondary battery can have small thickness and high flexibility.

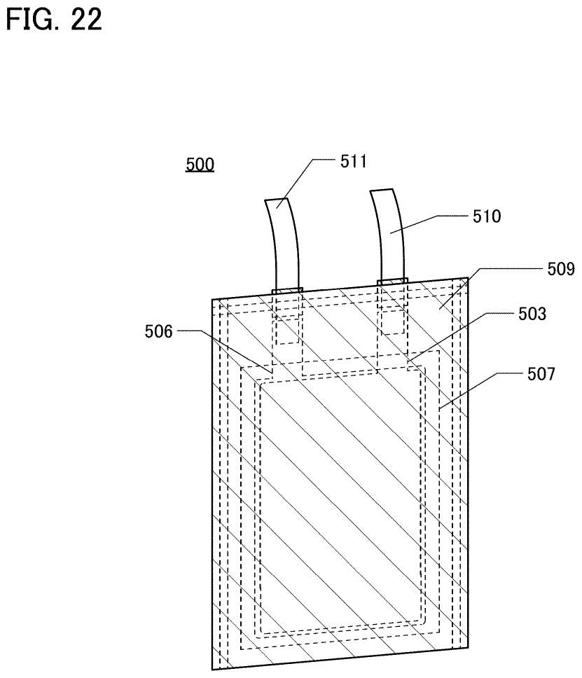

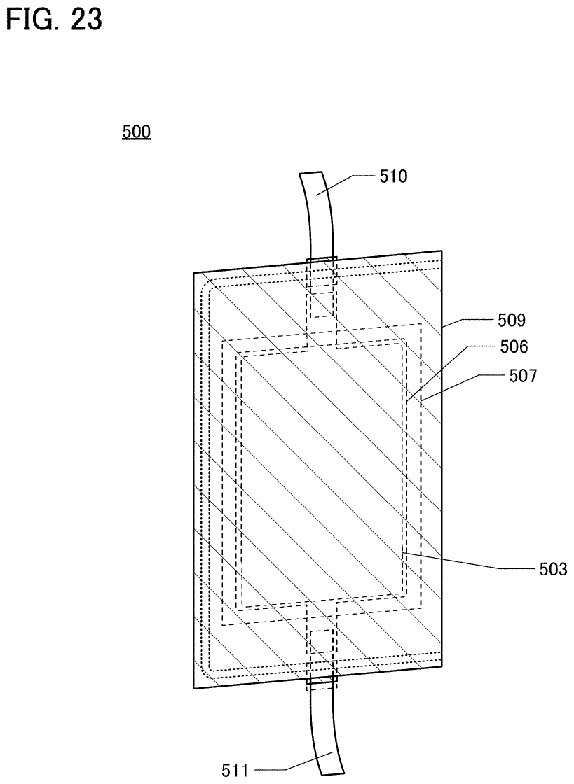

FIG. 22 and FIG. 23 each illustrate an example of the external view of the laminated secondary battery 500. In FIG. 22 and FIG. 23, the laminated secondary battery 500 includes the positive electrode 503, the negative electrode 506, the separator 507, the exterior body 509, a positive electrode lead electrode 510, and a negative electrode lead electrode 511.

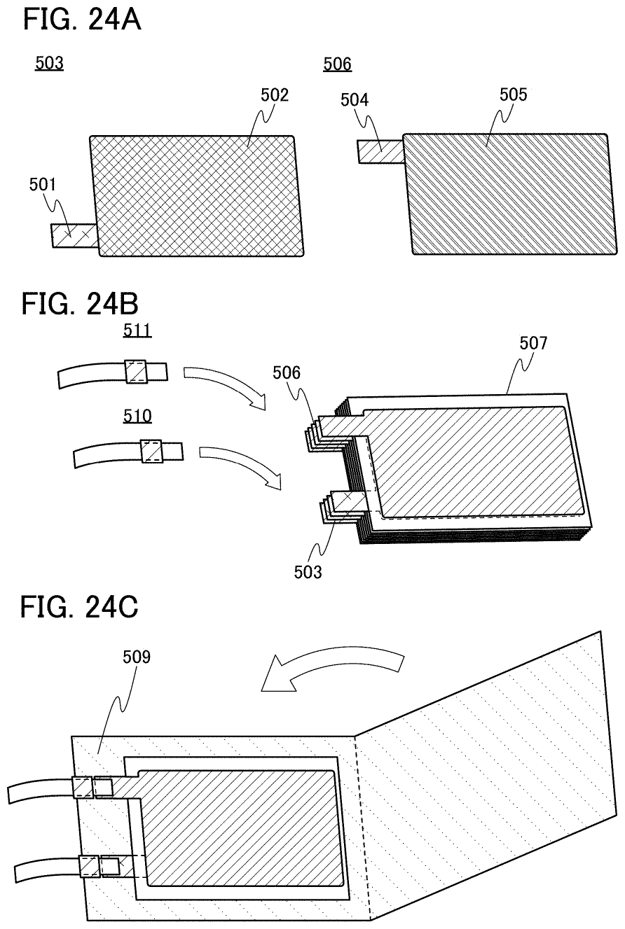

FIG. 24(A) illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 24(A).

### [Method for Forming Laminated Secondary Battery]

Here, an example of a method for forming the laminated secondary battery whose external view is illustrated in FIG. 22 is described with reference to FIGS. 24(B) and 24(C).

First, the negative electrode 506, the separator 507, and the positive electrode 503 are stacked. FIG. 24(B) illustrates a stack including the negative electrode 506, the separator 507, and the positive electrode 503. The secondary battery described here as an example includes 5 negative electrodes and 4 positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a dashed line as illustrated in FIG. 24(C). Then, the outer edges of the exterior body 509 are bonded to each other. The bonding can be performed by thermocompression, for example. At this time, a part (or one side) of the exterior body 509 is left unbonded (to provide an inlet) so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is sealed by bonding. In the above manner, the laminated secondary battery 500 can be manufactured.

When the positive electrode active material described in the above embodiment is used in the positive electrode 503, the secondary battery 500 with high capacity and excellent cycle performance can be obtained.

### [Bendable Secondary Battery]

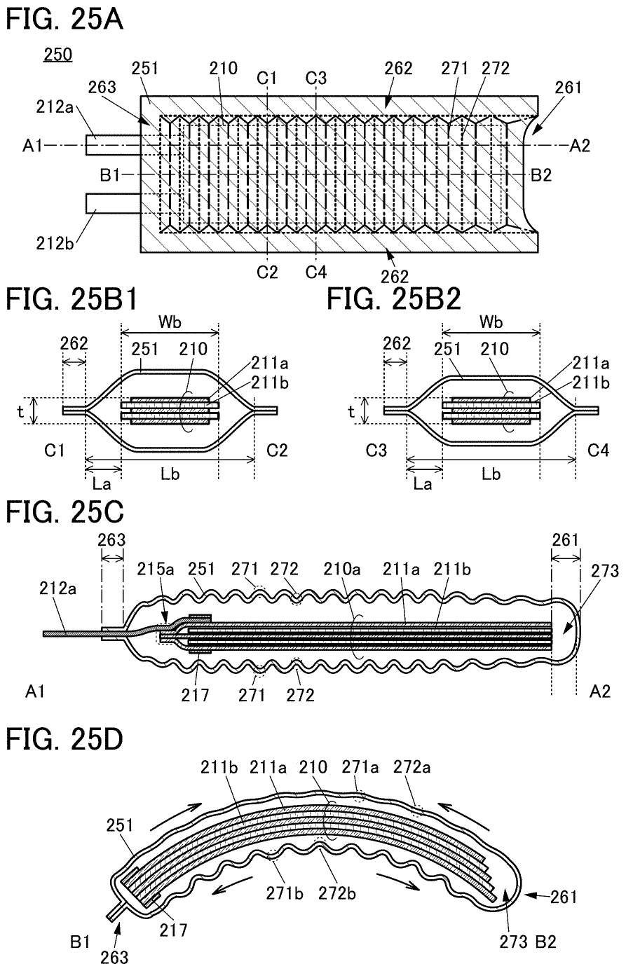

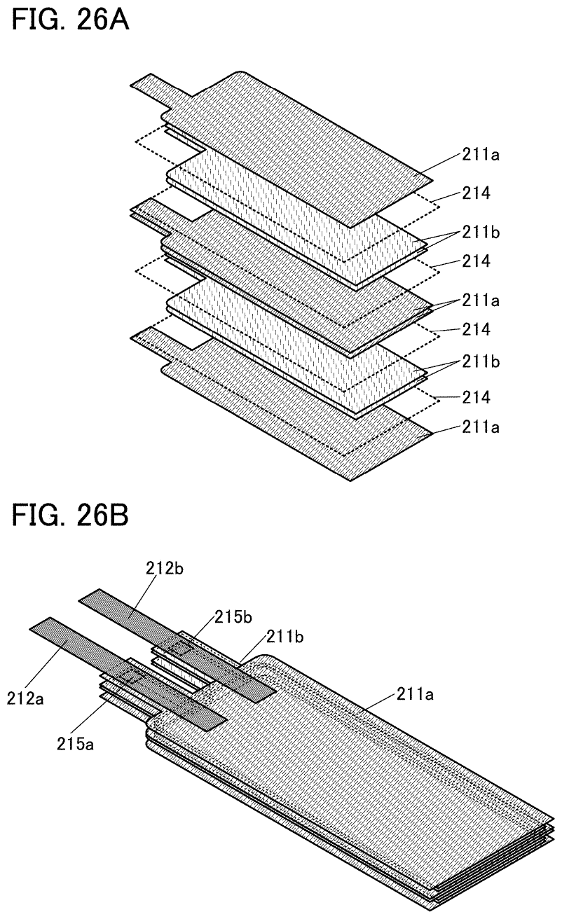

Next, an example of a bendable secondary battery is described with reference to FIGS. 25(A), 25(B1), 25(B2), 25(C), and 25(D) and FIGS. 26(A) and 26(B).

FIG. 25(A) is a schematic top view of a bendable secondary battery 250. FIGS. 25(B1), 25(B2), and 25(C) are schematic cross-sectional views taken along the cutting line C1-C2, the cutting line C3-C4, and the cutting line A1-A2, respectively, in FIG. 25(A). The secondary battery 250 includes an exterior body 251 and a positive electrode 211a and a negative electrode 211b held in the exterior body 251. A lead 212a electrically connected to the positive electrode 211a and a lead 212b electrically connected to the negative electrode 211b are extended to the outside of the exterior body 251. In addition to the positive electrode 211a and the negative electrode 211b, an electrolyte solution (not illustrated) is enclosed in a region surrounded by the exterior body 251.

FIGS. 26(A) and 26(B) illustrate the positive electrode 211a and the negative electrode 211b included in the secondary battery 250. FIG. 26(A) is a perspective view illustrating the stacking order of the positive electrode 211a, the negative electrode 211b, and a separator 214. FIG. 26(B) is a perspective view illustrating the lead 212a and the lead 212b in addition to the positive electrode 211a and the negative electrode 211b.

As illustrated in FIG. 26(A), the secondary battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab portion. A positive electrode active material layer is formed on one surface of the positive electrode 211a other than the tab portion, and a negative electrode active material layer is formed on one surface of the negative electrode 211b other than the tab portion.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material is not formed are in contact with each other.

Furthermore, the separator 214 is provided between the surface of the positive electrode 211a on which the positive electrode active material is formed and the surface of the negative electrode 211b on which the negative electrode active material is formed. In FIG. 26(A), the separator 214 is shown by a dotted line for easy viewing.

In addition, as illustrated in FIG. 26(B), the plurality of positive electrodes 211a are electrically connected to the lead 212a in a bonding portion 215a. The plurality of negative electrodes 211b are electrically connected to the lead 212b in a bonding portion 215b.

Next, the exterior body 251 is described with reference to FIGS. 25(B1), 25(B2), 25(C), and 25(D).

The exterior body 251 has a film-like shape and is folded in half with the positive electrodes 211a and the negative electrodes 211b between facing portions of the exterior body 251. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 25(B1) shows a cross section along the part overlapping with the crest line 271. FIG. 25(B2) shows a cross section along the part overlapping with the trough line 272. FIGS. 25(B1) and 25(B2) correspond to cross sections of the secondary battery 250, the positive electrodes 211a, and the negative electrodes 211b in the width direction.

Here, the distance between end portions of the positive electrode 211a and the negative electrode 211b in the width direction and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte solution. Therefore, the distance La is preferably set as long as possible. However, if the distance La is too long, the volume of the secondary battery 250 is increased.

The distance La between the positive and negative electrodes 211a and 211b and the seal portion 262 is preferably increased as the total thickness of the stacked positive electrodes 211a and negative electrodes 211b is increased.

Specifically, when the total thickness of the stacked positive electrodes 211a, negative electrodes 211b, and separators 214 (not illustrated) is referred to as a thickness t, the distance La is preferably 0.8 times or more and 3.0 times or less, further preferably 0.9 times or more and 2.5 times or less, and still further preferably 1.0 times or more and 2.0 times or less as large as the thickness t. When the distance La is in the above range, a compact battery highly reliable for bending can be obtained.

Furthermore, when the distance between the pair of seal portions 262 is referred to as a distance Lb, it is preferred that the distance Lb be sufficiently longer than the widths of the positive electrode 211a and the negative electrode 211b (here, a width Wb of the negative electrode 211b). In that case, even when the positive electrode 211a and the negative electrode 211b come into contact with the exterior body 251 by change in the shape of the secondary battery 250, such as repeated bending, the position of part of the positive electrode 211a and the negative electrode 211b can be shifted in the width direction; thus, the positive and negative electrodes 211a and 211b and the exterior body 251 can be effectively prevented from being rubbed against each other.

For example, the difference between the distance Lb (i.e., the distance between the pair of seal portions 262) and the width Wb of the negative electrode 211b is preferably 1.6 times or more and 6.0 times or less, further preferably 1.8 times or more and 5.0 times or less, and still further preferably 2.0 times or more and 4.0 times or less as large as the thickness t of the positive electrode 211a and the negative electrode 211b.

In other words, the distance Lb, the width Wb, and the thickness t preferably satisfy the relationship of Formula 1 below.

$$\frac{L b - W b}{2 t} \geq a \qquad [ Formula 1 ]$$

In the formula, a is 0.8 or more and 3.0 or less, preferably 0.9 or more and 2.5 or less, further preferably 1.0 or more and 2.0 or less.

FIG. 25(C) illustrates a cross section including the lead 212a and corresponds to a cross section of the secondary battery 250, the positive electrode 211a, and the negative electrode 211b in the length direction. As illustrated in FIG. 25(C), a space 273 is preferably provided between the end portions of the positive electrode 211a and the negative electrode 211b in the length direction and the exterior body 251 in the folded portion 261.

FIG. 25(D) is a schematic cross-sectional view of the secondary battery 250 in a state of being bent. FIG. 25(D) corresponds to a cross section along the cutting line B1-B2 in FIG. 25(A).

When the secondary battery 250 is bent, a part of the exterior body 251 positioned on the outer side in bending is unbent and the other part positioned on the inner side changes its shape as it shrinks. More specifically, the part of the exterior body 251 positioned on the outer side in bending changes its shape such that the wave amplitude becomes smaller and the length of the wave period becomes larger. In contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand and contract. Thus, the secondary battery 250 can be bent with weak force without damage to the exterior body 251.

Furthermore, as illustrated in FIG. 25(D), when the secondary battery 250 is bent, the positions of the positive electrode 211a and the negative electrode 211b are shifted relatively. At this time, ends of the stacked positive electrodes 211a and negative electrodes 211b on the seal portion 263 side are fixed by a fixing member 217. Thus, the plurality of positive electrodes 211a and the plurality of negative electrodes 211b are more shifted at a position closer to the folded portion 261. Therefore, stress applied to the positive electrode 211a and the negative electrode 211b is relieved, and the positive electrode 211a and the negative electrode 211b themselves do not need to expand and contract. Consequently, the secondary battery 250 can be bent without damage to the positive electrode 211a and the negative electrode 211b.

Furthermore, the space 273 is provided between the positive electrode 211a and the negative electrode 211b, whereby the relative positions of the positive electrode 211a and the negative electrode 211b can be shifted while the positive electrode 211a and the negative electrode 211b located on an inner side when the secondary battery 250 is bent do not come in contact with the exterior body 251.

In the secondary battery 250 illustrated in FIGS. 25(A), 25(B1), 25(B2), 25(C), and 25(D) and FIGS. 26(A) and 26(B), the exterior body, the positive electrode 211a, and the negative electrode 211b are less likely to be damaged and the battery characteristics are less likely to deteriorate even when the secondary battery 250 is repeatedly bent and unbent. When the positive electrode active material described in the above embodiment are used in the positive electrode 211a included in the secondary battery 250, a battery with better cycle performance can be obtained.

### Embodiment 4

In this embodiment, examples of electronic devices each including the secondary battery of one embodiment of the present invention are described.

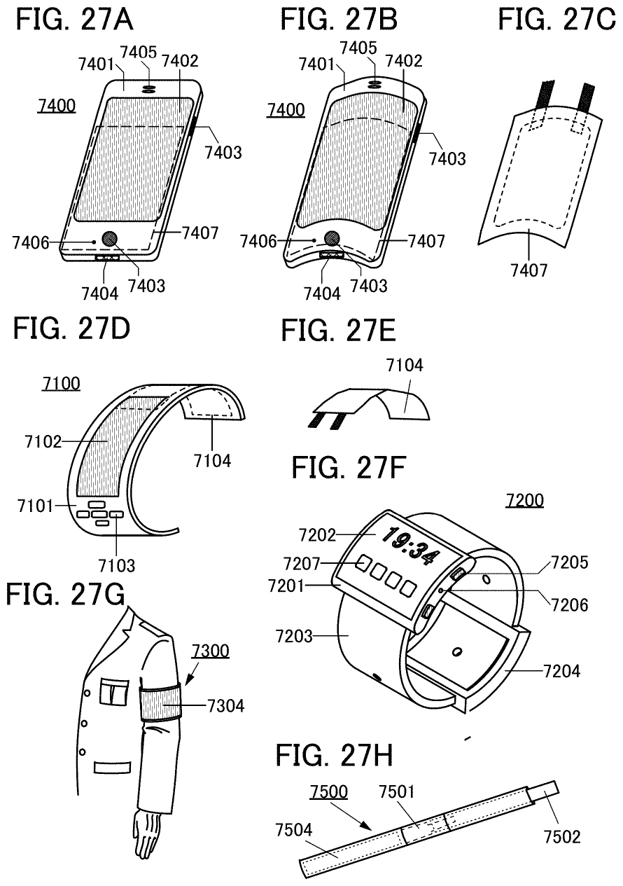

First, FIGS. 27(A) to 27(G) show examples of electronic devices including the bendable secondary battery described in Embodiment 3. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

In addition, a flexible secondary battery can be incorporated along a curved inside/outside wall surface of a house or a building or a curved interior/exterior surface of an automobile.

FIG. 27(A) illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 27(B) illustrates the mobile phone 7400 that is bent. When the whole mobile phone 7400 is bent by the external force, the secondary battery 7407 included in the mobile phone 7400 is also bent. FIG. 27(C) illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 27(D) illustrates an example of a bangle display device. A portable display device 7100 includes a housing 7101, a display portion 7102, operation buttons 7103, and a secondary battery 7104. FIG. 27(E) illustrates the bent secondary battery 7104. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed in the range of radius of curvature from 40 mm to 150 mm inclusive. When the radius of curvature at the main surface of the secondary battery 7104 is greater than or equal to 40 mm and less than or equal to 150 mm, the reliability can be kept high. When the secondary battery of one embodiment of the present invention is used as the secondary battery 7104, a lightweight portable display device with a long lifetime can be provided.

FIG. 27(F) illustrates an example of a watch-type portable information terminal A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operation system incorporated in the portable information terminal 7200.

The portable information terminal 7200 can employ near field communication that is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 27(E) that is in the state of being curved can be provided in the housing 7201. Alternatively, the secondary battery 7104 illustrated in FIG. 27(E) can be provided in the band 7203 such that it can be curved.

The portable information terminal 7200 preferably includes a sensor. As the sensor, for example a human body sensor such as a fingerprint sensor, a pulse sensor, or a temperature sensor, a touch sensor, a pressure sensitive sensor, or an acceleration sensor is preferably mounted.

FIG. 27(G) illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication, which is a communication method based on an existing communication standard.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

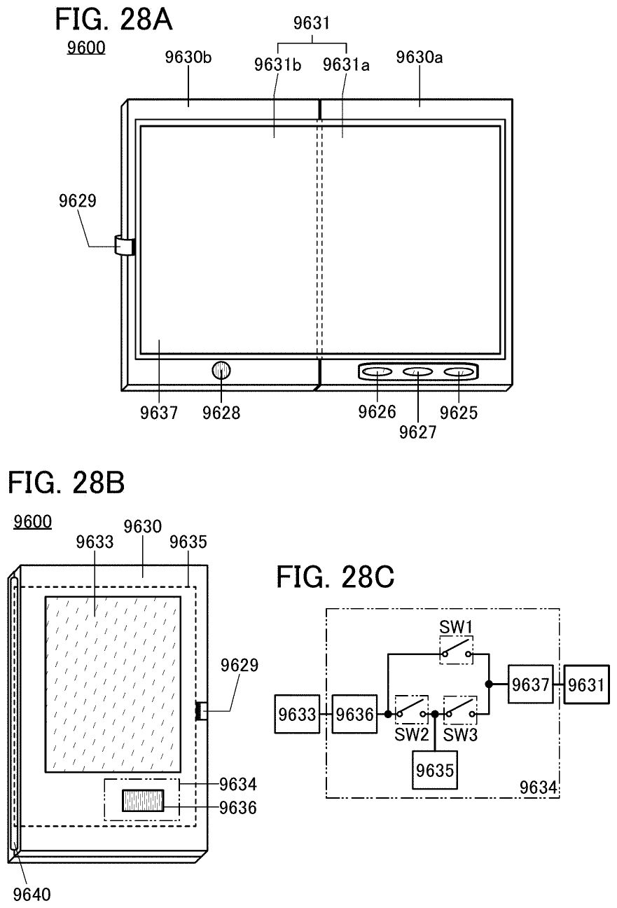

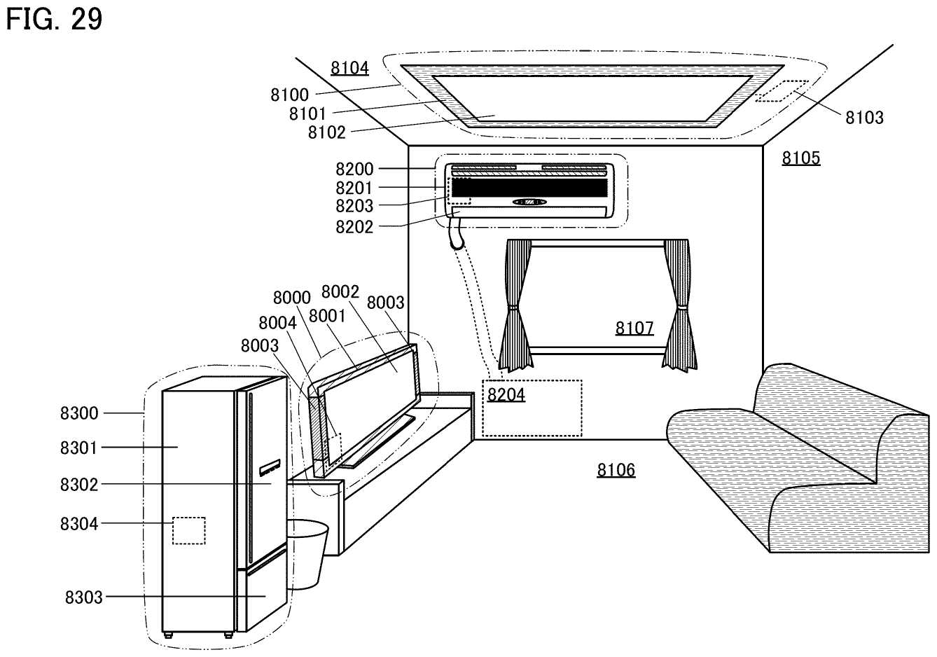

In addition, examples of electronic devices each including the secondary battery with excellent cycle performance described in the above embodiment are described with reference to FIG. 27(H), FIGS. 28(A), 28(B), and 28(C), and FIG. 29.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 27(H) is a perspective view of a device called a vaporizer (electronic cigarette). In FIG. 27(H), an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 in FIG. 24(H) includes an external terminal for connection to a charger. When the electronic cigarette 7500 is held by a user, the secondary battery 7504 becomes a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIGS. 28(A) and 28(B) illustrate an example of a tablet terminal that can be folded in half. A tablet terminal 9600 illustrated in FIGS. 28(A) and 28(B) includes a housing 9630a, a housing 9630b, a movable portion 9640 connecting the housings 9630a and 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 28(A) illustrates the tablet terminal 9600 that is opened, and FIG. 28(B) illustrates the tablet terminal 9600 that is closed.

The tablet terminal 9600 includes a power storage unit 9635 inside the housing 9630a and the housing 9630b. The power storage unit 9635 is provided across the housings 9630a and 9630b, passing through the movable portion 9640.

Part of or the entire display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

In addition, it is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display keyboard buttons on the display portion 9631.

In addition, touch input can be performed concurrently in a touch panel region in the display portion 9631a on the housing 9630a side and a touch panel region in the display portion 9631b on the housing 9630b side.

The switches 9625 to 9627 may function not only as an interface for operating the tablet terminal 9600 but also as an interface that can switch various functions. For example, at least one of the switches 9625 to 9627 may have a function of switching on/off of the tablet terminal 9600. For another example, at least one of the switches 9625 to 9627 may have a function of switching display between a portrait mode and a landscape mode and a function of switching display between monochrome display and color display. For another example, at least one of the switches 9625 to 9627 may have a function of adjusting the luminance of the display portion 9631. The display luminance of the display portion 9631 can be controlled in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

The display portion 9631a on the housing 9630a side and the display portion 9631b on the housing 9630b side have substantially the same display area in FIG. 28(A); however, there is no particular limitation on the display areas of the display portions 9631a and 9631b, and the display portions may have different areas or different display quality. For example, one of the display portions 9631a and 9631b may display higher definition images than the other.

The tablet terminal 9600 is folded in half in FIG. 28(B). The tablet terminal 9600 includes a housing 9630, a solar cell 9633, and a charge and discharge control circuit 9634 including a DCDC converter 9636. The power storage unit of one embodiment of the present invention is used as the power storage unit 9635.

The tablet terminal 9600 can be folded in half such that the housings 9630a and 9630b overlap with each other when not in use. Thus, the display portion 9631 can be protected, which increases the durability of the tablet terminal 9600. With the power storage unit 9635 including the secondary battery of one embodiment of the present invention, which has high capacity and excellent cycle performance, the tablet terminal 9600 that can be used for a long time over a long period can be provided.

The tablet terminal 9600 illustrated in FIGS. 28(A) and 28(B) can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, supplies electric power to a touch panel, a display portion, a video signal processing portion, and the like. Note that the solar cell 9633 can be provided on one or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 28(B) are described with reference to a block diagram in FIG. 28(C). The solar cell 9633, the power storage unit 9635, the DCDC converter 9636, a converter 9637, switches SW1 to SW3, and the display portion 9631 are illustrated in FIG. 28(C), and the power storage unit 9635, the DCDC converter 9636, the converter 9637, and the switches SW1 to SW3 correspond to the charge and discharge control circuit 9634 in FIG. 28(B).

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage of the electric power is raised or lowered by the converter 9637 to a voltage needed for operating the display portion 9631. When display on the display portion 9631 is not performed, the switch SW1 is turned off and the switch SW2 is turned on, so that the power storage unit 9635 can be charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the power storage unit 9635 may be charged with a non-contact power transmission module that transmits and receives power wirelessly (without contact), or with a combination of other charge units.

FIG. 29 illustrates other examples of electronic devices. In FIG. 29, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides TV broadcast reception.

In FIG. 29, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 29 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 29 as an example, the secondary battery of one embodiment of the present invention can be used in an installation lighting device provided in, for example, a wall 8105, a floor 8106, or a window 8107 other than the ceiling 8104. Alternatively, the secondary battery of one embodiment of the present invention can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 29, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 29 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 29 as an example, the secondary battery of one embodiment of the present invention can be used in an air conditioner in which the functions of an indoor unit and an outdoor unit are integrated in one housing.

In FIG. 29, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 29. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of an electronic device can be prevented by using the secondary battery of one embodiment of the present invention as an auxiliary power supply for supplying electric power which cannot be supplied enough by a commercial power supply.

In addition, in a time period when electronic devices are not used, particularly when the proportion of the amount of electric power which is actually used to the total amount of electric power which can be supplied from a commercial power supply source (such a proportion is referred to as a usage rate of electric power) is low, electric power can be stored in the secondary battery, whereby the usage rate of electric power can be reduced in a time period when the electronic devices are used. For example, in the case of the electric refrigerator-freezer 8300, electric power can be stored in the secondary battery 8304 in night time when the temperature is low and the refrigerator door 8302 and the freezer door 8303 are not often opened or closed. On the other hand, in daytime when the temperature is high and the refrigerator door 8302 and the freezer door 8303 are frequently opened and closed, the secondary battery 8304 is used as an auxiliary power supply; thus, the usage rate of electric power in daytime can be reduced.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained. This embodiment can be implemented in appropriate combination with any of the other embodiments.

### Embodiment 5

In this embodiment, examples of vehicles each including the secondary battery of one embodiment of the present invention are described.

The use of secondary batteries in vehicles enables production of next-generation clean energy vehicles such as hybrid electric vehicles (HEVs), electric vehicles (EVs), and plug-in hybrid electric vehicles (PHEVs).

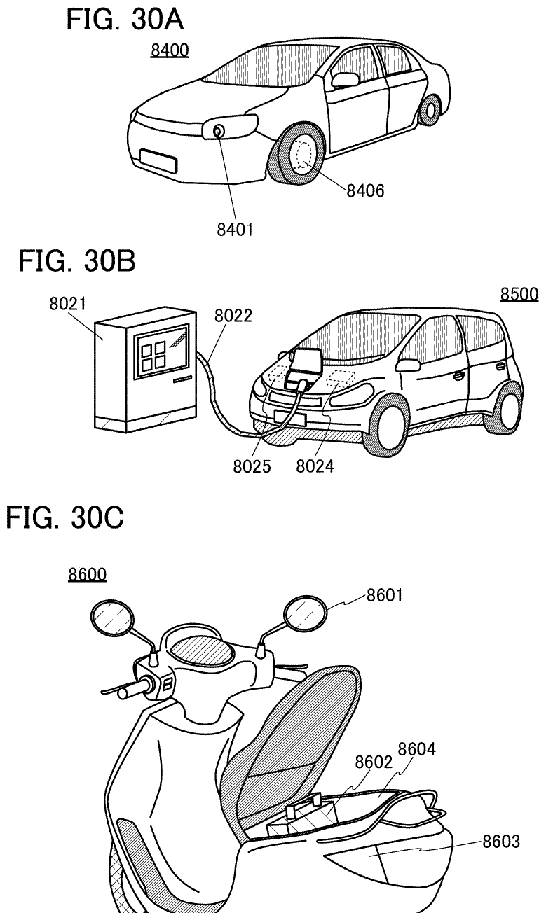

FIGS. 30(A), 30(B), and 30(C) illustrate examples of a vehicle including the secondary battery of one embodiment of the present invention. An automobile 8400 illustrated in FIG. 30(A) is an electric vehicle that runs on the power of an electric motor. Alternatively, the automobile 8400 is a hybrid electric vehicle capable of driving using either an electric motor or an engine as appropriate. The use of one embodiment of the present invention allows fabrication of a high-mileage vehicle. The automobile 8400 includes the secondary battery. As the secondary battery, the modules of the secondary batteries illustrated in FIGS. 15(C) and 15(D) may be arranged to be used in a floor portion in the automobile. Alternatively, a battery pack in which a plurality of secondary batteries each of which is illustrated in FIGS. 18(A) and 18(B) are combined may be placed in the floor portion in the automobile. The secondary battery is used not only for driving an electric motor 8406, but also for supplying electric power to a light-emitting device such as a headlight 8401 or a room light (not illustrated).

The secondary battery can also supply electric power to a display device included in the automobile 8400, such as a speedometer or a tachometer. Furthermore, the secondary battery can supply electric power to a semiconductor device included in the automobile 8400, such as a navigation system.

FIG. 30(B) illustrates an automobile 8500 including the secondary battery. The automobile 8500 can be charged when the secondary battery is supplied with electric power through external charge equipment by a plug-in system, a contactless power feeding system, or the like. In FIG. 30(B), a secondary battery 8024 included in the automobile 8500 are charged with the use of a ground-based charge apparatus 8021 through a cable 8022. In charge, a given method such as CHAdeMO (registered trademark) or Combined Charging System may be employed as a charge method, the standard of a connector, or the like as appropriate. The charge apparatus 8021 may be a charge station provided in a commerce facility or a power source in a house. For example, with the use of a plug-in technique, the secondary battery 8024 included in the automobile 8500 can be charged by being supplied with electric power from outside. The charge can be performed by converting AC electric power into DC electric power through a converter such as an AC-DC converter.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 30(C) shows an example of a motorcycle including the secondary battery of one embodiment of the present invention. A motor scooter 8600 illustrated in FIG. 30(C) includes a secondary battery 8602, side mirrors 8601, and indicators 8603. The secondary battery 8602 can supply electric power to the indicators 8603.

Furthermore, in the motor scooter 8600 illustrated in FIG. 30(C), the secondary battery 8602 can be held in a storage unit under seat 8604. The secondary battery 8602 can be held in the storage unit under seat 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

In this example, positive electrode active materials containing magnesium, fluorine, and phosphorus were formed, secondary batteries including positive electrodes using the positive electrode active materials were formed, and the continuous charge tolerance and cycle performance of the secondary batteries were evaluated.

### <Formation of Positive Electrode Active Material>

The positive electrode active materials were formed with reference to the flowcharts illustrated in FIG. 8 and FIG. 9. Note that Step S42 to Step S47 were not performed.

First, the mixture 902 containing magnesium and fluorine was formed (Steps Step S11 to Step S14 illustrated in FIG. 8). First, LiF and MgF₂ were weighted so that the molar ratio of LiF to MgF₂ was LiF:MgF₂=1:3, acetone was added as a solvent, and the materials were mixed and ground by a wet process. The mixing and the grinding were performed in a ball mill using a zirconia ball at 150 rpm for one hour. The material that has been subjected to the treatment was collected to be the mixture 902.

Next, a positive electrode active material containing cobalt was prepared (Step S25). Here, CELLSEED C-10N manufactured by NIPPON CHEMICAL INDUSTRIAL CO., LTD. was used for lithium cobalt oxide synthesized in advance. CELLSEED C-10N is lithium cobalt oxide having D50 of approximately 12 μm and few impurities.

Then, the mixture 902 and the lithium cobalt oxide were mixed (Step S31). The conditions for the atomic weight of magnesium contained in the mixture 902 with respect to the atomic weight of cobalt in the lithium cobalt oxide were varied. Weighing was performed so that the values for varied conditions were approximately 0.5%, 1.0%, 2.0%, 3.0%, and 6.0%. The atomic weight of magnesium in each of the formed positive electrode active material is shown in Table 1 and Table 2 described later. The mixing was performed by a dry method. The mixing was performed in a ball mill using a zirconia ball at 150 rpm for one hour.

Subsequently, the materials that has been subjected to the treatment were collected to obtain the mixtures 903 (Step S32 and Step S33).

Next, each of the mixtures 903 was put in an alumina crucible and annealed at 850° C. using a muffle furnace in an oxygen atmosphere for 60 hours (Step S34). At the time of annealing, the alumina crucible was covered with a lid. The flow rate of oxygen was 10 L/min. The temperature rising rate was 200° C./hr and the temperature decreasing time was longer than or equal to 10 hours. The materials that have been subjected to the heat treatment were collected (Step S35), each of the collected materials was made to pass through a sieve, and positive electrode active materials in which the conditions of the addition amount of magnesium were varied (the positive electrode active materials 100A_1 illustrated in FIG. 8) were obtained (Step S36). Hereinafter, the positive electrode active materials 100A_1 with the magnesium concentration of 0.5%, 1.0%, 2.0%, 3.0%, and 6.0% are referred to as Sample 11, Sample 12, Sample 13, Sample 14, and Sample 15, respectively. For forming the positive electrodes described later, both of the positive electrode active materials 100A_1 obtained in this step and positive electrode active materials on which Step S51 to Step S54 described later were performed after this step were used.

Then, the addition of metals in Step S42 to Step S47 illustrated in FIG. 9 was not performed, and the process went to Step S51.

Next, lithium phosphate was prepared (Step S51). Next, lithium phosphate and each of the positive electrode active materials 100A_1 were mixed (Step S52). The amount of mixed lithium phosphate was an amount corresponding to 0.06 mol when each of the positive electrode active materials 100A_1 was 1 mol. The mixing was performed in a ball mill using a zirconia ball at 150 rpm for one hour. After the mixing, each of the mixtures was made to pass through a sieve with 300 μmϕ. After that, the obtained mixtures were each put in an alumina crucible, the alumina crucible was covered with a lid, and annealing was performed at 750° C. for 20 hours in an oxygen atmosphere (Step S53). After that, each of the annealed mixtures was made to pass through a sieve with 53 mϕ, and the powder was collected (Step S54). Through the above steps, the positive electrode active materials to which a compound containing phosphorus was added and in which the conditions of the addition amount of magnesium were varied were obtained (hereinafter, the positive electrode active materials with the magnesium concentration of 0.5%, 1.0%, 2.0%, 3.0%, and 6.0% are referred to as Sample 21, Sample 22, Sample 23, Sample 24, and Sample 25, respectively).

### <Formation of Secondary Battery>

Positive electrodes were formed using the positive electrode active materials obtained above. A current collector that was coated with slurry in which the positive electrode active material, AB, and PVDF were mixed at the active material:AB:PVDF=95:3:2 (weight ratio) was used. As a solvent of the slurry, NMP was used.

After the current collector were coated with the slurry, the solvent was volatilized. Then, pressure was applied at 210 kN/m and then at 1467 kN/m. Through the above process, the positive electrodes were obtained. The carried amount of the positive electrode was approximately 20 mg/cm².

CR2032 type coin secondary batteries (a diameter of 20 mm, a height of 3.2 mm) were manufactured using the formed positive electrodes.

A lithium metal was used for a counter electrode.

As an electrolyte contained in the electrolyte solution, 1 mol/L lithium hexafluorophosphate (LiPF₆) was used. As the electrolyte solution, an electrolyte solution in which ethylene carbonate (EC) and diethyl carbonate (DEC) were mixed at EC:DEC=3:7 (volume ratio) was used. Note that for the secondary batteries used for evaluating the cycle performance, 2 wt % of vinylene carbonate (VC) was added to the electrolytic solution.

As a separator, 25-μm-thick polypropylene was used.

A positive electrode can and a negative electrode can formed of stainless steel (SUS) were used as a positive electrode can and a negative electrode can.

### <Continuous Charge Tolerance>

Next, the continuous charge tolerance of each of the secondary batteries using the positive electrode active materials was evaluated. First, the secondary batteries were measured at 25° C. for two cycles while the CCCV charge (0.05 C, 4.5 V or 4.6 V, a termination current of 0.005 C) and the CC discharge (0.05 C, 2.5 V) were performed.

After that, the CCCV charge (0.05 C) was performed at 60° C. The upper limit voltage was set to 4.55 V or 4.65 V, and the time until the voltage of the secondary battery became below the value obtained by subtracting 0.01 V from the upper limit voltage (4.54 V when the upper limit voltage was 4.55 V) was measured as a termination condition. In the case where the voltage of the secondary battery was lower than the upper limit voltage, phenomena such as short-circuit might have occurred. 1 C was set to approximately 200 mA/g.

Table 1 and Table 2 show the measurement time of each secondary battery. Table 1 shows the results using the positive electrode active materials obtained in Step S36, and Table 2 shows the results using the positive electrode active materials formed by being further subjected to Step S51 to Step S54, that is, the positive electrode active materials to which phosphorus compounds were added.

TABLE 1

| | Mg | |
|---|---|---|
| Charge | concentration | Time |
| voltage | [%] | [hrs] |
| 4.55 V | 0.5 | 35.8 |
| | 0.5 | 40.6 |
| | 2.0 | 59.9 |
| | 2.0 | 61.3 |
| | 6.0 | 34.2 |
| | 6.0 | 33.5 |
| 4.65 V | 0.5 | 20.5 |
| | 0.5 | 19.5 |
| | 2.0 | 20.4 |
| | 2.0 | 25.9 |
| | 6.0 | 11.2 |
| | 6.0 | 10.8 |

TABLE 2

| | Mg | |
|---|---|---|
| | concentration | Time |
| | [%] | [hrs] |
| 4.55 V | 0.5 | 106.5 |
| | 0.5 | 105.7 |
| | 1.0 | 75.5 |
| | 1.0 | 74.7 |
| | 2.0 | 124.1 |
| | 2.0 | 142.9 |
| | 3.0 | 75.4 |
| | 3.0 | 77.6 |
| | 6.0 | 119.5 |
| | 6.0 | 119.7 |
| 4.65 V | 0.5 | 217.8 |
| | 1.0 | 262.7 |
| | 1.0 | 266.3 |
| | 2.0 | 511.5 |
| | 2.0 | 430.9 |
| | 3.0 | 231.5 |
| | 3.0 | 250.1 |
| | 6.0 | 237.4 |
| | 6.0 | 267.9 |

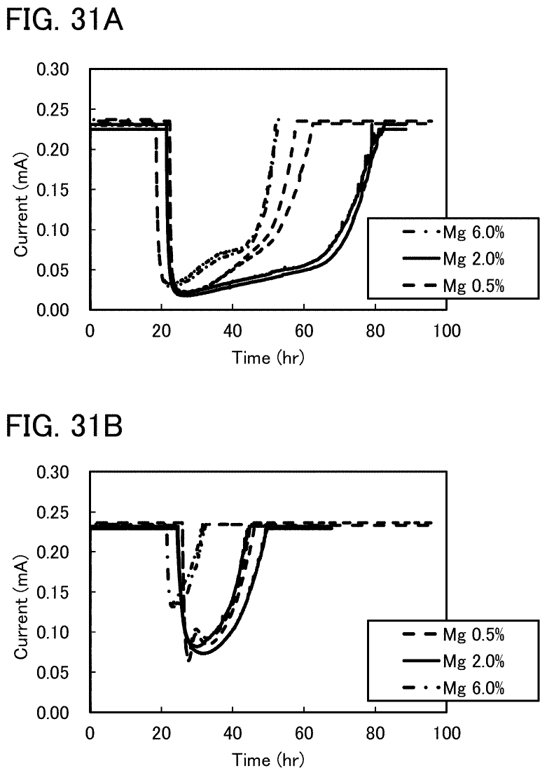

As the results using the positive electrode active materials obtained in Step S36, FIG. 31(A) shows time-current characteristics with a charge voltage of 4.55 V, and FIG. 31(B) shows time-current characteristics with a charge voltage of 4.65 V.

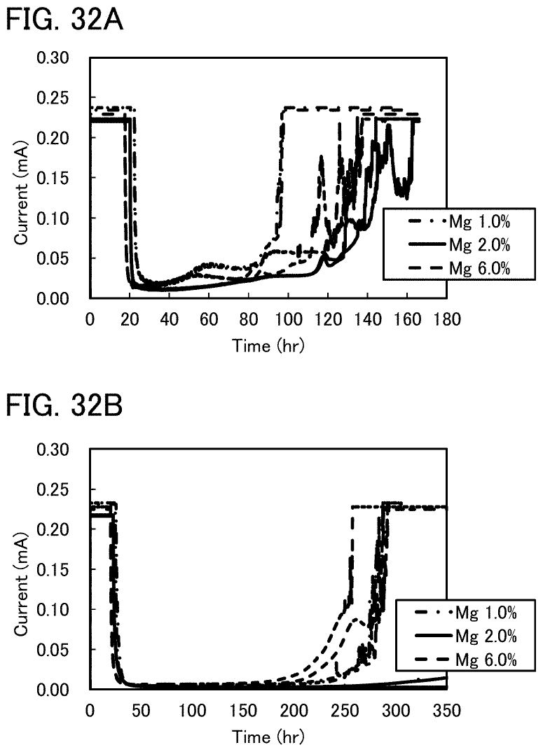

As the results using the positive electrode active materials formed through Step S51 to Step S54, that is, the positive electrode active materials to which phosphorus compounds were added, FIG. 32(A) shows time-current characteristics with a charge voltage of 4.55 V, and FIG. 32(B) shows time-current characteristics with a charge voltage of 4.65 V.

It was indicated that time until a voltage drop occurred became longer by addition of phosphorus compounds, and continuous charge tolerance was improved. It was also suggested that the continuous charge tolerance was improved notably in the condition that the addition amount of Mg was 2%.

### <Cycle Performance>

Next, the cycle performance of each of the secondary batteries using the positive electrode active materials formed above was evaluated. First, the secondary batteries were measured at 25° C. for two cycles while the CCCV charge (0.05 C, 4.6 V, a termination current of 0.005 C) and the CC discharge (0.05 C, 2.5 V) were performed. After that, the CCCV charge (0.2 C, 4.5 V, a termination current of 0.02 C) and the CC discharge (0.2 C, 2.5 V) were repeatedly performed at 25° C. on the secondary batteries, and then the cycle performance was evaluated.

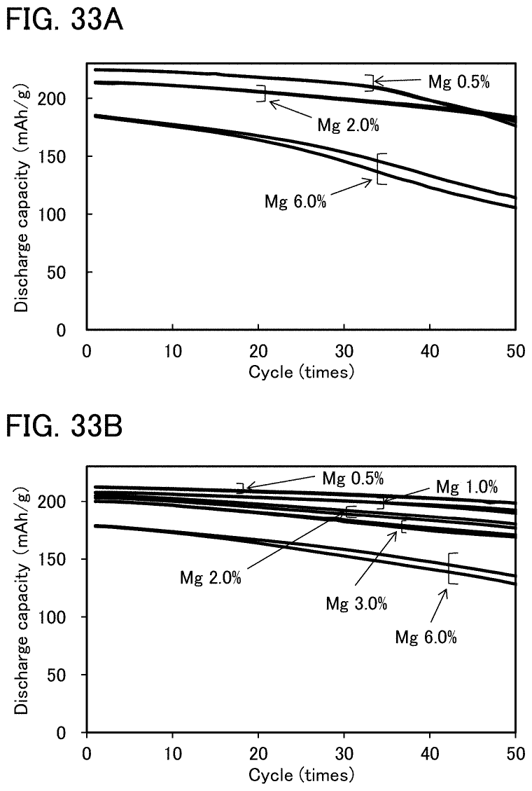

In FIGS. 33(A) and 33(B), the horizontal axis represents cycles and the vertical axis represents discharge capacity. FIG. 33(A) shows the results of the secondary batteries using the positive electrode active materials obtained in Step S36, and FIG. 33(B) shows the results of the secondary batteries using the positive electrode active materials obtained formed by being further subjected to Step S51 to Step S54, that is, the positive electrode active materials to which phosphorus compounds were added.

Focusing on the reduction rate of the capacity to the number of cycle a significant difference depending on the concentration of added magnesium cannot be observed. In contrast, as the concentration of added magnesium was higher, a significant decrease in initial capacity was observed. This is probably because the proportion of the phosphorus compound in the active material weight becomes higher and the proportion of cobalt is reduced relatively, and thus the proportion of a substance that contributes to a charge and discharge reaction is reduced.

### Example 2

In this example, positive electrode active materials containing magnesium, fluorine, cobalt, a metal except cobalt, and the like were formed, secondary batteries including positive electrodes using the positive electrode active materials were formed, the positive electrodes of the secondary batteries after charge was evaluated by XRD, and the continuous charge tolerance of the secondary batteries and the cycle performance of the secondary batteries were evaluated.

### <Formation of Positive Electrode Active Material>

Sample 30 to Sample 35 that are positive electrode active materials were formed with reference to the flowcharts illustrated in FIG. 8 and FIG. 9. Note that Step S51 to Step S54 were not performed.

First, as for each of Sample 30 to Sample 35, the mixture 902 containing magnesium and fluorine was formed (Step S11 to Step S14). LiF and MgF₂ were weighted so that the molar ratio of LiF to MgF₂ was LiF:MgF₂=1:3, acetone was added as a solvent, and the materials were mixed and ground by a wet process. The mixing and the grinding were performed in a ball mill using a zirconia ball at 150 rpm for one hour. The material subjected to the treatment was collected to be the mixture 902

Next, as for each of Sample 30 to Sample 35, CELLSEED C-10N manufactured by NIPPON CHEMICAL INDUSTRIAL CO., LTD. was prepared as a positive electrode active material containing cobalt (Step S25).

Then, as for each of Sample 30 to Sample 35, the mixture 902 and the lithium cobalt oxide were mixed (Step S31). The materials were weighed so that the atomic weight of magnesium in the mixture 902 was 2.0% of the atomic weight of cobalt in the lithium cobalt oxide. The mixing was performed by a dry method. The mixing was performed in a ball mill using a zirconia ball at 150 rpm for one hour.

Next, as for each of Sample 30 to Sample 35, the material which has been subjected to the treatment was collected, and the mixture 903 was obtained (Step S32 and Step S33).

Next, as for each of Sample 30 to Sample 35, the mixture 903 was put in an alumina crucible and annealed at 850° C. using a muffle furnace in an oxygen atmosphere for 60 hours (Step S34). At the time of annealing, the alumina crucible was covered with a lid. The flow rate of oxygen was 10 L/min. The temperature rise was 200° C./hr, and it took longer than or equal to 10 hours to lower the temperature. The material subjected to the heat treatment was collected and sifted (Step S35), and the positive electrode active material 100A_1 was obtained (Step S36).

Next, as for each of Sample 31 to Sample 35, treatment from Step S41 to Step S46 was performed. Note that for Sample 30, the addition of metal sources in Step S41 to Step S46 was not performed. First, as for each of Sample 31 to Sample 35, the positive electrode active material 100A_1 and a metal source were mixed in Step S41. Furthermore, in some cases, a solvent was also mixed.

### <<Addition of Aluminum>>

As for each of Sample 31 and Sample 32, a covering layer containing aluminum was formed on the positive electrode active material 100A_1 by a sol-gel method. Al isopropoxide was used as a raw material, and 2-propanol was used as a solvent. The treatment was performed so that the number of aluminum atoms in Sample 31 was 0.1% of the sum of the number of cobalt and aluminum atoms, and the number of aluminum atoms in Sample 32 was 0.5% of the sum of the number of cobalt and aluminum atoms. After that, the obtained mixture was put in the alumina crucible, the alumina crucible was covered with a lid, and annealing was performed at 850° C. for two hours in an oxygen atmosphere (Step S45). After that, the annealed mixture was made to pass through a sieve with 53 μmϕ, and the powder was collected (Step S46), so that Sample 31 and Sample 32 were obtained as positive electrode active materials.

### <<Addition of Nickel>>

As for each of Sample 33 and Sample 34, nickel hydroxide that is a metal source and the positive electrode active material 100A_1 were mixed. The mixing was performed so that the number of nickel atoms in Sample 33 was 0.1% of the sum of the number of cobalt and nickel atoms and the number of nickel atoms in Sample 34 was 0.5% of the sum of the number of cobalt and nickel atoms. The mixing was performed in a ball mill using a zirconia ball at 150 rpm for one hour. After the mixing, the mixture was made to pass through a sieve with 300 μmϕ. After that, the obtained mixture was put in the alumina crucible, the alumina crucible was covered with a lid, and annealing was performed at 850° C. for two hours in an oxygen atmosphere (Step S45). After that, the annealed mixture was made to pass through a sieve with 53 μmϕ, and the powder was collected (Step S46), so that Sample 33 and Sample 34 were obtained as positive electrode active materials.

### <<Addition of Aluminum and Nickel>>

As for Sample 35, nickel hydroxide that is a metal source and the positive electrode active material 100A_1 were mixed in a ball mill, and then a covering layer containing aluminum was formed by a sol-gel method. Al isopropoxide was used as a metal source, and 2-propanol was used as a solvent. The mixing was performed so that the number of nickel atoms and the number of aluminum atoms were each 0.5% of the sum of the number of cobalt, nickel, and aluminum atoms. After that, the obtained mixture was put in the alumina crucible, the alumina crucible was covered with a lid, and annealing was performed at 850° C. for two hours in an oxygen atmosphere (Step S45). After that, the annealed mixture was made to pass through a sieve with 53 μmϕ, and the powder was collected (Step S46), so that Sample 35 was obtained as a positive electrode active material.

### <Formation of Secondary Battery>

Positive electrodes were formed using Sample 30 to Sample 35 obtained above as the positive electrode active materials. A current collector that was coated with slurry in which the positive electrode active material, AB, and PVDF were mixed at the active material:AB:PVDF=95:3:2 (weight ratio) was used. As a solvent of the slurry, NMP was used.

After the current collector was coated with the slurry, the solvent was volatilized. Then, pressure was applied at 210 kN/m and then at 1467 kN/m. Through the above process, the positive electrodes were obtained. The carried amount of the positive electrode was approximately 20 mg/cm².

CR2032 type coin secondary batteries (a diameter of 20 mm, a height of 3.2 mm) were manufactured using the formed positive electrodes.

A lithium metal was used for a counter electrode.

As an electrolyte contained in the electrolyte solution, 1 mol/L lithium hexafluorophosphate (LiPF₆) was used. As the electrolyte solution, an electrolyte solution in which ethylene carbonate (EC) and diethyl carbonate (DEC) were mixed at EC:DEC=3:7 (volume ratio) was used. Note that for the secondary batteries used for evaluating the cycle performance, 2 wt % of vinylene carbonate (VC) was added to the electrolytic solution.

As a separator, 25-μm-thick polypropylene was used.

A positive electrode can and a negative electrode can formed of stainless steel (SUS) were used as a positive electrode can and a negative electrode can.

### <XRD Performed on Positive Electrode>

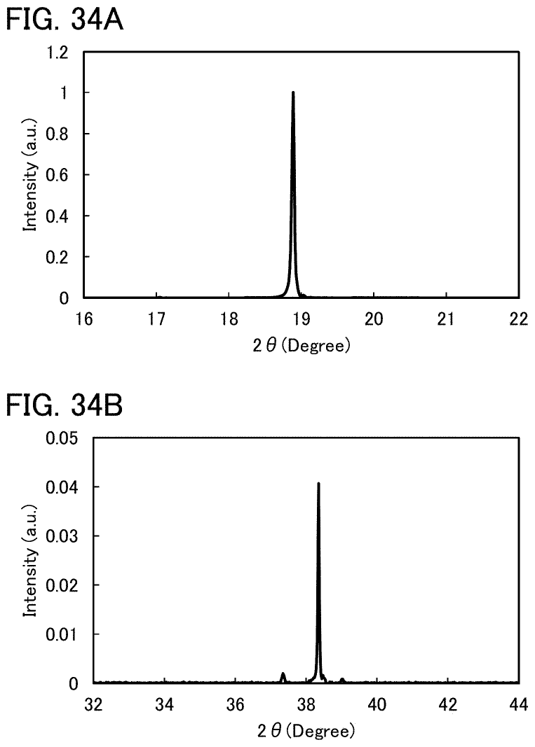

First, before charge and discharge, the positive electrode was evaluated by XRD. FIGS. 34(A) and 34(B) show XRD performed on the positive electrode before charge and discharge. Notable peaks at 2θ of 18.89° and 2θ of 38.35° were observed. In graphs of FIGS. 34(A) and 34(B), the horizontal axis represents 2θ and the vertical axis represents intensity.

<XRD Performed on Positive Electrode after Charge>

Next, the formed secondary batteries were subjected to CCCV charge at each of 4.55 V, 4.6 V, 4.65 V, and 4.7 V. Specifically, at 25° C., constant current charge was performed at 0.2 C until voltage reached predetermined voltage, and then constant voltage charge was performed until a current value reached 0.02 C. Note that here 1 C was set to 191 mA/g. Then, the secondary batteries in the charged state were disassembled in a glove box with an argon atmosphere to take out the positive electrodes, and the positive electrodes were washed with DMC (dimethyl carbonate) to remove the electrolyte solution. Then, the positive electrodes were enclosed in airtight containers with an argon atmosphere and analyzed by XRD.

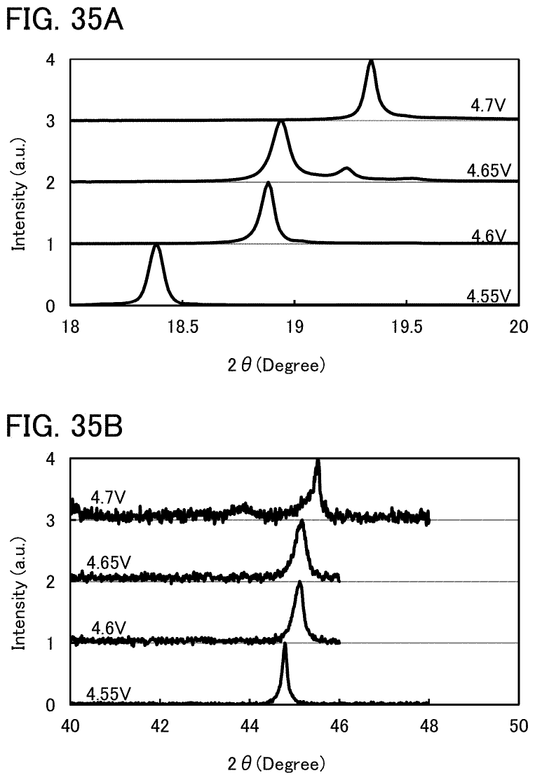

FIGS. 35(A) and 35(B) show XRD performed on Sample 35 and corresponding to each charge voltage condition. In graphs of FIGS. 35(A) and 35(B), the horizontal axis represents 2θ and the vertical axis represents intensity.

FIG. 35(A) shows peaks observed at 2θ of 18° to 20°. The peak observed in the charge voltage condition of 4.55 V is probably due to the O3-type crystal structure. When the charge voltage is made higher, the peak position is moved to higher degrees. A peak around 18.9° and a peak around 19.2° were observed in the charge voltage condition of 4.65 V and are probably due to a mixed state of two phases of the O3-type crystal structure and the pseudo-spinel crystal structure. A peak around 19.3° observed in the charge voltage condition of 4.7 V is probably due to the pseudo-spinel crystal structure.

FIG. 35(B) shows peaks observed at 2θ of 40° to 50°. When the charge voltage is made higher, a weak peak around 43.9°, which is probably due to the H1-3 crystal structure, is observed at i4.7 V

Accordingly, in the positive electrode active material of one embodiment of the present invention, when the charge voltage is made higher, a region that is changed from the O3-type crystal structure to the pseudo-spinel crystal structure is probably generated at a charge voltage of 4.65 V, and when the charge voltage is further made higher to 4.7 V, the positive electrode active material probably has the pseudo-spinel crystal structure mainly although the H1-3 crystal structure is mixed; thus, the positive electrode active material of one embodiment of the present invention is probably highly stable even at a high charge voltage.

### <Continuous Charge Tolerance>

Next, the continuous charge tolerance of each of the secondary batteries was evaluated. First, the secondary batteries using Sample 30 to Sample 35 as the positive electrode active materials were measured at 25° C. for two cycles while the CCCV charge (0.05 C, 4.5 V or 4.6 V, a termination current of 0.005 C) and the CC discharge (0.05 C, 2.5 V) were performed.

After that, the CCCV charge (0.05 C) was performed at 60° C. The upper limit voltage was set to 4.55 V or 4.65 V, and the time until the voltage of the secondary battery became below the value obtained by subtracting 0.01 V from the upper limit voltage (4.54 V when the upper limit voltage was 4.55 V) was measured as a termination condition. In the case where the voltage of the secondary battery was lower than the upper limit voltage, phenomena such as short-circuit might have occurred. 1 C was set to approximately 200 mA/g.

Table 3 shows the measurement time of each secondary battery. Note that for each condition, two secondary batteries were formed. Table 3 shows an average value of the two results.

TABLE 3

| | | Al | Ni | |
|---|---|---|---|---|
| | Charge | concentration | concentration | Time |
| | voltage | [%] | [%] | [hrs] |
| Sample 30 | 4.55 V | — | — | 60.6 |
| Sample 31 | | 0.1 | — | 76.0 |
| Sample 32 | | 0.5 | — | 81.1 |
| Sample 33 | | — | 0.1 | 58.4 |
| Sample 34 | | — | 0.5 | 59.2 |
| Sample 35 | | 0.5 | 0.5 | 73.4 |
| Sample 30 | 4.65 V | — | — | 23.1 |
| Sample 31 | | 0.1 | — | 32.0 |
| Sample 32 | | 0.5 | — | 38.4 |
| Sample 33 | | — | 0.1 | 23.6 |
| Sample 34 | | — | 0.5 | 25.2 |
| Sample 35 | | 0.5 | 0.5 | 33.0 |

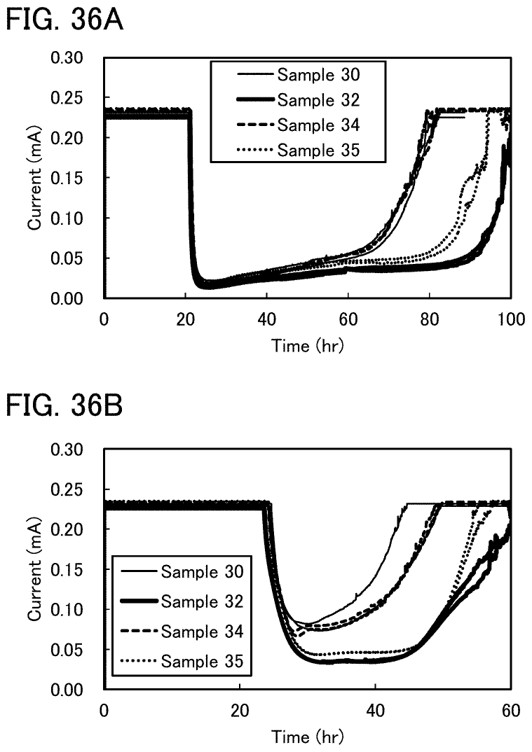

First, as the results using Sample 30, Sample 32, Sample 34, and Sample 35, FIG. 36(A) shows time-current characteristics at a charge voltage of 4.55 V and FIG. 36(B) shows time-current characteristics at a charge voltage of 4.65 V.

Time until a voltage drop occurred became longer by addition of aluminum, and it was indicated that continuous charge tolerance was improved. The continuous charge tolerance was improved notably by addition of nickel and aluminum as compared with the case where only nickel was added.

### <Cycle Performance>

Next, the cycle performance of the secondary batteries using Sample 30, Sample 32, Sample 34, and Sample 35 was evaluated. First, the secondary batteries were measured at 25° C. for two cycles while the CCCV charge (0.05 C, 4.6 V, a termination current of 0.005 C) and the CC discharge (0.05 C, 2.5 V) were performed. After that, the CCCV charge (0.2 C, 4.6 V, a termination current of 0.02 C) and the CC discharge (0.2 C, 2.5 V) were repeatedly performed at 25° C. on the secondary batteries, and then the cycle performance was evaluated.

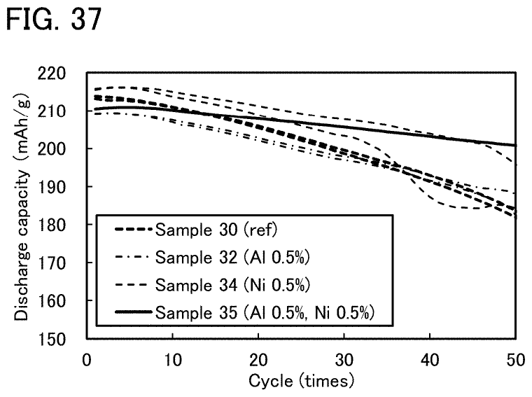

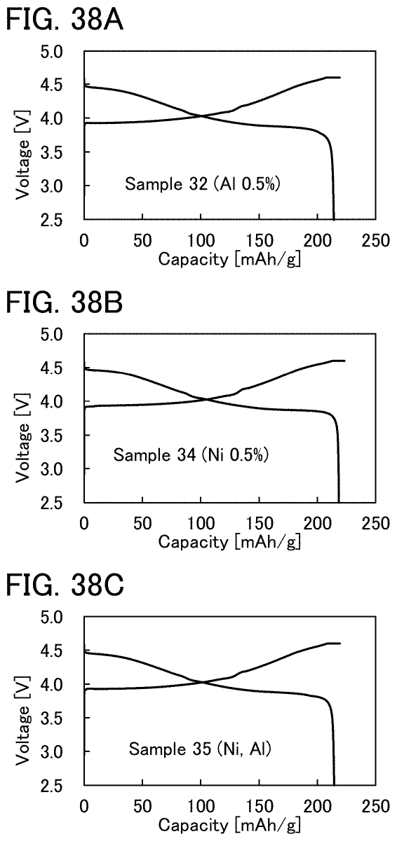

FIG. 37 shows the results of cycle performance. In FIG. 37, the horizontal axis represents cycles and the vertical axis represents discharge capacity. FIG. 38(A) shows an initial charge and discharge curve of Sample 32, FIG. 38(B) shows an initial charge and discharge curve of Sample 34, and FIG. 38(C) shows an initial charge and discharge curve of Sample 35. Initial capacity was improved by addition of nickel (Sample 34). A decrease in capacity due to cycles was inhibited probably by addition of nickel or aluminum, and a better result was obtained particularly in the condition of adding nickel and aluminum (Sample 35).

### Example 3

In this example, the positive electrodes were evaluated by direct current resistance measurement.

### <Formation of Secondary Battery>

A positive electrode was formed using Sample 11 described in Example 1 as a positive electrode active material. A current collector that was coated with slurry in which the positive electrode active material, carbon black, and PVDF were mixed at the active material:carbon black:PVDF=90:5:5 (weight ratio) was used. As a solvent of the slurry NMP was used.

After the current collector was coated with the slurry, the solvent was volatilized. Then, the positive electrode was pressurized at 210 kN/m and then further pressurized at 1467 kN/m. Through the above process, the positive electrode was obtained. The carried amount of the positive electrode was approximately 20 mg/cm².

A CR2032 type coin secondary battery (a diameter of 20 mm, a height of 3.2 mm) were manufactured using the formed positive electrode.

A lithium metal was used for a counter electrode.

As an electrolyte contained in the electrolyte solution, 1 mol/L lithium hexafluorophosphate (LiPF₆) was used. As the electrolyte solution, an electrolyte solution in which ethylene carbonate (EC) and diethyl carbonate (DEC) were mixed at EC:DEC=3:7 (volume ratio) was used. Note that for secondary batteries used for evaluating the cycle performance, 2 wt % of vinylene carbonate (VC) was added to the electrolytic solution.

As a separator, 25-μm-thick polypropylene was used.

A positive electrode can and a negative electrode can formed of stainless steel (SUS) were used as a positive electrode can and a negative electrode can.

### <Charge and Discharge Cycle Test>

Direct current resistance was measured before a charge and discharge cycle test and after 50 cycles of the charge and discharge cycle test. The conditions described in Example 1 were referred to for the charge and discharge cycle test.

### <Direct Current Resistance Measurement>

Next, direct current resistance measurement was performed using the formed secondary battery. An electrochemical measurement system HJ1001SM8A produced by HOKUTO DENKO CORPORATION was used as a measurement unit.

First, CCCV charge was performed until the voltage reaches 4.5 V at 25° C., and then a 20-minute break was taken. Next, CC discharge was performed until the voltage drops to 3.0 V and then a 20-minute break was taken. Using the discharge capacity obtained in the measurement as a reference, the direct current resistance measurement was performed in varied SOC conditions as described below.

First, CCCV charge was performed until the voltage reaches 4.5 V at 25° C. Next, discharge was performed, and the direct current resistance measurement was performed at three states, which are SOC of 70%, 20%, and 10%.

At each SOC, current was flowed for a certain time after the discharge capacity reaches the predetermined SOC, and the direct current resistance was obtained. Table 4 shows the obtained direct current resistance.

TABLE 4

| | Direct current | Direct current | Direct current |
|---|---|---|---|
| | resistance | resistance | resistance |
| | at SOC | at SOC | at SOC |
| | of 70% [Ω] | of 20% [Ω] | of 10% [Ω] |
| Before charge and | 69.4 | 75.1 | 84.3 |
| discharge cycle test | | | |
| After 50 cycles | 89.0 | 106.6 | 121.1 |

The direct current resistance tended to be higher when the SOC was smaller. The direct current resistance after the cycle test increased 1.3 to 1.4 times the direct current resistance before the cycle test.

### Example 4

In this example, cross-sectional TEM-EDX analysis was performed on a particle included in the positive electrode active material of one embodiment of the present invention.

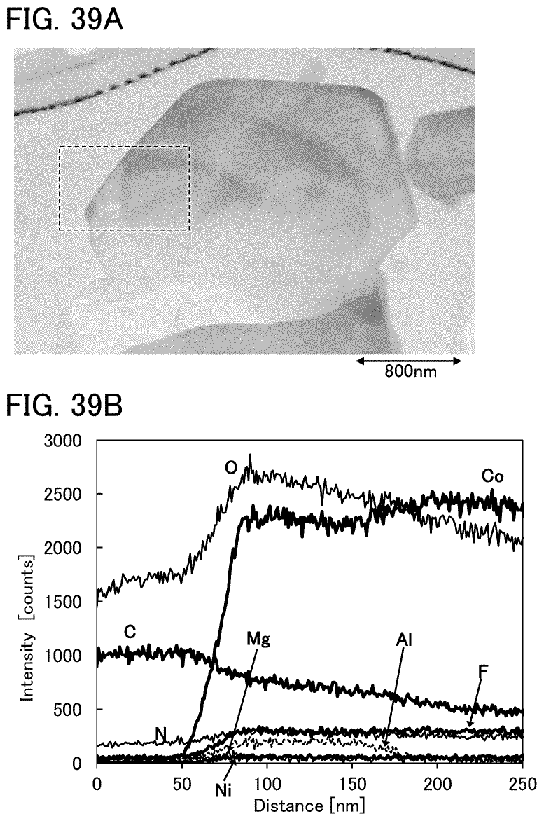

The samples were sliced using an FIB (Focused Ion Beach System) and then a TEM image thereof was observed. FIG. 39(A) shows a cross-sectional TEM image of Sample 35 formed in Example 2.

### <TEM-EDX Analysis>

TEM-EDX analysis was performed on a portion surrounded by a broken line in FIG. 39(A). Analysis was performed linearly from the surface to the inner portion of the particle. The line was approximately perpendicular to the surface. FIG. 39(B) shows the result of the EDX line analysis. In the vicinity of the surface, relatively, the aluminum concentration tended to be high and the cobalt concentration tended to be low. Moreover, an increase in the magnesium concentration in the vicinity of the surface is also shown. Accordingly, aluminum, magnesium, and the like may contribute to the stabilization of the structure of the particle surface in the particle included in the positive electrode active material.

### Example 5

In this example, secondary batteries each including a positive electrode using the positive electrode active material of one embodiment of the present invention were formed, and the positive electrodes of the secondary batteries after charge were evaluated by XRD.

Positive electrodes were formed using Sample 30 and Sample 35 formed in Example 2, and secondary batteries were formed using the positive electrodes. The positive electrodes and the secondary batteries were formed by a formation method described in Example 2.

<XRD Performed on Positive Electrode after Charge>

Next, the formed secondary batteries were subjected to CCCV charge at each of 4.6 V and 4.65 V. Specifically, at 45° C., constant current charge was performed at 0.2 C until voltage reached predetermined voltage, and then constant voltage charge was performed until a current value reached 0.02 C. Note that here 1 C was set to 191 mA/g. Then, the secondary batteries in the charged state were disassembled in a glove box with an argon atmosphere to take out the positive electrodes, and the positive electrodes were washed with DMC (dimethyl carbonate) to remove the electrolyte solution. Then, the positive electrodes were enclosed in airtight containers with an argon atmosphere and analyzed by XRD.

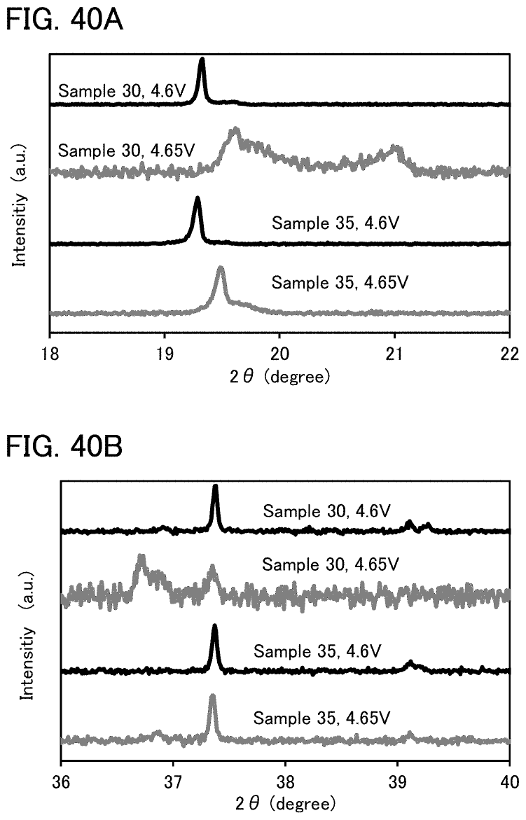

FIGS. 40(A) and 40(B) show the results of XRD. At a high charge voltage, in Sample 30, in addition to a peak due to the H1-3 crystal structure, notable peaks around 20.9° and around 36.8° were observed. The peaks around 20.9° and around 36.8° were probably due to CoO₂ and thus Sample 30 probably has an unstable state in which the crystal structure is broken because of extraction of lithium. In contrast, Sample 35 probably has a pseudo-spinel crystal structure and is probably stable even at a high charge voltage.

### REFERENCE NUMERALS

100: positive electrode active material, 100A: positive electrode active material, 100A_1: positive electrode active material, 100A_2: positive electrode active material, 100A_3: positive electrode active material, 100C: positive electrode active material, 200: active material layer, 201: graphene compound, 211a: positive electrode, 211b: negative electrode, 212a: lead, 212b: lead, 214: separator, 215a: bonding portion, 215b: bonding portion, 217: fixing member, 250: secondary battery, 251: exterior body, 261: folded portion, 262: seal portion, 263: seal portion, 271: crest line, 272: trough line, 273: space, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 500: secondary battery, 501: positive electrode current collector, 502: positive electrode active material layer, 503: positive electrode, 504: negative electrode current collector, 505: negative electrode active material layer, 506: negative electrode, 507: separator, 508: electrolyte solution, 509: exterior body, 510: positive electrode lead electrode, 511: negative electrode lead electrode, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module, 616: wiring, 617: temperature control device, 900: circuit board, 901: raw material, 902: mixture, 903: mixture, 904: mixture, 910: label, 911: terminal, 912: circuit, 913: secondary battery, 914: antenna, 916: layer, 917: layer, 918: antenna, 920: display device, 921: sensor, 922: terminal, 930: housing, 930a: housing, 930b: housing, 931: negative electrode, 932: positive electrode, 933: separator, 950: wound body, 951: terminal, 952: terminal, 980: secondary battery, 981: film, 982: film, 993: wound body, 994: negative electrode, 995: positive electrode, 996: separator, 997: lead electrode, 998: lead electrode, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input-output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 8000: display device, 8001: housing, 8002: display portion, 8003: speaker portion, 8004: secondary battery, 8021: charge apparatus, 8022: cable, 8024: secondary battery, 8100: lighting device, 8101: housing, 8102: light source, 8103: secondary battery, 8104: ceiling, 8105: wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 8400: automobile, 8401: headlight, 8406: electric motor, 8500: automobile, 8600: motor scooter, 8601: side mirror, 8602: secondary battery, 8603: indicator, 8604: storage unit under seat, 9600: tablet terminal, 9625: switch, 9627: switch, 9628: operation switch, 9629: fastener, 9630: housing, 9630a: housing, 9630b: housing, 9631: display portion, 9631a: display portion, 9631b: display portion, 9633: solar cell, 9634: charge and discharge control circuit, 9635: power storage unit, 9636: DC-DC converter, 9637: converter, 9640: movable portion

1. A method of manufacturing a lithium-ion secondary battery comprising a positive electrode which includes a positive electrode active material, a negative electrode and an electrolyte, the method comprising the steps of:
mixing a lithium source and a cobalt source to form a first mixture;
performing a first heating on the first mixture to form a first composite oxide;
mixing the first composite oxide with a magnesium source and a fluorine source to form a second mixture;
performing a second heating on the second mixture at a temperature at which cation mixing is unlikely to occur so that fluorine of the fluorine source and magnesium of the magnesium source are segregated at a surface of the positive electrode active material, thereby forming a second composite oxide,
mixing the second composite oxide with an aluminum source; and
performing a third heating on the second composite oxide mixed with the aluminum source at a temperature at which cation mixing is unlikely to occur.

2. A method of manufacturing a lithium-ion secondary battery comprising a positive electrode which includes a positive electrode active material, a negative electrode and an electrolyte, the method comprising the steps of:
mixing a lithium source and a cobalt source to form a first mixture;
performing a first heating on the first mixture to form a first composite oxide;
mixing the first composite oxide with a magnesium source and a fluorine source to form a second mixture;
performing a second heating on the second mixture at a temperature at which cation mixing is unlikely to occur so that fluorine of the fluorine source and magnesium of the magnesium source are segregated at a surface of the positive electrode active material, thereby forming a second composite oxide,
mixing the second composite oxide with a nickel source and an aluminum source; and
performing a third heating on the second composite oxide mixed with the nickel source and the aluminum source at a temperature at which cation mixing is unlikely to occur.

3. A method of manufacturing a lithium-ion secondary battery comprising a positive electrode which includes a positive electrode active material, a negative electrode and an electrolyte, the method comprising the steps of:
mixing a lithium source and a cobalt source to form a first mixture;
performing a first heating on the first mixture to form a first composite oxide;
mixing the first composite oxide with a magnesium source and a fluorine source to form a second mixture;
performing a second heating on the second mixture at a temperature higher than or equal to 600° C. and lower than or equal to 950° C. so that fluorine of the fluorine source and magnesium of the magnesium source are segregated at a surface of the positive electrode active material, thereby forming a second composite oxide,
mixing the second composite oxide with an aluminum source; and
performing a third heating on the second composite oxide mixed with the aluminum source at a temperature higher than or equal to 700° C. and lower than or equal to 920° C.

4. A method of manufacturing a lithium-ion secondary battery comprising a positive electrode which includes a positive electrode active material, a negative electrode and an electrolyte, the method comprising the steps of:
mixing a lithium source and a cobalt source to form a first mixture;
performing a first heating on the first mixture to form a first composite oxide;
mixing the first composite oxide with a magnesium source and a fluorine source to form a second mixture;
performing a second heating on the second mixture at a temperature higher than or equal to 600° C. and lower than or equal to 950° C. so that fluorine of the fluorine source and magnesium of the magnesium source are segregated at a surface of the positive electrode active material, thereby forming a second composite oxide,
mixing the second composite oxide with a nickel source and an aluminum source; and
performing a third heating on the second composite oxide mixed with the nickel source and the aluminum source at a temperature higher than or equal to 700° C. and lower than or equal to 920° C.

5. The method according to claim 1, wherein the fluorine source comprises lithium fluoride.

6. The method according to claim 2, wherein the fluorine source comprises lithium fluoride.

7. The method according to claim 3, wherein the fluorine source comprises lithium fluoride.

8. The method according to claim 4, wherein the fluorine source comprises lithium fluoride.

9. The method according to claim 1, wherein the magnesium source comprises magnesium fluoride or magnesium oxide.

10. The method according to claim 2, wherein the magnesium source comprises magnesium fluoride or magnesium oxide.

11. The method according to claim 3, wherein the magnesium source comprises magnesium fluoride or magnesium oxide.

12. The method according to claim 4, wherein the magnesium source comprises magnesium fluoride or magnesium oxide.

13. The method according to claim 1, wherein the first heating is performed at a temperature higher than or equal to 800° C. and lower than 1100° C.

14. The method according to claim 2, wherein the first heating is performed at a temperature higher than or equal to 800° C. and lower than 1100° C.

15. The method according to claim 3, wherein the first heating is performed at a temperature higher than or equal to 800° C. and lower than 1100° C.

16. The method according to claim 4, wherein the first heating is performed at a temperature higher than or equal to 800° C. and lower than 1100° C.

17. The method according to claim 1, wherein,
the positive electrode active material has an O3 crystal structure in a discharged state; and
a X-ray diffraction pattern of the positive electrode active material in a charged state has a first diffraction peak at 2θ of 19.30±0.20° and a second diffraction peak at 2θ of 45.55±0.10°, when the positive electrode comprising the positive electrode active material is analyzed by powder X-ray diffraction by using CuKα1 ray.

18. The method according to claim 2, wherein,
the positive electrode active material has an O3 crystal structure in a discharged state; and
a X-ray diffraction pattern of the positive electrode active material in a charged state has a first diffraction peak at 2θ of 19.30±0.20° and a second diffraction peak at 2θ of 45.55±0.10°, when the positive electrode comprising the positive electrode active material is analyzed by powder X-ray diffraction by using CuKα1 ray.

19. The method according to claim 3, wherein,
the positive electrode active material has an O3 crystal structure in a discharged state; and
a X-ray diffraction pattern of the positive electrode active material in a charged state has a first diffraction peak at 2θ of 19.30±0.20° and a second diffraction peak at 2θ of 45.55±0.10°, when the positive electrode comprising the positive electrode active material is analyzed by powder X-ray diffraction by using CuKα1 ray.

20. The method according to claim 4, wherein,
the positive electrode active material has an O3 crystal structure in a discharged state; and
a X-ray diffraction pattern of the positive electrode active material in a charged state has a first diffraction peak at 2θ of 19.30±0.20° and a second diffraction peak at 2θ of 45.55±0.10°, when the positive electrode comprising the positive electrode active material is analyzed by powder X-ray diffraction by using CuKα1 ray.

21. The method according to claim 1, wherein
the magnesium source is for inhibiting a deviation in CoO₂ layers.

22. The method according to claim 2, wherein
the magnesium source is for inhibiting a deviation in CoO₂ layers.

23. The method according to claim 3, wherein
the magnesium source is for inhibiting a deviation in CoO₂ layers.

24. The method according to claim 4, wherein
the magnesium source is for inhibiting a deviation in CoO₂ layers.

25. The method according to claim 1, wherein
the fluorine source is a compound which lowers a melting point of the magnesium source.

26. The method according to claim 2, wherein
the fluorine source is a compound which lowers a melting point of the magnesium source.

27. The method according to claim 3, wherein
the fluorine source is a compound which lowers a melting point of the magnesium source.

28. The method according to claim 4, wherein
the fluorine source is a compound which lowers a melting point of the magnesium source.

29. The method according to claim 3, wherein
the positive electrode active material has an O3 crystal structure with a charge depth of 0.06 or less, and
a X-ray diffraction pattern of the positive electrode active material with the charge depth of greater than or equal to 0.7 and less than or equal to 0.9 has a first diffraction peak at 2θ of 19.30±0.20° and a second diffraction peak at 2θ of 45.55±0.10° when the positive electrode is analyzed in a powder X-ray diffraction using CuKα1 ray.

30. The method according to claim 4, wherein
the positive electrode active material has an O3 crystal structure with a charge depth of 0.06 or less, and
a X-ray diffraction pattern of the positive electrode active material with the charge depth of greater than or equal to 0.7 and less than or equal to 0.9 has a first diffraction peak at 2θ of 19.30±0.20° and a second diffraction peak at 2θ of 45.55±0.10° when the positive electrode is analyzed in a powder X-ray diffraction using CuKα1 ray.
